(19) United States
(12) Patent Application Publication
(10) Pub. No.: US 2025/0374875 A1
(43) Pub. Date: Dec. 11, 2025

(54) IRRIGATION SYSTEMS

(71) Applicants: Morteza Mojarradi, Falkensee (DE); Gholamreza Mojarradi, Zanjan (IR)

(72) Inventors: Morteza Mojarradi, Falkensee (DE); Gholamreza Mojarradi, Zanjan (IR)

(21) Appl. No.: 19/141,766

(22) PCT Filed: Oct. 21, 2024
(86) PCT No.: PCT/IB2024/060341

§ 371 Date: Jun. 20, 2025

Related U.S. Application Data
(60) Provisional application No. 63/591,910, filed on Oct. 20, 2023.
(60) Provisional application No. 63/618,746, filed on Jan. 8, 2024.

(51) Int. Cl. A01G 27/00

(52) U.S. Cl. CPC A01G 27/001

(57) ABSTRACT

Systems and methods for irrigating a target (e.g., soil) are provided. An equilibrium for system liquid out and system air in may be achieved until an absorber mechanism of the system gets wet and transitions for blocking the flow of air through a gas conduit of the system and into an accumulation space of the system, such that there may no longer be an equilibrium and pressure down on the liquid may no longer be applied, such that a liquid outlet valve of the system may close and stop dispensing liquid from the accumulation space of the system.

### CROSS-REFERENCE TO RELATED APPLICATION(S)

This application claims the benefit of prior filed U.S. Provisional Patent Application No. 63/591,910, filed Oct. 20, 2023, and prior filed U.S. Provisional Patent Application No. 63/618,746, filed Jan. 8, 2024, each of which is hereby incorporated by reference herein in its entirety.

### COPYRIGHT NOTICE

At least a portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### TRADEMARK NOTICE

Applicant(s) make no claim to any trademarks referenced in the disclosure.

### TECHNICAL FIELD

This disclosure relates to irrigation systems, including, but not limited to, moisture sensitive valve systems and low power mechatronic valve systems.

### BACKGROUND OF THE DISCLOSURE

Maintaining the right level of moisture in soil is crucial for the health and growth of plants. Overwatering or underwatering can lead to various plant diseases and can even cause the plant to die. Conventional watering methods often rely on manual intervention, which can be time-consuming and inefficient.

### SUMMARY OF THE DISCLOSURE

This document describes systems and methods for irrigating a target.

For example, an irrigation system is provided that may include a container defining an accumulation space, a liquid inlet port configured to fluidly couple the accumulation space to a first portion of an ambient environment of the system, a liquid outlet port configured to fluidly couple the accumulation space to a second portion of the ambient environment, and a gas conduit extending between a gas inlet port configured to fluidly couple the gas conduit to a third portion of the ambient environment and a gas outlet port configured to fluidly couple the gas conduit to the accumulation space. The system may also include an absorber assembly including an absorber mechanism, wherein: a first portion of the absorber mechanism is positioned within the gas conduit between the gas inlet port and the gas outlet port, a second portion of the absorber mechanism is exposed via an absorber opening of the gas conduit to a fourth portion of the ambient environment, and the first portion of the absorber mechanism is configured to transition between an initial state that passes air through the first portion of the absorber mechanism between the gas inlet port and the gas outlet port and a transitioned state that does not pass air through the first portion of the absorber mechanism between the gas inlet port and the gas outlet port.

As another example, a method for mechanically controlling an irrigation system is provided, wherein the irrigation system may include a container defining an accumulation space, a liquid inlet port configured to fluidly couple the accumulation space to a liquid inlet portion of an ambient environment of the system, a liquid outlet port configured to fluidly couple the accumulation space to a liquid outlet portion of the ambient environment, and a gas conduit extending between a gas inlet port configured to fluidly couple the gas conduit to a gas inlet portion of the ambient environment and a gas outlet port configured to fluidly couple the gas conduit to the accumulation space, and an absorber mechanism, wherein a first portion of the absorber mechanism is positioned within the gas conduit between the gas inlet port and the gas outlet port, wherein a second portion of the absorber mechanism is exposed via an absorber opening of the gas conduit to an absorber portion of the ambient environment, and wherein the first portion of the absorber mechanism is configured to transition between an initial state that passes air through the first portion of the absorber mechanism between the gas inlet port and the gas outlet port and a transitioned state that does not pass air through the first portion of the absorber mechanism between the gas inlet port and the gas outlet port, the method including increasing liquid flow from the accumulation space to the liquid outlet portion of the ambient environment via the liquid outlet port when the first portion of the absorber mechanism transitions from the transitioned state to the initial state, and decreasing liquid flow from the accumulation space to the liquid outlet portion of the ambient environment via the liquid outlet port when the first portion of the absorber mechanism transitions from the initial state to the transitioned state.

As yet another example, a method for mechanically controlling an irrigation system is provided, wherein the irrigation system may include a container defining an accumulation space, a liquid inlet port configured to add liquid into the accumulation space, a liquid outlet port configured to selectively disburse liquid from the accumulation space to a liquid outlet portion of the ambient environment, and a gas conduit extending between a gas inlet port configured to fluidly couple the gas conduit to a gas inlet portion of the ambient environment and a gas outlet port configured to fluidly couple the gas conduit to the accumulation space, and an absorber mechanism, wherein a first portion of the absorber mechanism is positioned within the gas conduit between the gas inlet port and the gas outlet port, and wherein a second portion of the absorber mechanism is exposed via an absorber opening of the gas conduit to an absorber portion of the ambient environment, the method may include adjusting liquid flow from the accumulation space to the liquid outlet portion of the ambient environment via the liquid outlet port when the second portion of the absorber mechanism is exposed to a change in moisture by the absorber portion of the ambient environment.

This Summary is provided to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters may refer to like parts throughout, and in which:

FIG. 1 is a front view of an irrigation system, according to some embodiments of the disclosure;

FIG. 1A is a side view of the irrigation system of FIG. 1, according to some embodiments of the disclosure;

FIG. 1B is a rear view of the irrigation system of FIGS. 1 and 1A, according to some embodiments of the disclosure;

FIG. 1C is a top view of the irrigation system of FIGS. 1-1B, taken from line IC-IC of FIG. 1A, according to some embodiments of the disclosure;

FIG. 1D is a bottom view of the irrigation system of FIGS. 1-1C, taken from line ID-ID of FIG. 1A, according to some embodiments of the disclosure;

FIG. 1E is a top, front, side perspective view of the irrigation system of FIGS. 1-1D, according to some embodiments of the disclosure;

FIG. 1F is a bottom, front, side perspective view of the irrigation system of FIGS. 1-1E, according to some embodiments of the disclosure;

FIG. 1G is a top, rear, side perspective view of the irrigation system of FIGS. 1-1F, according to some embodiments of the disclosure;

FIG. 1H is a bottom, rear, side perspective view of the irrigation system of FIGS. 1-1G, according to some embodiments of the disclosure;

FIG. 1I is a cross-sectional view of the irrigation system of FIGS. 1-1H, taken from line II-II of FIG. 1A, according to some embodiments of the disclosure;

FIG. 1J is a cross-sectional view of the irrigation system of FIGS. 1-1I, taken from line IJ-IJ of FIG. 1B, according to some embodiments of the disclosure;

FIG. 2 is a front view of another irrigation system, according to some embodiments of the disclosure;

FIG. 2A is a side view of the irrigation system of FIG. 2, according to some embodiments of the disclosure;

FIG. 2B is a rear view of the irrigation system of FIGS. 2 and 2A, according to some embodiments of the disclosure;

FIG. 2C is a top view of the irrigation system of FIGS. 2-2B, taken from line IIC-IIC of FIG. 2A, according to some embodiments of the disclosure;

FIG. 2D is a bottom view of the irrigation system of FIGS. 2-2C, taken from line IID-IID of FIG. 2A, according to some embodiments of the disclosure;

FIG. 2E is a top, front, side perspective view of the irrigation system of FIGS. 2-2D, according to some embodiments of the disclosure;

FIG. 2F is a bottom, front, side perspective view of the irrigation system of FIGS. 2-2E, according to some embodiments of the disclosure;

FIG. 2G is a top, rear, side perspective view of the irrigation system of FIGS. 2-2F, according to some embodiments of the disclosure;

FIG. 2H is a bottom, rear, side perspective view of the irrigation system of FIGS. 2-2G, according to some embodiments of the disclosure;

FIG. 2I is a cross-sectional view of the irrigation system of FIGS. 2-2H, taken from line III-III of FIG. 2A, according to some embodiments of the disclosure;

FIG. 2J is a cross-sectional view of the irrigation system of FIGS. 2-2I, taken from line IIJ-IIJ of FIG. 2B, according to some embodiments of the disclosure;

FIG. 3 is a front view of another irrigation system, according to some embodiments of the disclosure;

FIG. 3A is a side view of the irrigation system of FIG. 3, according to some embodiments of the disclosure;

FIG. 3B is a rear view of the irrigation system of FIGS. 3 and 3A, according to some embodiments of the disclosure;

FIG. 3C is a top view of the irrigation system of FIGS. 3-3B, taken from line IIIC-IIIC of FIG. 3A, according to some embodiments of the disclosure;

FIG. 3D is a bottom view of the irrigation system of FIGS. 3-3C, taken from line IIID-IIID of FIG. 3A, according to some embodiments of the disclosure;

FIG. 3E is a top, rear, side perspective view of the irrigation system of FIGS. 3-3D, according to some embodiments of the disclosure;

FIG. 3F is a cross-sectional view of the irrigation system of FIGS. 3-3E, taken from line IIIF-IIIF of FIG. 3B, according to some embodiments of the disclosure;

FIG. 4 is a schematic view of an illustrative system that may include an electronic module for use with an irrigation system, according to some embodiments of the disclosure;

FIG. 5 is a more detailed schematic view of a subsystem of the system of FIG. 4, according to some embodiments of the disclosure;

FIGS. 6 and 7 are flowcharts of illustrative irrigation processes, according to some embodiments of the disclosure;

FIG. 8 is a cross-sectional view of another irrigation system, according to some embodiments of the disclosure;

FIG. 9 is a cross-sectional view of another irrigation system, according to some embodiments of the disclosure;

FIG. 10 is a cross-sectional view of another irrigation system, according to some embodiments of the disclosure;

FIG. 11 is a cross-sectional view of another irrigation system, according to some embodiments of the disclosure;

FIG. 12 is a cross-sectional view of another irrigation system, according to some embodiments of the disclosure;

FIG. 13 is a cross-sectional view of another irrigation system, according to some embodiments of the disclosure;

FIG. 14 is a front view of another irrigation system, according to some embodiments of the disclosure;

FIG. 14A is a side view of the irrigation system of FIG. 14, according to some embodiments of the disclosure;

FIG. 14B is a rear view of the irrigation system of FIGS. 14 and 14A, according to some embodiments of the disclosure;

FIG. 14C is a top view of the irrigation system of FIGS. 14-14B, taken from line XIVC-XIVC of FIG. 14A, according to some embodiments of the disclosure;

FIG. 14D is a bottom view of the irrigation system of FIGS. 14-14C, taken from line XIVD-XIVD of FIG. 14A, according to some embodiments of the disclosure;

FIG. 14E is a top, front, side perspective view of the irrigation system of FIGS. 14-14D, according to some embodiments of the disclosure;

FIG. 14F is a top, rear, side perspective view of the irrigation system of FIGS. 14-14E, according to some embodiments of the disclosure;

FIG. 14G is a cross-sectional view of the irrigation system of FIGS. 14-14F, taken from line XIVG-XIVG of FIG. 14, according to some embodiments of the disclosure;

FIG. 14H is a cross-sectional view of the irrigation system of FIGS. 14-14G, taken from line XIVH-XIVH of FIG. 14A, according to some embodiments of the disclosure;

FIG. 15 is a front view of another irrigation system, according to some embodiments of the disclosure;

FIG. 15A is a side view of the irrigation system of FIG. 15, according to some embodiments of the disclosure;

FIG. 15B is a rear view of the irrigation system of FIGS. 15 and 15A, according to some embodiments of the disclosure;

FIG. 15C is a top view of the irrigation system of FIGS. 15-15B, taken from line XVC-XVC of FIG. 15A, according to some embodiments of the disclosure;

FIG. 15D is a bottom view of the irrigation system of FIGS. 15-15C, taken from line XVD-XVD of FIG. 15A, according to some embodiments of the disclosure;

FIG. 15E is a top, rear, side perspective view of the irrigation system of FIGS. 15-15D, according to some embodiments of the disclosure;

FIG. 15F is a cross-sectional view of the irrigation system of FIGS. 15-15E, taken from line XVF-XVF of FIG. 15B, according to some embodiments of the disclosure;

FIG. 15G is a cross-sectional view of the irrigation system of FIGS. 15-15F, taken from line XVG-XVG of FIG. 15B, according to some embodiments of the disclosure;

FIG. 15H is a cross-sectional view of the irrigation system of FIGS. 15-15G, taken from line XVH-XVH of FIG. 15, according to some embodiments of the disclosure;

FIG. 16 is a front view of another irrigation system, according to some embodiments of the disclosure;

FIG. 16A is a side view of the irrigation system of FIG. 16, according to some embodiments of the disclosure;

FIG. 16B is a rear view of the irrigation system of FIGS. 16 and 16A, according to some embodiments of the disclosure;

FIG. 16C is a top view of the irrigation system of FIGS. 16-16B, taken from line XVIC-XVIC of FIG. 16A, according to some embodiments of the disclosure;

FIG. 16D is a bottom view of the irrigation system of FIGS. 16-16C, taken from line XVID-XVID of FIG. 16A, according to some embodiments of the disclosure;

FIG. 16E is a top, front, side perspective view of the irrigation system of FIGS. 16-16D, according to some embodiments of the disclosure;

FIG. 16F is a bottom, rear, side perspective view of the irrigation system of FIGS. 16-16E, according to some embodiments of the disclosure; and

FIG. 16G is a cross-sectional view of the irrigation system of FIGS. 16-16F, taken from line XVIG-XVIG of FIG. 16B, according to some embodiments of the disclosure.

### DETAILED DESCRIPTION OF THE DISCLOSURE

Systems and methods for irrigating a target are provided.

In the field of horticulture and plant care, maintaining the right level of moisture in the soil can be crucial for the health and growth of plants. Overwatering or underwatering can lead to various plant diseases and can even cause the plant to die. Some watering methods may rely on manual intervention, which can be time-consuming and inefficient. Moreover, such methods may not always provide the optimal amount of water needed by the plants. Therefore, there is a need for a system that can automatically regulate the watering process based on the moisture level in the soil. The field of agriculture and horticulture has long recognized the importance of efficient irrigation systems. Water is a critical resource for plant growth, and its efficient use is paramount, especially in regions where water is scarce or expensive. Some irrigation systems may involve the use of sprinklers or drip lines to deliver water to the soil. However, such systems can be inefficient, leading to water waste through evaporation or runoff. Additionally, such systems may require manual intervention to turn on and off, which can be time-consuming and labor-intensive. Therefore, there is a need for an irrigation system that can efficiently deliver water to the soil, reduce water waste, and automate the watering process.

Irrigation may involve the artificial application of water to soil or land to assist in the growth of crops. While irrigation may seem straightforward, it can be a complex process that requires careful management to ensure that crops receive the right amount of water. Too much water can lead to waterlogging and root diseases, while too little water can lead to wilting and reduced yield. Some irrigation systems may struggle to maintain this delicate balance, leading to inefficient water use and suboptimal crop growth. Furthermore, such systems may require manual intervention to adjust water flow based on changing soil and weather conditions, which can be labor-intensive and time-consuming. Therefore, there is a need for an irrigation system that can provide optimal watering conditions for plant growth while minimizing water waste and manual intervention without using electricity.

Some systems may present problems related to costs and maintenance of available electronic sensory valves in different applications, especially in agricultural domains. Electronic systems have become seemingly omnipresent, promising automation and efficiency. However, they may bring forth a host of challenges, primarily centered around costs and maintenance. In contrast, an adaptive valve that may mechanically control its output based on environment levels may be useful for its ability to perform similar tasks with reduced financial burdens. An electronic system of the disclosure may be configured to employ a distinctive methodology that may significantly reduce the power consumption associated with irrigation while keeping the needed investments also low.

Electronic systems, with their sensors and controllers, may demand substantial upfront investments. For example, adding electronic sensors to control irrigation of a 1,000,000 square meter farm may incur a staggering cost, not to mention ongoing power costs and frequent maintenance requirements. In such a scenario, the total expenses can skyrocket, making it financially impractical.

To the contrary, valves that may mechanically adjust their output based on any suitable properties of the soil or other suitable growing medium or target, such as target moisture, target temperature, and/or any suitable chemical levels of the target (e.g., a gas flow valve (e.g., a material 1407) may be configured to react based on a density of any suitable chemical material that may be present in the soil or other suitable target, and the system may be configured to deliver such chemical(s) with the liquid of the system to the target (e.g., any suitable group of chemical fertilizers)) (e.g., by controlling the air pressure that may act on a container of water), can provide a significantly less expensive solution (e.g., a particular material (e.g., using material 1407 or any suitable alternative) may be provided that may be configured to react based on a density of any special chemical material(s) in the target). While electrical sensors can still play a role, they can be used sparingly, thanks to the mechanical valves' precision. This approach may not only address the cost factor, but may also ensure reliability and longevity, making it a compelling choice in today's tech-driven world. In some embodiments, an electronic system of the disclosure may use a similar technique to the mechatronic valves in order to shape a soil specification sensor by indirectly measuring the air pressure that goes into the device.

Some valves may change the output flow rate based on the environment conditions. These may use expandable liquid absorber materials or use weight change after absorbing liquids. Therefore, when such a system is in contact with a liquid, the system may absorb the liquid and consequently some parts of the system may change size and/or may gain extra weight. The change(s) in size and/or weight may then be used to control a mechanical valve. However, such changes may not be fast enough on both activation and deactivation phase, which may make the sensors not practical in certain real scenarios as some of these materials may need a long time to give the absorbed liquid back to the environment and for the valve to go back into its initial condition.

Balancing electronic innovation with mechanical reliability may be useful for providing efficient and effective solutions for various situations. While electronic systems have transformed our lives, they present challenges in costs and maintenance. A mechanical valve that may be capable of adapting irrigation of a target, such as soil, based on the target's moisture levels, temperature, and/or chemical levels, can offer practicality, reliability, and sustainability. A system of the disclosure, when combined with a reduced number of electrical sensors, if any, may not only cut costs but also may conserve water efficiently. The use of such a system may not be limited to the field of agriculture. Instead, such a system can be configured to react based on any suitable environmental changes of a target or its environment and can be used in several different domains. An irrigation system of the disclosure may be configured for any suitable use case beyond providing liquid to a soil or other growing medium. For example, a system of the disclosure may be configured to adjust the output of a substance (e.g., water or any suitable firefighting matter) from the system to a target (e.g., a room in which the system is located) based on the temperature of the target (e.g., temperature of the air of the room). As a particular example, a material (e.g., material 1407) of a system may be configured to expand with temperature and be coupled to a spring or any other suitable mechanism such that it may be used to shut off or reduce the output of a substance for fighting fire when the temperature of the target is reduced, which may be helpful to stop a fire extinguisher or sprinkler system once a fire has been reduced or terminated. As another example, a system of the disclosure may be configured to develop toilet flush tanks that may use a smaller space, wherein a valve of the system may be placed inside a water tank of a toilet and may not need a big float that may be used in some flush tanks, and instead use any suitable filters or ceramic parts (e.g., when a material 1407 may be removed) that may prevent water from entering into air channels of the system. Therefore, a system of the disclosure may be used with any suitable target, including soil, air, or even water or any other suitable liquid as a medium.

In accordance some embodiments, an irrigation system is provided that may include a container for holding fluid. The system may include a liquid outlet for discharging the fluid to the ground. The system may also include a gas conduit for transporting gas to the container. The system may also include an absorbent material, which may be partially positioned in the gas conduit and partially in contact with the ground. The liquid concentration in the absorbent material may regulate the flow of gas transported to the container. The fluid may be discharged from the container in proportion to the volume of gas transported to the container. The system may also include a liquid inlet for accepting fluid from a fluid supply. The system may also include a reservoir located within the container. The system may also include a fluid control mechanism for managing the liquid inlet. The absorbent material, which may be a fabric wick, may control the flow of air delivered to the fluid vessel. The fluid may be released from the fluid vessel proportional to the amount of air delivered to the fluid vessel through the gas conduit. An added layer on top of the wick (e.g., a barrier on an absorber) may be adjustable to reduce or increase the surface of the wick that may be in contact with soil or air that may result in changing the needed time for returning the wick to its original state. In some embodiments, the system may include a separate air channel that may take the air to the wick. Such an air channel may be adjusted to reduce or increase the needed time for returning the wick to its original state. Furthermore, the amount and/or location of the water exit can be adjusted in order to reduce or increase the time that may be needed to take the wick from its original state into a wet state. The wick can be connected to other types of materials, such as plastic to reduce or increase the time that the wick may need to return to its original state. For example, a fabric may be configured to dry a short time after being made wet when the totality or a majority of the fabric is exposed to a drying environment (e.g., air). However, the same fabric may take longer to dry when some or substantially all of the fabric is not exposed to such a drying environment but is instead separated from such a drying environment by any suitable additional material(s) (e.g., a fabric wick may be covered by a thick plastic surface or other suitable drying barrier that may prevent the drying environment from helping dry the fabric except for one or more small holes provided through the plastic surface). The area, size, shape, and/or number of such holes and/or the type of such drying barrier and/or the coverage amount of the fabric by the barrier (e.g., coverage area or coverage ratio of covered area to uncovered area) may be adjusted to enable a desired time to return a wick to its original (e.g., dry) state from a wet or any other suitable transformed state of the wick (e.g., in some embodiments, the less coverage area, the faster to transition from wet to dry). For example, as described with respect to system 1400, a protection material or mechanism 1408 may be developed to protect an absorber material or mechanism 1407, while a channel 1423 may be provided to take air or any other suitable fluid to mechanism 1407. Any suitable size, shape, position with respect to mechanism 1407, and/or the like of mechanism 1408 and/or of channel 1423 may be adjusted or specifically defined to control the performance (e.g., timing performance of mechanism 1407 and system 1400). Additionally or alternatively, a slider (e.g., slider mechanism 1509 of system 1500) may be used to control the amount of a drying environment (e.g., air) that may be able to travel to and/or otherwise interact with an absorber mechanism. Any suitable barrier component(s) may be provided by any suitable system of the disclosure for limiting a fluid connection between the wick of an absorber mechanism and a target in one or more ways (e.g., to only allow a fluid connection between one or more exposed portions or areas of the absorber mechanism and the target (e.g., just in limited areas) to reduce or increase the needed time for returning the wet or otherwise transitioned wick to its original state). The size, shape, and/or orientation of one or more exposed areas of any suitable absorber mechanism to any suitable target by any suitable barrier mechanism may be adjusted by any suitable adjustment member for allowing adjustment of the time between irrigations (see, e.g., component 1509 of system 1500 (e.g., a component that may be configured to reduce or increase the amount of air that can be transferred via a gas channel), component 1408 of system 1400 (e.g., a mechanism with small areas that may connect with soil by changing the area sizes), a liquid exit may be positioned to dispense liquid on an area of a target that is near an absorber mechanism or far from an absorber mechanism in order to change the transition timing of the system, and/or the like. Any suitable material that may be configured to hold or retain water or any suitable liquid for some amount of time (e.g., wood, cork, cotton, wool, any combination(s) thereof, etc.) may be used as an absorber mechanism of a system.

A benefit of such an irrigation system may be its ability to optimize water consumption. By deploying a large number of these cost-effective mechanical valves across a vast (e.g., 1,000,000 square meter) farm, water can be distributed precisely where and when it is needed. This precision, coupled with reduced electronic sensor dependency, may significantly reduce water consumption.

In some embodiments, a water irrigation system is provided that may be configured to provide liquid, water, and/or any other suitable irrigation solution to soil and/or to any other suitable growing medium or target, including air or even water (e.g., for a fire-fighting use case and/or a toilet use case). An irrigation system may include a container for holding a fluid. The container may include a liquid outlet for discharging the fluid to the soil or ground or other suitable target. The irrigation system may include a gas conduit for transporting gas to the container. The gas may be air entering the gas conduit from an air inlet port. The irrigation system may include an absorbent mechanism (e.g., absorbent material). The absorbent material may include a first portion positioned in a portion of the gas conduit between the air inlet channel and an air passage channel. The absorbent material may include a second portion in contact with the soil or other growing medium or target. The liquid concentration in the absorbent material may regulate the flow of gas transported through the inlet channel and passage channel and into the container. The fluid may be discharged from the liquid outlet port of the container in proportion to the volume of gas delivered to the container. The irrigation system may include a liquid inlet for accepting fluid from a fluid supply. The irrigation system may include an inlet reservoir within the container for receiving the fluid from the liquid inlet. The irrigation system may include a fluid control valve for controlling the passage of fluid from the inlet container to the reservoir container. The fluid control valve may be a reservoir lip for limiting any spillover between the inlet reservoir and the container. The liquid concentration in the absorbent material may control the flow of air delivered to the container, wherein the fluid may be released from the container proportional to the amount of air delivered to the container through the gas conduit.

In some other embodiments, a water irrigation system may include a container for holding fluid. The container may include a liquid outlet for discharging the fluid to the soil or ground. The water irrigation system may include a gas conduit for transporting gas to the container. The gas may be air entering the gas conduit from an air inlet port. The water irrigation system may include an absorbent material. The absorbent material may include a first portion positioned in a portion of the gas conduit between the air inlet channel and a passage channel. The absorbent material may include a second portion in contact with the soil or other growing medium. The liquid concentration in the absorbent material may regulate the flow of gas transported through the inlet channel and passage channel and into the container. The fluid may be discharged from an outlet port of the container in proportion to the volume of gas delivered to the container. The water irrigation system may include a liquid inlet for accepting fluid from a fluid supply line. The fluid supply line may be permanently attached when the system includes a water inlet control valve. The water irrigation system may include an inlet reservoir having at least a portion thereof within the container for receiving the fluid from the liquid inlet. The water irrigation system may include a fluid control valve for controlling the passage of fluid from the inlet container to the reservoir container. The fluid control valve may be activated by buoyancy of the reservoir, controlling the passage of fluid between the inlet reservoir and the container. The liquid concentration in the absorbent material may control the flow of air delivered to the container, wherein the fluid may be released from the container outlet port proportional to the amount of air delivered to the container through the gas conduit. The absorbent material may be a fabric wick.

A system of this disclosure may be configured to control the exit rate of the flow from a liquid container indirectly by controlling the air pressure that may be exerted on top of the liquid. Therefore, if there is no air entering the container, the system may be configured not to release water from the container.

As this disclosure is susceptible to embodiments of many different forms, it is intended that the present disclosure be considered as an example of the principles of the disclosure and not intended to limit the disclosure to the specific embodiments shown and described.

The term fluid is generally referring to any suitable gas and/or liquid, including, but not limited to water or water having a chemical makeup sufficient for plant irrigation, medical purposes, and/or the like.

A gas conduit may be generally referring to an air channel and the gas that may flow through the gas conduit may be air and/or any other suitable gas and/or combination(s) thereof.

The ground may be a target that may be generally referring to soil for sustaining a plant or vegetation, although any other suitable embodiments are possible. The terms exit and outlet (e.g., liquid exit and liquid outlet) may be interchangeable terms.

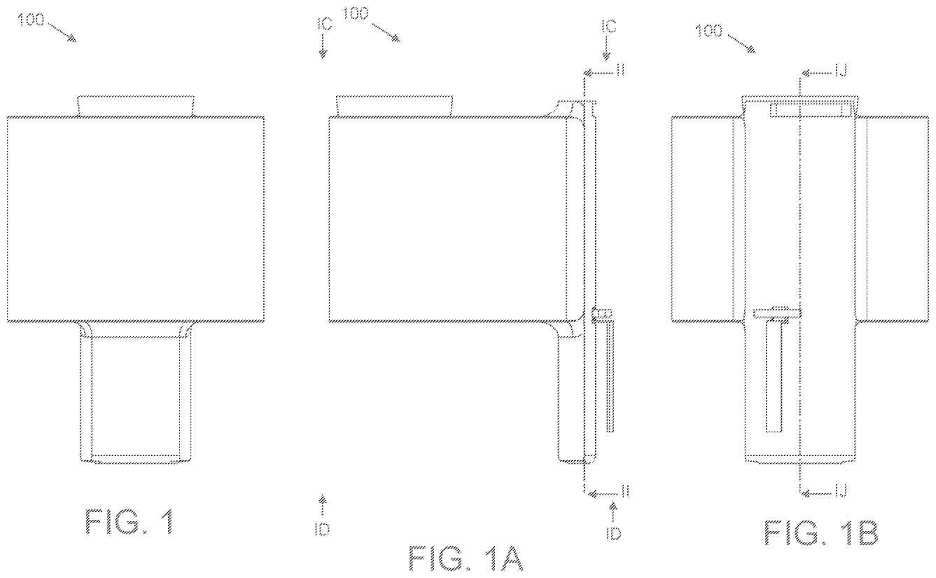

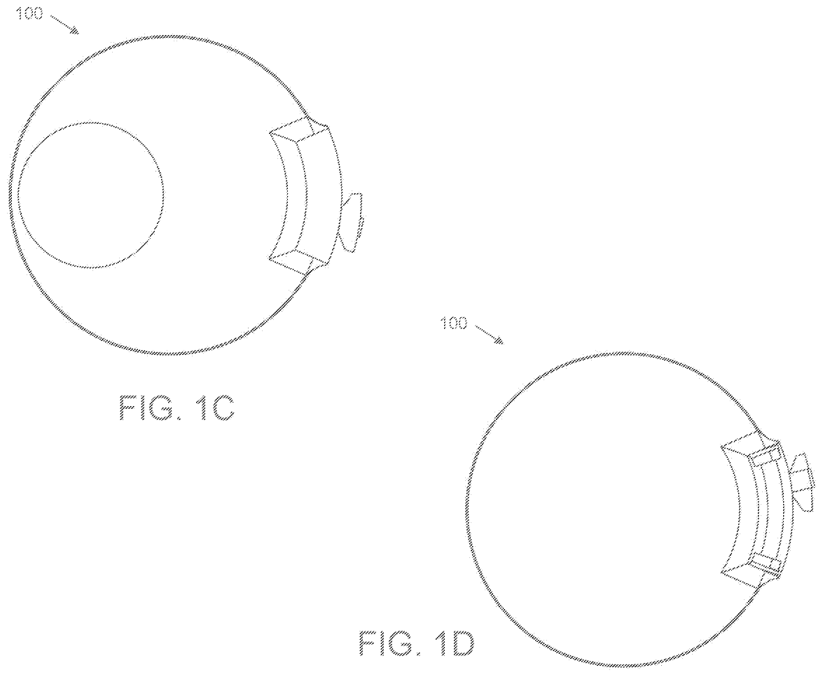

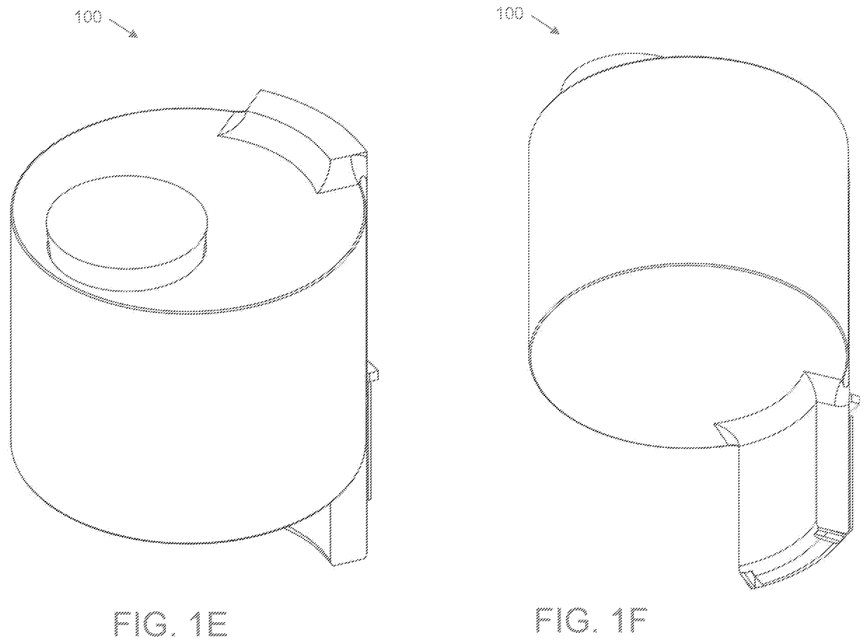

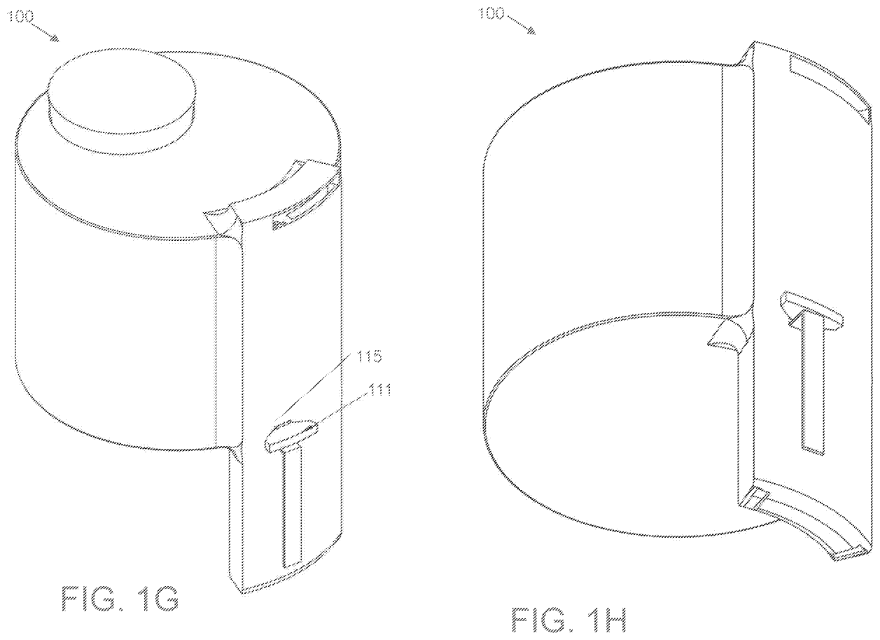

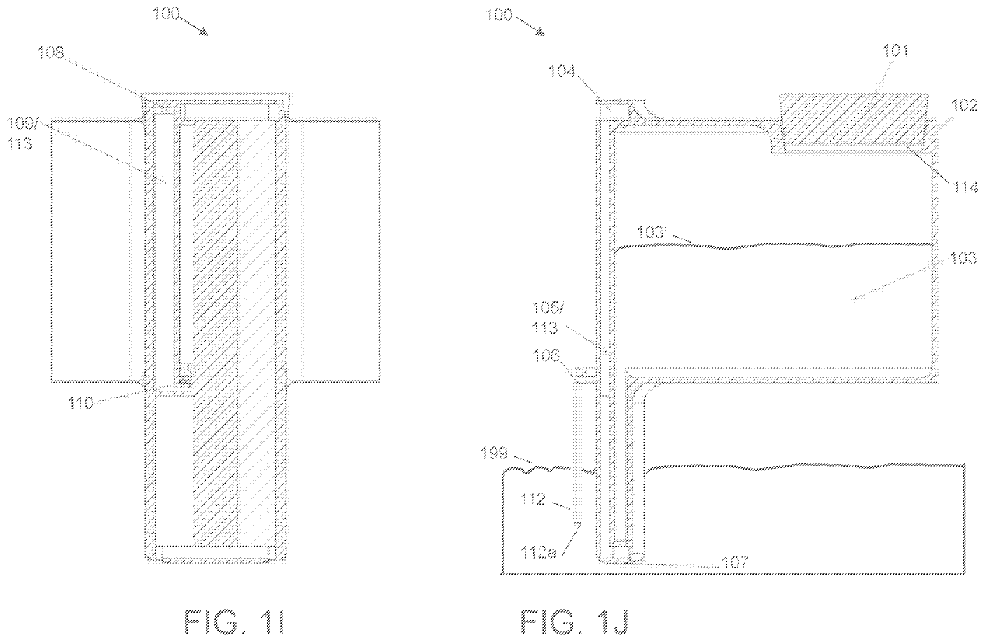

### FIGS. 1-1J

As shown in FIGS. 1-1J, in some embodiments of the disclosure, there may be provided a system 100 (e.g., any suitable irrigation system (e.g., a water irrigation system)) that may be configured to supply any suitable liquid, water, or other suitable irrigation solution to soil or ground or any other suitable growing medium or target (e.g., target 199 of FIG. 1J). As shown, system 100 may include a liquid (e.g., water) container 102. Container 102 may define an accumulation space 103 for holding any suitable fluid(s) (e.g., water, air, etc.). In some embodiments, space 103 may be defined by a rigid structure such that the space may not collapse in volume (e.g., due to any suitable pressure(s)). Any suitable removable seal or head part 101 may be provided for closing or opening a liquid inlet or source opening 114 (e.g., of container 102) for enabling liquid to be supplied into space 103 of container 102 from any suitable liquid source. Container 102 may define any suitable ambient opening 104 that may be exposed to any suitable environment of container 102 for enabling any suitable ambient fluid of the ambient environment (e.g., air) of system 100 to enter into system 100 via opening 104. Container 102 may define any suitable ambient fluid channel 105 that may extend between opening 104 and any suitable absorber mechanism 106 for passing any suitable ambient fluid of the ambient environment between opening 104 and mechanism 106. Container 102 may define any suitable absorber fluid channel 109 that may extend between absorber mechanism 106 and any suitable accumulation opening 108 for passing any suitable fluid via mechanism 106 into accumulation space 103. An absorber mechanism portion 110 (e.g., an internal end) of absorber mechanism 106 may be positioned within ambient fluid channel 105 (e.g., via any suitable absorber opening 115 through container 102) in order to bring mechanism 106 into communication with any fluid within ambient fluid channel 105. Any suitable support 111 (e.g., a support plug (e.g., any suitable plastic part)) may be provided to hold absorber mechanism 106 in place with respect to container 102 (e.g., such that first absorber mechanism portion 110 (e.g., an internal end) of absorber mechanism 106 may be positioned within ambient fluid channel 105 and such that a second absorber mechanism portion 112 (e.g., an external end) may be positioned external to container 102 in order to be exposed to the target (e.g., a portion of mechanism 106 between portions 110 and 112 may extend via opening 115)). At least a portion of absorber mechanism 106 may be any suitable fabric wick. Support 111 may be used for securing mechanism 106 to container 102 (e.g., portion 110 within conduit 113 and/or portion 112 within, at, or near the target (e.g., target 199)). Any suitable protection layer 112a may be provided along any suitable portion of mechanism 106 (e.g., along portion 112) and may be configured to protect at least that portion of mechanism 106 from any possible source(s) of damage (e.g., roots in target 199 that may otherwise damage mechanism 106 if not protected by layer 112a (e.g., a layer of rigid plastic)). In some embodiments, component or layer 112a (e.g., plastic with one or more holes therethrough) may be configured to prevent portion 112 of mechanism 106 from drying out too quickly (e.g., if portion 112 may be exposed to sunlight in the environment), so as to promote liquid being conveyed by portion 112 to another portion of mechanism 106 for transitioning states. Varying the size and/or number of holes through layer 112a may vary the effect of layer 112a on delaying the drying of portion 112. Support may be any suitable plastic or other rigid component, a threaded fastener, adhesive, or any other suitable mechanical securing fastener for securing mechanism 106 in its functional position. Container 102 may include a fluid outlet port 107 for enabling the discharge of any suitable fluid(s) from accumulation space 103 and to the target. Container 102 may define any suitable fluid or gas conduit 113 (e.g., ambient fluid channel 105 and absorber fluid channel 109 that may communicate via absorber mechanism 106) for transporting any suitable fluid (e.g., any suitable gas (e.g., ambient fluid of the ambient environment (e.g., air))) from the ambient environment of system 100 into accumulation space 103. The fluid may be air or any other suitable gas that may enter the channel (e.g., channel 105) via any suitable ambient opening(s) 104 (e.g., as may be described with respect to opening(s) 1508 of system 1500). Ambient fluid channel 105 of conduit 113 may be configured to take air from the ambient environment (e.g., via opening(s) 104) to absorber mechanism 106, while absorber fluid channel 109 of conduit 113 may be configured to take such air from or via absorber mechanism 106 to accumulation space 103 (e.g., via opening(s) 108, which may be positioned above the top surface of any liquid within accumulation space 103). System 100 may include any suitable absorber mechanism 106 that may be provided by any suitable absorbent material(s). Mechanism 106 (e.g., a long wool or cotton fabric) may be configured (e.g., as a wick) to absorb any suitable fluid from the target (e.g., second portion 112 of mechanism 106 may be configured to be in direct contact with the target external to container 102 in order to absorb humidity or otherwise from the target) and variably block the flow of any suitable fluid (e.g., air) through conduit 113 between opening(s) 104 at the ambient environment and opening(s) 108 at accumulation space 103 (e.g., first portion 110 of mechanism 106 may be configured to block to a varying degree communication between channels 105 and 109 of conduit 113 when first portion 110 has expanded or otherwise transitioned from an original state (e.g., a dry state) to a transitioned state (e.g., a wet state)). In some embodiments, as shown in FIG. 1J the target, such as target 199, may be positioned at least a minimum distance from (e.g., below) ambient opening 104 such that the target may not block a source of ambient fluid for conduit 113, while the target may be positioned such that at least a portion of second portion 112 of absorber mechanism 106 may be in fluid communication with the target (e.g., a tip of second portion 112 may be positioned within the target). In some other embodiments, even ambient opening 104 may be positioned below the top of target 199 (e.g., opening 104 may be positioned within target 199, as certain targets may allow gas (e.g., air) to pass through the target (e.g., air may pass through soil)). Therefore, liquid concentration or other suitable transitioning in mechanism 106 (e.g., in portion 110 of mechanism 106) may be configured to regulate the flow of fluid (e.g., gas (e.g., air)) transported through conduit 113 between opening(s) 104 and opening(s) 108 (e.g., between the ambient environment and accumulation space 103 of container 102). Fluid may be discharged from accumulation space 103 (e.g., via fluid outlet port(s) 107) in proportion to the gas delivered to accumulation space 103 via conduit 113 (e.g., pressure created by the introduction of new fluid (e.g., air into accumulation space 103 via conduit 113 and opening(s) 108) may be equalized by the removal of fluid (e.g., liquid from accumulation space 103 via outlet port(s) 107)). Any suitable removable seal or head part 101 may be provided for creating an air tight seal when it is not removed for enabling fluid from an external fluid source from adding fluid into accumulation space 103 via any suitable source opening 114 (e.g., seal 101 may be removed from opening 114 when a hose or any other suitable fluid source may be used to inject liquid (e.g., water) into accumulation space 103 via opening 114, and seal 101 may be positioned at opening 114 to seal opening 114 shut to create an air tight seal at opening 114 (e.g., such that when seal 101 may close opening 114, ambient fluid (e.g., air) may only enter accumulation space 103 via conduit 113 and not also via opening 114 and/or fluid outlet port(s) 107 (e.g., port(s) 107 may be configured as one-way valves for releasing fluid from space 103 but not for introducing fluid into space 103)) and/or via absorber opening 115 (e.g., opening 115 may allow a portion of mechanism 106 to pass therethrough without allowing air to pass about mechanism 106 through opening 115). When a liquid is dispensed from accumulation space 103 of container 102 through port(s) 107, ambient pressure above the liquid level in space 103 may drop and create a partial vacuum. This vacuum may be filled by a volume of fluid (e.g., air) that may be generally equal to the volume of liquid that has been removed to equalize the pressure within the container. This pressure may be equalized by external air drawn into the container through conduit 113 and not through the same valve aperture through which the liquid exited the container (e.g., not through port(s) 107) and not through sealed opening(s) 114 and not through opening(s) 115. Because an air-back passageway (e.g., conduit 113) may be at least in part formed separately from the liquid-out passageway (e.g., outlet port(s) 107), air can flow into the container (e.g., accumulation space 103) simultaneously with the dispensing of liquid therefrom. Thus, the pressure can continuously be equalized or attempted to be equalized (e.g., by gas conduit 113) between the exterior of the container and the interior of the container above the liquid level within accumulation space 103 (e.g., liquid level 103′ of FIG. 1J), so that the liquid may flow smoothly and/or at a controllable rate that may be dictated by liquid concentration or any other suitable transitioning in mechanism 106 (e.g., in portion 110 of mechanism 106) within conduit 113 (e.g., due to any suitable characteristic(s) of the target that may be exposed to portion 112 of mechanism 106 (e.g., target moisture level(s), target temperature level(s), level(s) of any suitable chemical(s) in the target, etc.)) for controlling the amount of ambient air that may be introduced into accumulation space 103). For example, an equilibrium for liquid out and air in may be sought or achieved until an absorber mechanism gets wet and transitions for blocking the flow of air through the gas conduit and into the accumulation space, such that there may no longer be an equilibrium and pressure down on the liquid may no longer be applied, such that a liquid outlet valve may close and stop dispensing liquid from the accumulation space.

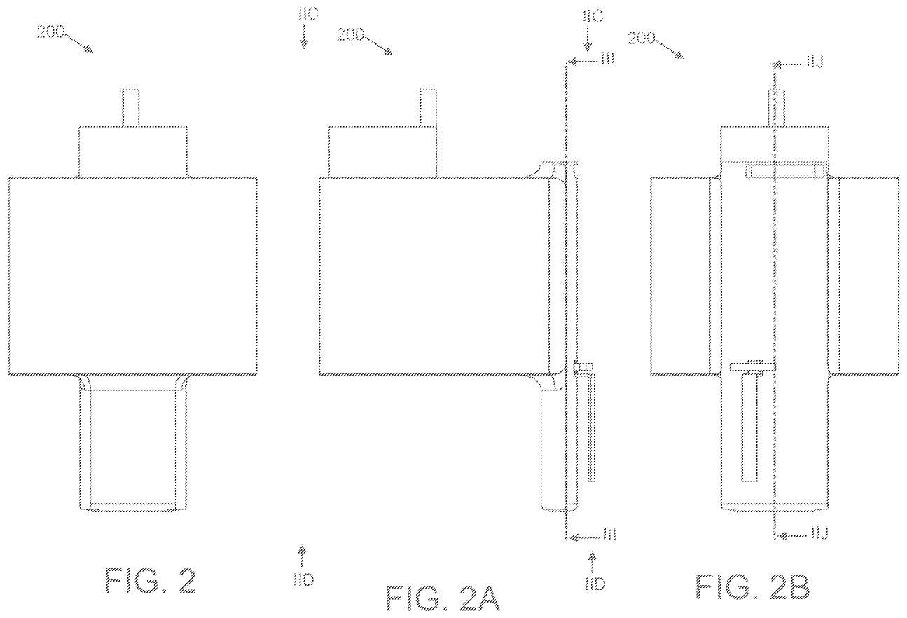

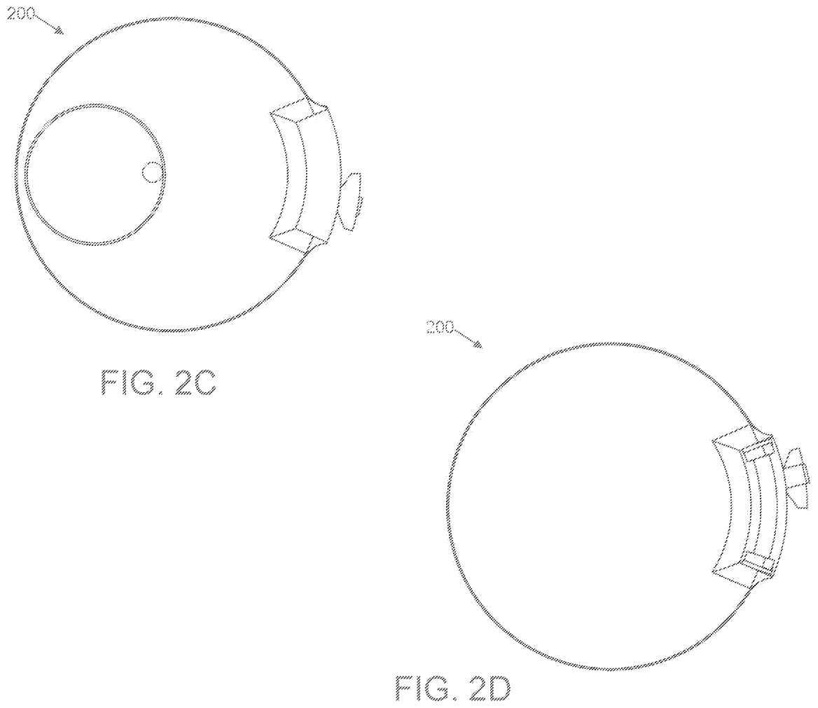

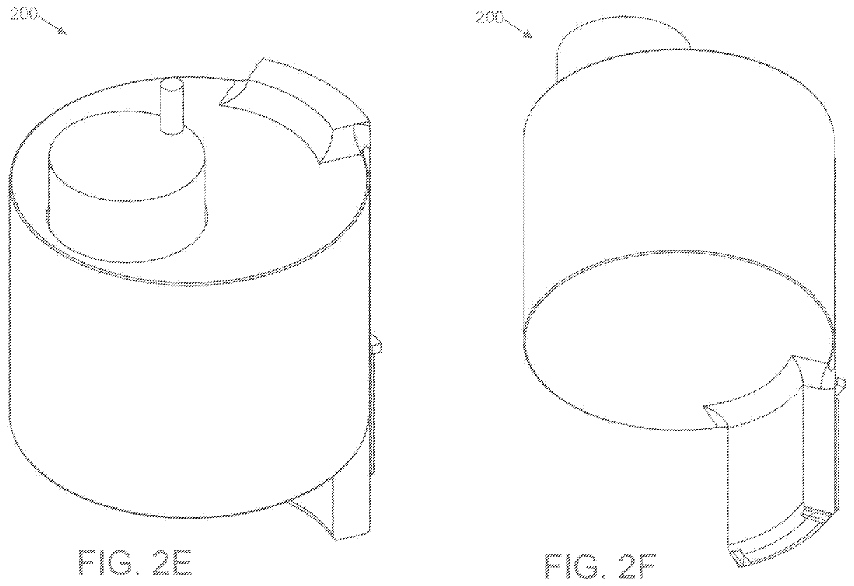

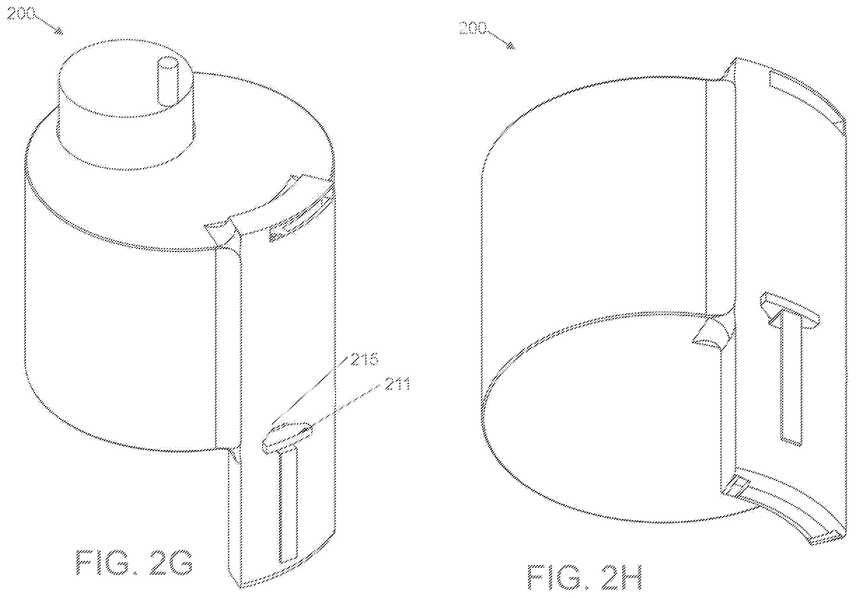

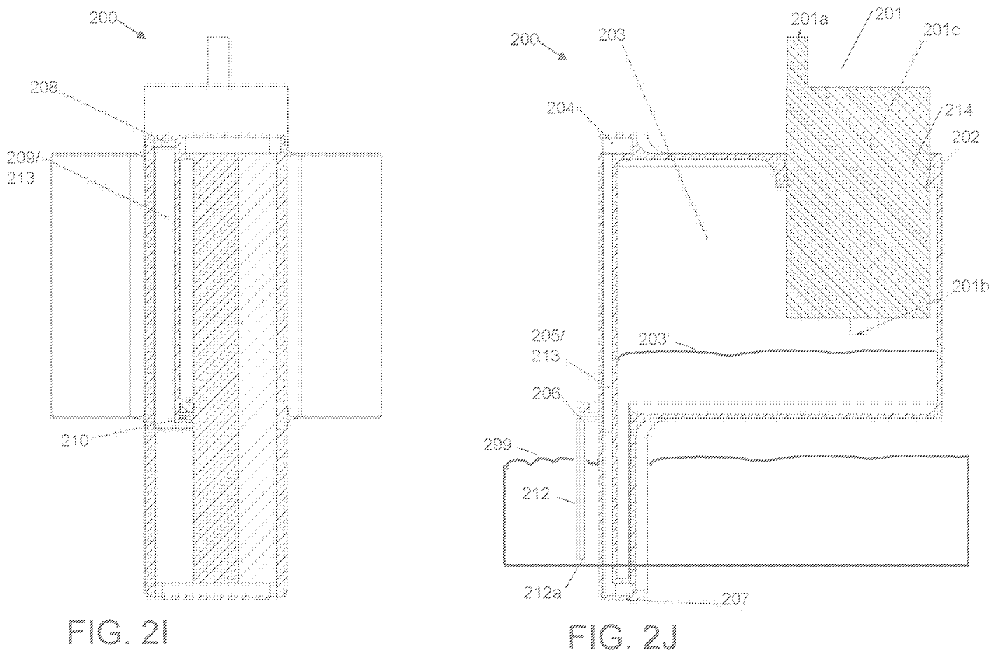

### FIGS. 2-2J

As shown in FIGS. 2-2J, in some embodiments of the disclosure, there may be provided a system 200, which may be similar to or the same as system 100 in various ways. As shown, system 200 may include a liquid (e.g., water) container 202. Container 202 may define an accumulation space 203 for holding any suitable fluid(s) (e.g., water, air, etc.). Any suitable removable seal or head assembly 201 may be provided for closing or opening a liquid inlet or source opening 214 (e.g., of container 202) for enabling liquid to be supplied into space 203 of container 202 from any suitable liquid source. Container 202 may define any suitable ambient opening 204 that may be exposed to any suitable environment of container 202 for enabling any suitable ambient fluid of the ambient environment (e.g., air) of system 200 to enter into system 200 via opening 204. Container 202 may define any suitable ambient fluid channel 205 that may extend between opening 204 and any suitable absorber mechanism 206 for passing any suitable ambient fluid of the ambient environment between opening 204 and mechanism 206. Container 202 may define any suitable absorber fluid channel 209 that may extend between absorber mechanism 206 and any suitable accumulation opening 208 for passing any suitable fluid via mechanism 206 into accumulation space 203. An absorber mechanism portion 210 (e.g., an internal end) of absorber mechanism 206 may be positioned within ambient fluid channel 205 (e.g., via any suitable absorber opening 215 through container 202) in order to bring mechanism 206 into communication with any fluid within ambient fluid channel 205. Any suitable support 211 (e.g., a support plug (e.g., any suitable plastic part)) may be provided to hold absorber mechanism 206 in place with respect to container 202 (e.g., such that first absorber mechanism portion 210 (e.g., an internal end) of absorber mechanism 206 may be positioned within ambient fluid channel 205 and such that a second absorber mechanism portion 212 (e.g., an external end) may be positioned external to container 202 in order to be exposed to the target (e.g., a portion of mechanism 206 between portions 210 and 212 may extend via opening 215)). At least a portion of absorber mechanism 206 may be any suitable fabric wick. Support 211 may be used for securing mechanism 206 to container 202. Any suitable protection layer 212a may be provided along any suitable portion of mechanism 206 (e.g., along portion 212) and may be configured to protect at least that portion of mechanism 206 from any possible source(s) of damage (e.g., roots in a target 299 that may otherwise damage mechanism 206 if not protected by layer 212a (e.g., a layer of rigid plastic)). Container 202 may include any suitable fluid outlet port(s) 207 for enabling the discharge of any suitable fluid(s) from accumulation space 203 and to the target. Container 202 may define any suitable fluid or gas conduit 213 (e.g., ambient fluid channel 205 and absorber fluid channel 209 that may communicate via absorber mechanism 206) for transporting any suitable fluid (e.g., any suitable gas (e.g., ambient fluid of the ambient environment (e.g., air))) from the ambient environment of system 200 into accumulation space 203. The fluid may be air or any other suitable gas that may enter the channel (e.g., channel 205) via any suitable ambient opening(s) 204 (e.g., as may be described with respect to opening(s) 1508 of system 1500). Ambient fluid channel 205 of conduit 213 may be configured to take air from the ambient environment (e.g., via opening(s) 204) to absorber mechanism 206, while absorber fluid channel 209 of conduit 213 may be configured to take such air from or via absorber mechanism 206 to accumulation space 203 (e.g., via opening(s) 208, which may be positioned above the top surface of any liquid within accumulation space 203). System 200 may include any suitable absorber mechanism 206 that may be provided by any suitable absorbent material(s). Mechanism 206 (e.g., a long wool or cotton fabric) may be configured (e.g., as a wick) to absorb any suitable fluid from the target (e.g., second portion 212 of mechanism 206 may be configured to be in direct contact with the target external to container 202 in order to absorb humidity or otherwise from the target) and variably block the flow of any suitable fluid (e.g., air) through conduit 213 between opening(s) 204 at the ambient environment and opening(s) 208 at accumulation space 203 (e.g., first portion 210 of mechanism 206 may be configured to block to a varying degree communication between channels 205 and 209 of conduit 213 when first portion 210 has expanded or otherwise transitioned from an original state (e.g., a dry state) to a transitioned state (e.g., a wet state)). In some embodiments, as shown in FIG. 2J, the target, such as target 299, may be positioned at least a minimum distance from (e.g., below) ambient opening 204 such that the target may not block a source of ambient fluid for conduit 213, while the target may be positioned such that at least a portion of second portion 212 of absorber mechanism 206 may be in fluid communication with the target (e.g., a tip of second portion 212 may be positioned within the target). Therefore, liquid concentration or other suitable transitioning in mechanism 206 (e.g., in portion 210 of mechanism 206) may be configured to regulate the flow of fluid (e.g., gas (e.g., air)) transported through conduit 213 between opening(s) 204 and opening(s) 208 (e.g., between the ambient environment and accumulation space 203 of container 202). Fluid may be discharged from accumulation space 203 (e.g., via fluid outlet port(s) 207) in proportion to the gas delivered to accumulation space 203 via conduit 213 (e.g., pressure created by the introduction of new fluid (e.g., air into accumulation space 203 via conduit 213 and opening(s) 208) may be equalized by the removal of fluid (e.g., liquid from accumulation space 203 via outlet port(s) 207)). Any suitable removable seal or head assembly 201 may be provided for creating an air tight seal when it is not removed for enabling fluid from an external fluid source from adding fluid into accumulation space 203 via any suitable source opening 214 (e.g., seal assembly 201 may be removed from opening 214 when a hose or any other suitable fluid source may be used to inject liquid (e.g., water) into accumulation space 203 via opening 214, and seal assembly 201 may be positioned at opening 214 to seal opening 214 shut to create an air tight seal at opening 214 (e.g., such that when seal assembly 201 may close opening 214, ambient fluid (e.g., air) may only enter accumulation space 203 via conduit 213 and not also via opening 214 and/or fluid outlet port(s) 207 (e.g., port(s) 207 may be configured as one-way valves for releasing fluid from space 203 but not for introducing fluid into space 203) and not also via opening(s) 215). When a liquid is dispensed from accumulation space 203 of container 202 through port(s) 207, ambient pressure above the liquid level in space 203 may drop and create a partial vacuum. This vacuum may be filled by a volume of fluid (e.g., air) that may be generally equal to the volume of liquid that has been removed to equalize the pressure within the container. This pressure may be equalized by external air drawn into the container through conduit 213 and not through the same valve aperture through which the liquid exited the container (e.g., not through port(s) 207) and not through sealed opening(s) 214 and not through opening(s) 215. Because an air-back passageway (e.g., conduit 213) may be at least in part formed separately from the liquid-out passageway (e.g., outlet port(s) 207), air can flow into the container (e.g., accumulation space 203) simultaneously with the dispensing of liquid therefrom. Thus, the pressure can continuously be equalized between the exterior of the container and the interior of the container above the liquid level within accumulation space 203 (e.g., liquid level 203′ of FIG. 2J), so that the liquid may flow smoothly and/or at a controllable rate that may be dictated by liquid concentration or any other suitable transitioning in mechanism 206 (e.g., in portion 210 of mechanism 206) within conduit 213 (e.g., due to any suitable characteristic(s) of the target that may be exposed to portion 212 of mechanism 206 (e.g., target moisture level(s), target temperature level(s), level(s) of any suitable chemical(s) in the target, etc.)).

Seal assembly 201 may include any suitable liquid assembly inlet(s) 201a, any suitable liquid assembly outlet(s) 201b, and any suitable liquid level controller 201c that may be configured to maintain liquid in accumulation space 203 such that a liquid level of liquid within accumulation space 203 (e.g., liquid level 203′ of FIG. 2J) may not reach or exceed ambient opening 204 or double level float controllers that may be configured to release water if water reaches to the bottom of space 203 and/or to stop water when water reaches to the top of space 203. Controller 201c may be provided by any suitable mechanical controller, such as a float controller (see, e.g., system 800) for shutting of the input of liquid into accumulation space 203.

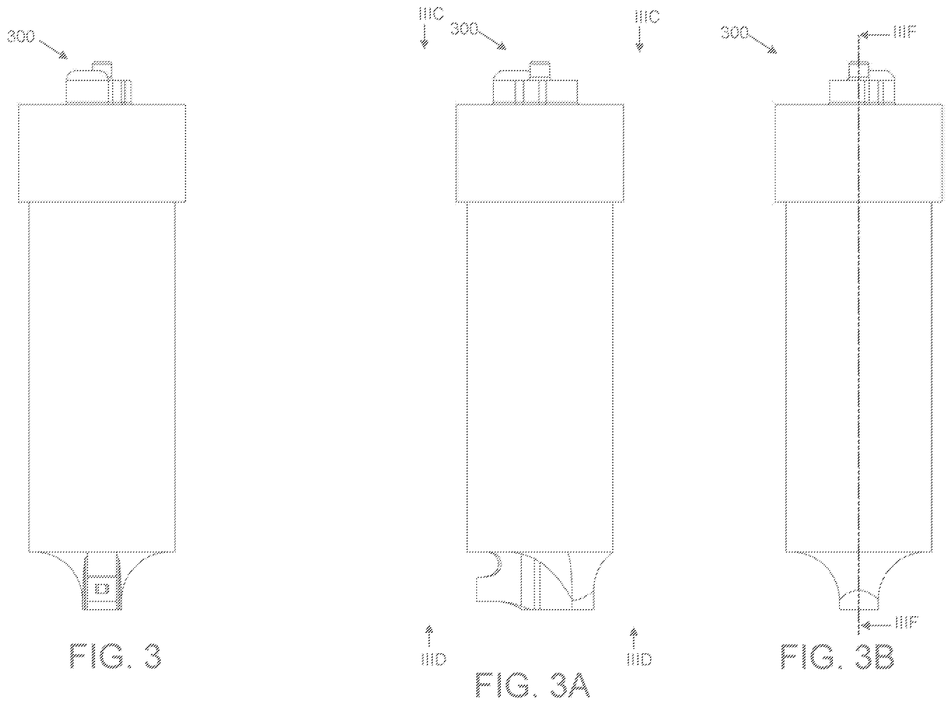

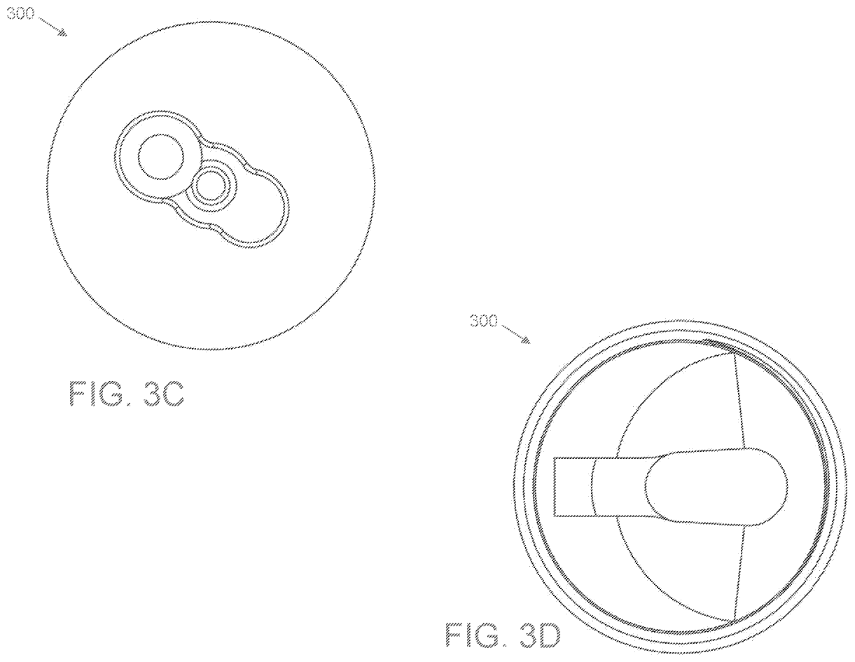

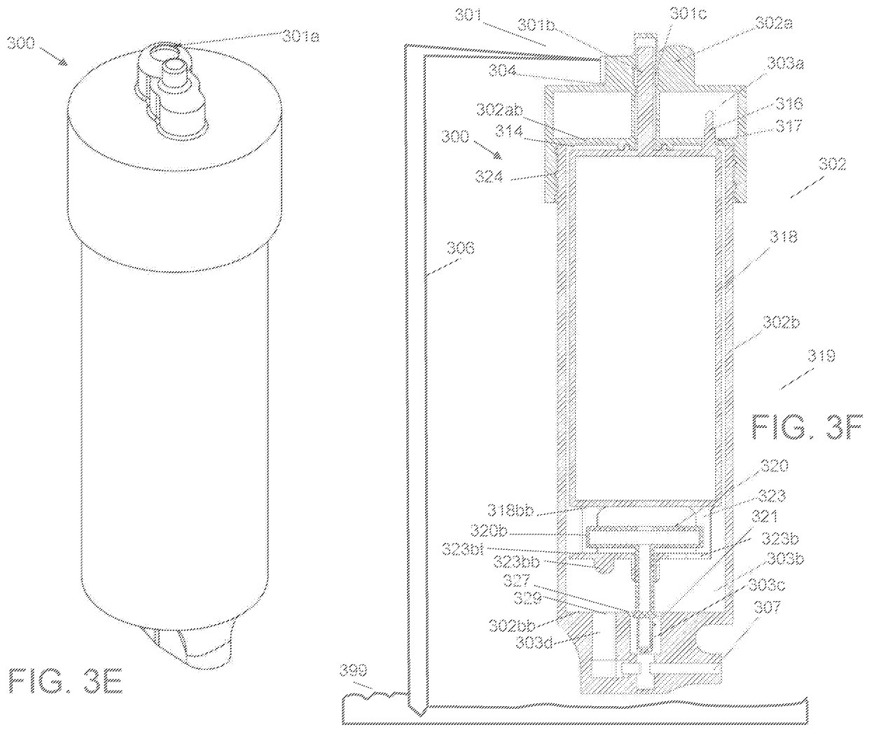

### FIGS. 3-3F

As shown in FIGS. 3-3F, in some embodiments of the disclosure, there may be provided a system 300, which may be similar to or the same as system 100 and/or system 200 in various ways, and which may be configured to supply any suitable liquid, water, or other suitable irrigation solution to soil or ground or any other suitable growing medium or target. As shown, system 300 may include a liquid (e.g., water) container assembly 302. Container assembly 302 may include a top container 302a that may define a top liquid accumulation space 303a for holding any suitable fluid(s) and a bottom container 302b that may define a bottom liquid accumulation space 303b for holding any suitable fluid(s). Top container 302a may include any suitable head assembly 301 for enabling any suitable liquid to be introduced into the accumulation space(s) 303 of container assembly 302 (e.g., spaces 303a and 303b), while bottom container 302b may include any suitable fluid outlet port(s) 307 for enabling the discharge of any suitable fluid(s) from accumulation space(s) 303 and to any suitable target. Top container 302a may be coupled to bottom container 302b using any suitable mechanism(s) or feature(s) 324 (e.g., screws, adhesives, snaps, etc.), which may be configured to create an air-tight seal between containers 302a and 302b and/or between accumulation spaces 303a and 303b. For example, as shown in FIG. 3F, when containers 302a and 302b may be coupled, a source opening 314 of container 302b at a top of accumulation space 303b may be held against or adjacent a wall 302ab of container 302a that may define a bottom of space 303a, while any suitable space opening(s) 317 may be provided through wall 302ab for fluidly coupling space 303a with space 303b (e.g., via source opening 314). Any suitable float assembly 319 may be positioned at least partially within space 303b and held therein by container 302a and container 302b when containers 302a and 302b are coupled together (e.g., by feature(s) 324). Float assembly 319 may include a top float 318 and a bottom float 320. Top float 318 may include any suitable top shaft(s) 316, a top portion of each of which may pass up into space 303a through a respective space opening 317 and seal the respective space opening 317 for terminating fluid communication between accumulation spaces 303a and 303b when top float 318 is biased upwardly within space 303b towards top container 302a (e.g., up towards and against a bottom of wall 302ab or otherwise (e.g., as shown in FIG. 3F)), and each of which may travel down away from space 303a and at least partially out from a respective space opening and unseal the respective space opening for enabling fluid communication between accumulation spaces 303a and 303b when top float 318 is not biased upwardly within space 303b towards top container 302a (e.g., such that liquid within space 303a may travel downwardly via opening(s) 317 into space 303b (e.g., downwardly along and about top float 318)). Bottom float 320 may include any suitable bottom shaft(s) 321 extending downwardly from a base 320b of bottom float 320, a bottom portion of each shaft 321 may pass down into a space portion 303c of bottom space 303b through a respective space opening 327 and seal a respective fluid outlet port 307 for terminating fluid communication between accumulation space 303b and fluid outlet port(s) 307 via space portion 303c when bottom float 320 is biased downwardly within space 303b towards the bottom of bottom container 302b (e.g., down towards a top of a bottom wall 302bb of bottom container 302b or otherwise), and each shaft 321 may travel up away from space 303c and at least partially out from space 303c and unseal the respective fluid outlet port 307 for enabling fluid communication between accumulation space 303b and fluid outlet port(s) 307 via space portion 303c when bottom float 320 is not biased downwardly within space 303b towards the bottom of bottom container 302b (e.g., such that liquid within space 303b may travel downwardly via space(s) 303c and through fluid outlet port(s) 307 and flow into an ambient environment of container assembly 302 (e.g., into any suitable target of system 300)). Therefore, bottom float 320 may be configured to selectively fluidly couple or fluidly decouple fluid outlet port(s) 307 and bottom accumulation space 303b. Bottom float 320 may be movably coupled to top float 318 via a float coupler 323 of float assembly 319. Float coupler 323 may be fixedly and/or immovably coupled to a bottom surface 318bb of a bottom of top float 318 and may be configured to prevent any substantial left/right movement of float 320 with respect to float 318 and/or may be configured to limit the upward/downward movement of base 320b of bottom float 320 with respect to bottom surface 318bb of a bottom of top float 318 and a top surface 323bt of a bottom base 323b of float coupler 323, where top surface 323bt of bottom base 323b of float coupler 323 and bottom surface 318bb of a bottom of bottom float 318 may be separated by a fixed distance along which base 320b of bottom float 320 may travel with respect to top float 318 and float coupler 323. Therefore, float coupler 323 of float assembly 319 may be configured to enable bottom float 320 to move downwardly with top float 318 when base 320b of bottom float 320 is biased against bottom surface 318bb of bottom float 318 and/or to enable bottom float 320 to move upwardly with respect to top float 318 when base 320b of bottom float 320 moves upwardly away from top surface 323bt of bottom base 323b of float coupler 323 (e.g., when bottom float 320 is biased completely down). Therefore, float coupler 323 may be any suitable feature at a bottom of top float 318 that may be configured to allow bottom float 320 to have some limit of free movement with respect to top float 318. Any suitable feature(s) 323bb may extend downwardly from bottom base 323b of float coupler 323 and may be configured to pass down into a space portion 303d of bottom space 303b through a respective space opening 329 and seal fluid outlet port(s) 307 for terminating fluid communication between accumulation space 303b and fluid outlet port(s) 307 via space portion 303d when top float 318 is biased downwardly within space 303b towards the bottom of bottom container 302b (e.g., down towards a top of a bottom wall 302bb of bottom container 302b or otherwise), and each feature 323bb may travel up away from space 303d and at least partially out from space 303d and unseal the respective fluid outlet port(s) 307 for enabling fluid communication between accumulation space 303b and fluid outlet port(s) 307 via space portion 303d when top float 318 is not biased downwardly within space 303b towards the bottom of bottom container 302b (e.g., such that liquid within space 303b may travel downwardly via space(s) 303d and through fluid outlet port(s) 307 and flow into an ambient environment of container assembly 302 (e.g., into any suitable target of system 300)). Therefore, top float 318 may be configured to selectively fluidly couple or fluidly decouple fluid outlet port(s) 307 and bottom accumulation space 303b. One or both of spaces 303c and 303d may receive a respective portion of float assembly 319 (e.g., shaft 321 of bottom float 320 via movement of bottom float 320 and feature(s) 323bb of float coupler 323 via movement of top float 318, respectively) at a particular time or at different times for variably opening or closing the liquid output of the system while opening(s) 317 may receive shaft(s) 316 of top float 320 for opening or closing the liquid input of the system.

System 300 may include any suitable ambient fluid entrance or opening 304 that may be configured to enable the entry of any suitable fluid (e.g., gas (e.g., air)) into container assembly 302. Entrance 304 may be protected by any suitable absorber mechanism 306, which may prevent air from passing through entrance 304 and into any accumulation space(s) of system 300 when absorber mechanism 306 is wet or has otherwise transitioned. An external end portion of absorber mechanism 306 may extend away from entrance 304 and into any suitable target 399.

Head assembly 301 may be configured to include any suitable liquid entrance or liquid assembly inlet(s) 301a for enabling any suitable liquid to be supplied into an initial chamber 301c that may be defined by top container 302a (e.g., extending downwardly through space 303a) and that may variably feed the liquid into accumulation spaces 303. For example, as shown, top float 318 may include any suitable center top shaft 301b, a top portion of which may pass up into chamber 301c and seal chamber 301c for terminating fluid communication between liquid assembly inlet(s) 301a and accumulation spaces 303 via chamber 301c when top float 318 is biased upwardly within space 303b towards top container 302a (e.g., up towards and against a bottom of wall 302ab or otherwise (e.g., as shown in FIG. 3F)), and a top portion of center top shaft 301b may travel down away from chamber 301c and at least partially out from a respective space opening and unseal chamber 301c for enabling fluid communication between liquid assembly inlet(s) 301a and accumulation spaces 303 via chamber 301c when top float 318 is not biased upwardly within space 303b towards top container 302a (e.g., such that liquid within chamber 301c may travel downwardly into space 303b (e.g., downwardly along and about center top shaft 301b of top float 318)). Shaft 301b may be configured as a one-way valve. Therefore, air may be received by top accumulation space 303a and affect liquid movement between top and bottom accumulation spaces. Moisture may be absorbed by mechanism 306, which may enable mechanism 306 to block air entrance 304 for blocking ambient air passage into the system. Shafts 301b and 321 may generally act as a shaft that goes up and down and may be used as a controller (e.g., when float(s) are up, the shaft may be inserted into opening(s) 317 to close the liquid input, and when float(s) are down, liquid output may be completely closed, and may be reopened when liquid within the accumulation space reaches a certain level. Based on the size of spaces 303c, 303d, float 310, float 320, and the float shafts, different timing schemes may be achieved for adding or removing liquid from the accumulation space. While liquid outlet port 307 is shown to be above target 399 in FIG. 3F, outlet port 307 may be positioned within a target in other embodiments. When outlet port 307 is positioned within a target, air may be provided to the environment just external to port 307 (e.g., via an additional air channel), such that external air pressure may be utilized for seeking air pressure equilibrium (e.g., when the target may otherwise deprive outlet port of external air pressure).

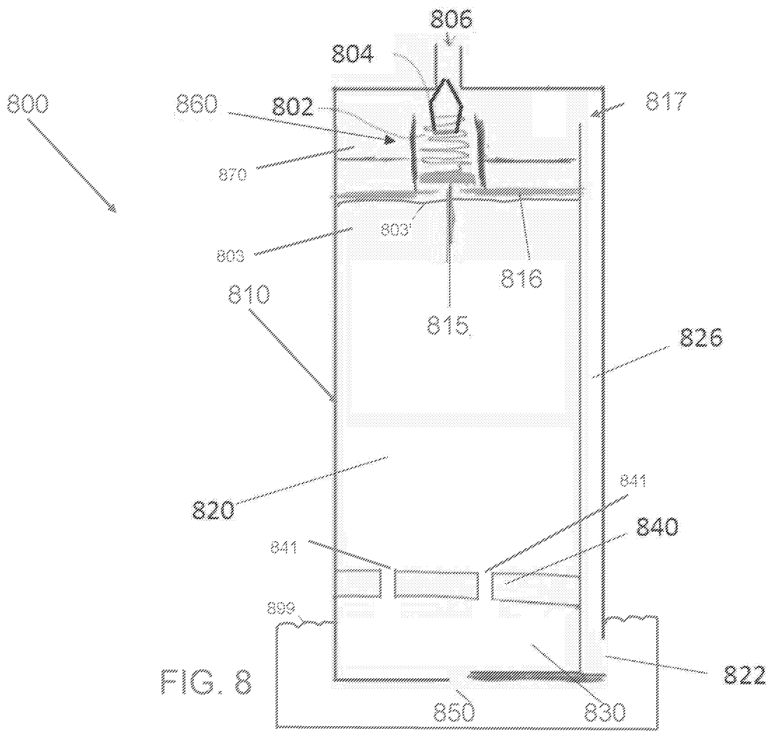

### FIG. 8

As shown in FIG. 8, in some embodiments of the disclosure, there may be provided a system 800 (e.g., a water irrigation system or any suitable moisture sensitive valve system) that may supply any suitable liquid, water, or other suitable irrigation solution to soil or ground or any other suitable growing medium 899. As shown, unlike in system 100, system 800 may include a spring-loaded one-way valve and multiple (e.g., three) accumulation spaces (e.g., reservoirs 870, 820, and 830) stacked from top to bottom of a container. System 800 may be similar to any suitable system of the disclosure and may include any suitable fluid (e.g., liquid) control valve 860 that may be used with any suitable system of the disclosure. Valve 860 may be configured to control the passage of fluid from any suitable fluid (e.g., liquid) supply (not shown) into a reservoir 820 of a container 810 and may include any suitable liquid (e.g., fluid) inlet 806 port that may be configured for accepting the fluid from the fluid supply into reservoir 820. Valve 860 may include a float support 816 for slidingly supporting a float 815 (e.g., so float 815 may only move up or down). Float 815 may be any suitable mechanism made of any suitable material(s) that may be configured to float on a top surface 803′ of a liquid 803 within reservoir 820 and to raise, via any suitable bias or spring mechanism 802, an inlet seal 804 into inlet 806 for sealing inlet 806 when the top surface of the liquid in reservoir 820 rises to a certain level. For example, once enough liquid is in reservoir 820, seal 804 may be forced by the liquid within reservoir 820 into or otherwise against inlet 806 (e.g., via mechanism 802) with sufficient force to seal inlet 806 in order to prevent the fluid supply from passing more fluid through inlet 806 into reservoir 820. Mechanism 802 may bias float 815 against the top surface of the liquid in reservoir 820 or at least down away from inlet 806 by any suitable amount such that float 815 and seal 804 may be biased away from inlet 806 in order for fluid to flow into reservoir 820 via inlet 806 above float 815 until the force of such fluid below float 815 within reservoir 820 in an upward direction against float 815 may overcome the force in a downward direction by mechanism 802 against float 815 such that float 815 and mechanism 802 and seal 804 may enable upward movement of seal 804 into inlet 806 for sealing inlet 806. Once the force of fluid within reservoir 820 below float 815 in an upward direction against float 815 is no longer able to overcome the force in a downward direction by mechanism 802 and/or fluid pushing downward through inlet 806 from the fluid supply against float 815, float 815 and mechanism 802 and seal 804 may enable downward movement of seal 804 away from inlet 806 for unsealing inlet 806 and allowing the fluid from the fluid supply to enter reservoir 820 via inlet 806. Mechanism 802 may be configured to prevent a water flow cycle of system 800 from being too short. Mechanism 802 may be configured to form a one-way valve with seal 804 and float 815 in order to let the input fluid (e.g., water) from the fluid supply flow into container 810 only after a certain input pressure is achieved. A plurality of floats 815 may be placed at different heights (e.g., within reservoir 820) to open and close liquid inlet port 806 at respective different liquid levels. Container 810 may be similar to any suitable container of the disclosure and may include any suitable buffer reservoir 830 and any suitable flow limiter 840 that may be used with any suitable system of the disclosure. Flow limiter 840 may be configured for limiting an amount of liquid released from an outlet 850 of container 810 during time periods when inlet reservoir 820 is being filled. An amount of liquid allowed through flow limiter 840 may be sufficient to allow proper use of a gas conduit 826 and a gas inlet opening 822 of gas conduit 826 to the ambient environment and a gas outlet port 817 of gas conduit 826 to reservoir 820. System 800 may be referred to as including an inlet float valve. In a normal situation, input flow from liquid inlet port 806 may force seal 804 to go down. However, in case no air can come from gas conduit 826 into reservoir 870 via gas outlet port 817, liquid may face higher resistance when passing flow limiter 840, which may be any suitable structure (e.g., a normal rigid structure with small holes (e.g., holes 841) or channels, fabrics, filters with small holes, etc.). Such higher resistance may result in accumulation of liquid in reservoir 820 when liquid is accumulated in this space, whereby float 815 and float support 816 may be pushed up, whereby float 815 may be pushed up to apply a higher upward force on spring mechanism 802 for forcing seal 804 into inlet 806, which may prevent liquid from coming in through inlet 806 into reservoir 870. The lower reservoir may be configured to cause resistance and prohibit air from entering the system if a small amount of liquid is inside the system. Support 816 may be fixed with respect to reservoir 870 and reservoir 820, as support 816 may be configured to support spring 802 float 815 for upward and downward movement with respect to support 816.s

### FIG. 9

As shown in FIG. 9, in some embodiments of the disclosure, there may be provided a system 900 (e.g., a water irrigation system or any suitable moisture sensitive valve system) that may supply any suitable liquid, water, or other suitable irrigation solution (e.g., water, as shown) to soil or ground or any other suitable growing medium or target 999. System 900 may be similar to any suitable system of the disclosure and may include a container 910 that may include a reservoir 920 and a liquid outlet 950 for discharging any suitable liquid 903 (e.g., water) from reservoir 920 to the target. System 900 may include a gas conduit 926 for transporting any suitable atmospheric fluid (e.g., atmospheric gas) into reservoir 920 via any suitable gas inlet port 917. System 900 may include any suitable gas control valve fabric or material or mechanism 912 (e.g., any suitable material (e.g., any suitable absorbent material), which may be the same as or similar to absorber mechanism 106, 206, and/or the like) that may be configured to control the flow of atmospheric gas into gas conduit 926 through a gas inlet opening 922 in gas conduit 926, such that the gas may then travel through gas conduit 926 and into reservoir 920 via port 917 of gas conduit 926. Absorber mechanism 912 may be coupled to conduit 926 in any suitable manner with respect to opening 922 for controlling the flow of gas therethrough (e.g., a material of mechanism 912 may be tightly held within opening 922 through respective geometries and/or through use of any suitable support (e.g., support 111, support 211, etc.). The amount of fluid (e.g., liquid) that may be released from container 910 (e.g., from reservoir 920) via liquid outlet 950 may be proportional to the amount of fluid (e.g., atmospheric gas) that may be delivered to container 910 (e.g., into reservoir 920) via conduit 926. System 900 may also include a liquid control valve (e.g., a valve that may be the same as or similar to fluid control valve 860 of system 800) for controlling the passage of the fluid into reservoir 920, such as via a liquid inlet port (e.g., a port that may be the same as or similar to port 806 of system 800) for accepting any suitable fluid from any suitable fluid supply into reservoir 920.

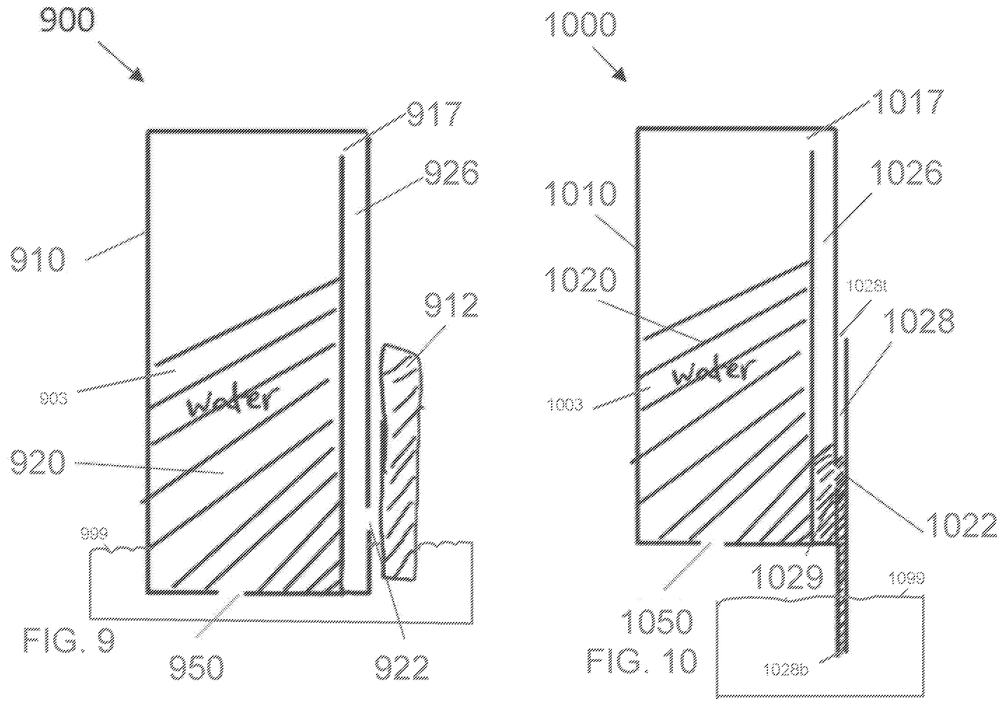

### FIG. 10

As shown in FIG. 10, in some embodiments of the disclosure, there may be provided a system 1000 (e.g., a water irrigation system or any suitable moisture sensitive valve system) that may supply any suitable liquid, water, or other suitable irrigation solution (e.g., water, as shown) to soil or ground or any other suitable growing medium or target 1099. System 1000 may be similar to any suitable system of the disclosure and may include a container 1010 that may include a reservoir 1020 and a liquid outlet 1050 for discharging any suitable liquid 1003 (e.g., water) from reservoir 1020 to the target. System 1000 may include a gas conduit 1026 for transporting any suitable atmospheric fluid (e.g., atmospheric gas) into reservoir 1020 via any suitable gas inlet port 1017. System 1000 may include any suitable tube (e.g., a thin and/or short tube) or valve 1028 (e.g., a capillary controlled valve) that may be configured to control the flow of atmospheric gas into gas conduit 1026 through a gas inlet opening 1022 (e.g., a capillary opening) in gas conduit 1026, such that the gas may then travel through gas conduit 1026 and into reservoir 1020 via port 1017 of gas conduit 1026. If a bottom open end 1028b of tube 1028 is positioned within target (e.g., soil) 1099 and the target is wet, water or any other suitable liquid 1029 may rise up inside tube 1028 (e.g., due to capillary effect) and may enter or otherwise block opening 1022, which may prevent air or any other suitable gas from entering into gas conduit 1026 (e.g., via a top open end 1028t of tube 1028). Therefore, a capillary effect of tube 1028 may adjust the amount of gas pressure provided to reservoir 1020 by conduit 1026. Therefore, liquid 1029 may be drawn into or otherwise received by gas conduit 1026 via valve 1028 and opening 1022 and may block the passage of atmospheric gas via opening 1022 and conduit 1026 into reservoir 1020. The amount of fluid (e.g., liquid) that may be released from container 1010 (e.g., from reservoir 1020) via liquid outlet 1050 may be proportional to the amount of fluid (e.g., atmospheric gas) that may be delivered to container 1010 (e.g., into reservoir 1020) via conduit 1026. System 1000 may also include a liquid control valve (e.g., a valve that may be the same as or similar to fluid control valve 860 of system 800) for controlling the passage of the fluid into reservoir 1020, such as via a liquid inlet port (e.g., a port that may be the same as or similar to port 806 of system 800) for accepting any suitable fluid from any suitable fluid supply into reservoir 1020.

### FIG. 11

As shown in FIG. 11, in some embodiments of the disclosure, there may be provided a system 1100 (e.g., a water irrigation system or any suitable moisture sensitive valve system) that may supply any suitable liquid, water, or other suitable irrigation solution (e.g., water, as shown) to soil or ground or any other suitable growing medium or target 1199. System 1100 may be similar to any suitable system of the disclosure and may include a container 1110 that may include a reservoir 1120 and a liquid outlet 1150 for discharging any suitable liquid 1103 (e.g., water) from reservoir 1120 to the target. System 1100 may include a gas conduit 1126 for transporting any suitable atmospheric fluid (e.g., atmospheric gas) into reservoir 1120 via any suitable gas inlet port 1117. System 1100 may include any suitable float 1115 (e.g., a gas control float) that may be configured to block and control the flow of atmospheric gas through gas conduit 1126 to reservoir 1120. Float 1115 may be configured to slide vertically in any suitable tube 1128 (e.g., a capillary tube) so that any drawn liquid 1129 that may be drawn into or otherwise received by tube 1128 (e.g., via bottom end 1128b of tube 1128) may raise float 1115 to block an opening 1122 between capillary tube 1128 and gas conduit 1126. If a bottom open end 1128b of tube 1128 is positioned within target (e.g., soil) 1199 and the target is wet, water or any other suitable liquid 1129 may rise up inside tube 1128 (e.g., due to capillary effect) and may lift float 1115 to enter or otherwise block opening 1122, which may prevent air or any other suitable gas from entering into gas conduit 1126 (e.g., via a top open end 1128t of tube 1128). Therefore, a capillary effect of tube 1128 may adjust the amount of gas pressure provided to reservoir 1120 by conduit 1126. Therefore, liquid 1129 may be drawn into or otherwise received by gas conduit 1126 via valve 1128 and opening 1122 and may block the passage of atmospheric gas via opening 1122 and conduit 1126 into reservoir 1120. The amount of fluid (e.g., liquid) that may be released from container 1110 (e.g., from reservoir 1120) via liquid outlet 1150 may be proportional to the amount of fluid (e.g., atmospheric gas) that may be delivered to container 1110 (e.g., into reservoir 1120) via conduit 1126. System 1100 may also include a liquid control valve (e.g., a valve that may be the same as or similar to fluid control valve 860 of system 800) for controlling the passage of the fluid into reservoir 1120, such as via a liquid inlet port (e.g., a port that may be the same as or similar to port 806 of system 800) for accepting any suitable fluid from any suitable fluid supply into reservoir 1120.

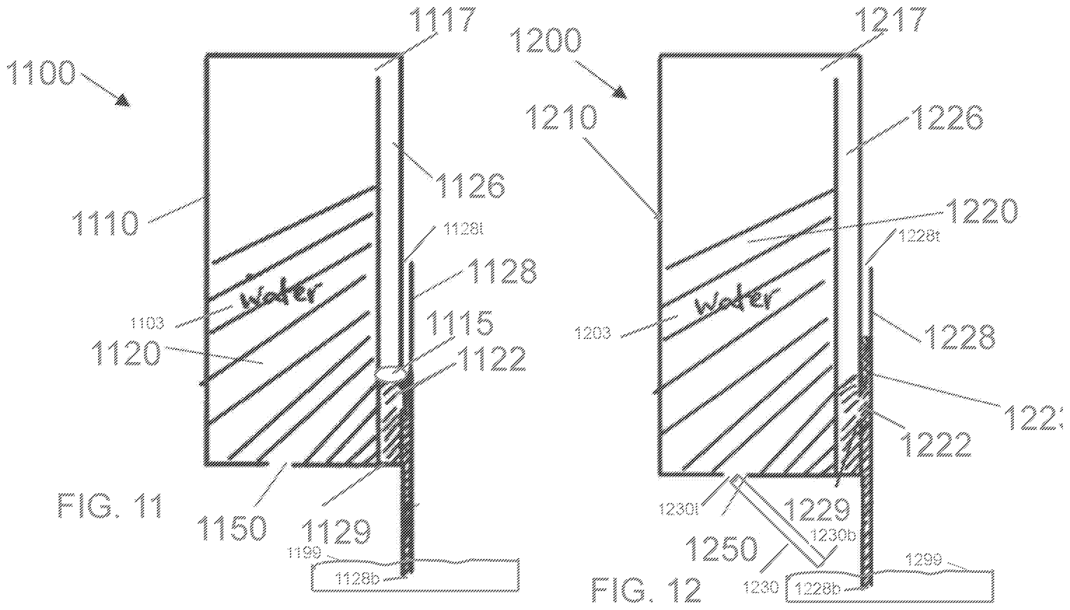

### FIG. 12

As shown in FIG. 12, in some embodiments of the disclosure, there may be provided a system 1200 (e.g., a water irrigation system or any suitable moisture sensitive valve system) that may supply any suitable liquid, water, or other suitable irrigation solution (e.g., water, as shown) to soil or ground or any other suitable growing medium or target 1299. System 1200 may be similar to any suitable system of the disclosure and may include a container 1210 that may include a reservoir 1220 and a liquid outlet 1250 for discharging any suitable liquid 1203 (e.g., water) from reservoir 1220 to the target. System 1200 may include a gas conduit 1226 for transporting any suitable atmospheric fluid (e.g., atmospheric gas) into reservoir 1220 via any suitable gas inlet port 1217. System 1200 may include any suitable blocking valve 1223 that may be configured to control the flow of atmospheric gas through gas conduit 1226 (e.g., through a gas inlet opening 1217 in gas conduit 1226), such that the gas may then travel through gas conduit 1226 and into reservoir 1220 via port 1217 of gas conduit 1226. Blocking valve 1223 may be any suitable absorber mechanism or material that may be configured to expand with a humidity increase (e.g., similar to absorber mechanism 106, 206, etc.) or transition based on any other suitable characteristic. Drawn liquid 1229 may be drawn into or otherwise received by gas conduit 1226 and may block the passage of atmospheric gas via conduit 1226 into reservoir 1220. Blocking valve 1223 may be configured to block and/or otherwise restrict atmospheric gas passage through a capillary tube 1228 once drawn liquid 1229 expands blocking valve 1223. If a bottom open end 1228b of tube 1228 is positioned within target (e.g., soil) 1299 and the target is wet, water or any other suitable liquid 1229 may rise up inside tube 1228 (e.g., due to capillary effect) and may expand blocking valve 1223 to enter or otherwise block an opening 1222, which may prevent air or any other suitable gas (e.g., ambient air) from entering into gas conduit 1226 (e.g., via a top open end 1228t of tube 1228 and opening 1222, which may fluidly couple conduit 1226 and tube 1228). Therefore, a capillary effect of tube 1228 and transitioning of valve 1223 may adjust the amount of gas pressure provided to reservoir 1220 by conduit 1226. Therefore, liquid 1229 may be drawn into or otherwise received by gas conduit 1226 via valve 1228 and opening 1222 and expand valve 1223 to block the passage of atmospheric gas via opening 1222 and conduit 1226 into reservoir 1220. The amount of fluid (e.g., liquid) that may be released from container 1210 (e.g., from reservoir 1220) via liquid outlet 1250 may be proportional to the amount of fluid (e.g., atmospheric gas) that may be delivered to container 1210 (e.g., into reservoir 1220) via conduit 1226. System 1200 may also include a liquid control valve (e.g., a valve that may be the same as or similar to fluid control valve 860 of system 800) for controlling the passage of the fluid into reservoir 1220, such as via a liquid inlet port (e.g., a port that may be the same as or similar to port 806 of system 800) for accepting any suitable fluid from any suitable fluid supply into reservoir 1220.

### Additional Concepts

In some embodiments, any suitable system of the disclosure may include a gas conduit that may be disposed within or otherwise provided by or coupled to a container of the system (e.g., conduit 113 defined by a portion of container 102 of system 100 rather than coupled to or otherwise extending along an external surface of container 102). The gas conduit may be used for transporting atmospheric gas to or via the wick or other suitable absorber mechanism (e.g., mechanism 106 of system 100, mechanism 206 of system 200, etc.), where the conduit and/or any other suitable portion(s) of the system may be adjusted to vary how much (e.g., the rate at which) air may be passed through the conduit from the system's ambient environment into an accumulation space of the system via the absorber mechanism.

In some embodiments, any suitable system of the disclosure may include an additional material that may be positioned parallel or otherwise adjacent to a wick or other suitable absorber mechanism (e.g., mechanism 106 of system 100, mechanism 206 of system 200, etc.) for covering and/or protecting at last a portion of the absorber mechanism, where the additional material may be used for reducing or increasing connection between the wick and the environment (see, e.g., component 1408 of system 1400, component 1509 of system 1500, and/or the like).

In some embodiments, any suitable system of the disclosure may include a movable member that may be positioned parallel or otherwise adjacent to a wick or other suitable absorber mechanism (e.g., mechanism 106 of system 100, mechanism 206 of system 200, etc.), where the movable member may be used for reducing or increasing an area or other dimension of contact between the wick and the environment (see, e.g., component 1408 of system 1400, which may be designed to be fixed or may be designed to include one or more holes that may grow bigger or smaller to enable a greater or smaller portion of the absorber mechanism to be exposed to ambient fluid (e.g., water from soil), component 1509 of system 1500, and/or the like).

In some embodiments, any suitable system of the disclosure may include a liquid exit or fluid outlet port that may be configured to be adjustable by area and/or position for adjusting the functionality of the system. For example, a fluid outlet port (e.g., port 107, 207, 307, 850, 950, 1050, 1150, 1250, etc.) may be configured to resize or move towards or away from an absorber mechanism or wick or other suitable absorbent material (e.g., mechanism 106 of system 100, mechanism 206 of system 200, etc.). For example, system 1200 may include any suitable distance adjustment tube 1230 with a fluid passing passageway extending between a bottom open end 1230b and top open end 1230t that may be fluidly coupled to fluid outlet port 1250. The length of tube 1230 between ends 1230b and 1230t may be adjusted and/or the location of bottom open end 1230b may otherwise be adjusted (e.g., tube 1230 may be flexible) to vary the distance between bottom open end 1230b and bottom open end 1228b of tube 1228 and/or absorber mechanism 1223 (e.g., a longer distance may increase the time it may take for liquid released from fluid outlet port 1250 to reach absorber mechanism 1223, while a shorter distance may decrease the time it may take for liquid released from fluid outlet port 1250 to reach absorber mechanism 1223).

Using an absorber (e.g., mechanism 106 of system 100, mechanism 206 of system 200, etc.) for variably closing a gas conduit may be one of many different approaches that can be used to close an air channel of a system's gas conduit. Other approaches may include, but are not limited to, using a thin tube that may be coupled beside the air channel (e.g., due to capillary effect when the soil or growing medium is wet, the tube may be configured to take the water or other liquid up from the medium (e.g., like a plant's root) and the liquid may be used to close the air passage (e.g., as described with respect to system 1000)), using a floating object inside the air channel (e.g., as described with respect to system 1100 (e.g., using a float valve to control air pass)), using any suitable material(s) that may be configured to change their volume and/or to absorb liquid and/or change weight to block air passage within the air channel (e.g., as described with respect to system 1200), and/or the like.

While, in some embodiments, any suitable system of the disclosure may be configured to at least partially or fully close a fluid channel (e.g., conduit 113, conduit 213, conduit, 1226, etc.) using humidity, in other embodiments, any suitable system of the disclosure may be configured to close a fluid channel using temperature and/or any suitable changes in the chemical specification of the environment. As an example, a valve (e.g., valve 1028, valve 1223, etc.) can be made by any suitable shape-memory alloy (“SMA”) material, such that the valve may be configured to at least partially or fully close a fluid channel when the environment's temperature becomes cold (e.g., falls below a particular low threshold temperature) and/or becomes hot (e.g., rises above a particular high threshold temperature). In chemistry, there are specific materials that may react with other specific materials and may result in a produced high-pressure gas if the reaction occurs in a small container, whereby the volume change may be used to block a fluid channel for fluid flow control via chemical changes in the environment. The materials may be used to provide a valve that may be configured to close or open a fluid channel for adjusting its ability to pass fluid therethrough due to any suitable changes in humidity, moisture level, temperature, and/or any suitable chemical changes in the environment. For example, a system may be configured to close a liquid outlet valve when an environment is determined to be wet (e.g., to have at least a certain humidity) but vice versa is also possible. (e.g., to close a valve when an environment is determined to be dry (e.g., to have less than a certain humidity).

Overwatering can kill the plants. Therefore, any suitable system of the disclosure may be configured to deliver liquid to a growing medium target (e.g., water on or under soil) in a controlled manner. When water may be delivered under the soil, air may also be delivered down to the root (e.g., by a small channel) to control the air pressure at water output, where such air may reduce the chance of killing the plant. For example, a system may be provided with a small tube that may be configured to take air from the ambient environment and take it down to a root of the target, which may cause the root to receive air and cause air to reach a water exit that may be useful for system functionality (e.g., a liquid outlet may be positioned above a target (e.g., above a soil level) and such a tube may be used to provide air to a root within the target (e.g., below the soil level).

Any suitable system of the disclosure may be configured to include multiple liquid containers and/or multiple liquid reservoirs or accumulation spaces in a single container, which may force a floating object to go higher than a point that is close to an input flow with one secondary container reservoir above the main container reservoir. For example, multiple floats may be provided in a single reservoir or in multiple distinct reservoirs. The system may be configured such that liquid may first fill a secondary container reservoir and then go into a main container reservoir, such that, when the input liquid flow is closed, there may still remain water in the container that may go into the main container reservoir and force the floating object to go higher (e.g., a first reservoir or accumulation space or chamber may be used for liquid to initially reside and then flow into a second reservoir or accumulation space or chamber that may cause air-tightness, while alternatively this may be replaced by a one-way valve with a spring (see, e.g., system 1400)), and/or such that, before letting the liquid exit to the soil, there may be another small container to slow down the speed of the flow and/or to make a resistance for the roots that may try to go inside the system after a time (e.g., a container and/or conduit, absorbent material, etc.).

In a large agricultural field irrigated by drip irrigation, there can be notable differences between plants that are near a water source (e.g., closer to drip emitters) and those that are far away. These differences may be due to variations in water distribution and/or availability.

Any suitable system of the disclosure may be configured to include a special gas container that may be configured to let an internal gas exit only after humidity is removed from inside the fabric(s) or other suitable absorber mechanism(s) that may be positioned at least partially within a gas conduit. Using this approach, a fabric and/or any other suitable absorber mechanism(s) may also be provided at an output channel (e.g., as a valve to control the disbursement of gas instead of liquid from an outlet port of an accumulation space of the system).

Any suitable system of the disclosure may be configured to include an outlet area adjustment mechanism such that a potential area of an outlet for disbursing fluid may be variable (e.g., by using a screw for changing an outlet's potential opening area and/or adjusting the number of used outlet ports) and such that system sensibility may be changed. Additionally or alternatively, any suitable system of the disclosure may be configured to include a length adjustable liquid output such that a distance between a liquid output of the system and an air input of the system may be variable (e.g., tube 1220) and such that system sensibility may be changed. Therefore, if such a distance is small, an air input may get wet and close after a limited amount of time, and, if such a distance is large, it may take time for the liquid to go through the soil and then make the fabric or other suitable element(s) wet and close the air input in order to close water flow. Therefore, a moisture sensitive valve system is provided that may include a container or housing. The housing may include a reservoir and a liquid outlet for discharging a liquid from the reservoir to a target (e.g., any suitable growing medium (e.g., soil)). The system may include a gas conduit for transporting atmospheric gas to the reservoir and a gas control valve for controlling the flow of atmospheric gas through the gas conduit to the reservoir. The system may include a liquid inlet for accepting the liquid from a liquid supply and a liquid control valve for controlling the passage of the liquid through the liquid inlet to the reservoir. An amount of liquid that may be released from the container may be proportional to an amount of atmospheric gas delivered to the reservoir through the gas conduit.

In some other embodiments, an irrigation system (e.g., a water irrigation system) may be configured to supply water, any other suitable liquid, or any other suitable irrigation solution to soil, any other suitable growing medium, or any other suitable target. The system may be a moisture sensitive valve system that may be configured to be used for automated irrigation purposes (e.g., for supplying liquid to soil). The system may include any suitable housing or vessel for water containment, a water egress port, an air channel, and a device to control the channel. The device may include any suitable mechanical element(s) that may close and/or open the air channel based on a detected presence of water in parallel or independent from an electronic air valve control system. The device may include an electronic sensor that may be configured to control the airflow and, indirectly, to control the liquid output flow. The housing may include a reservoir and a liquid outlet for discharging a liquid from the reservoir to the soil. The system may include a gas conduit for transporting atmospheric gas to the reservoir and a gas control valve for controlling the flow of atmospheric gas through the gas conduit to the reservoir. The system may include a liquid inlet for accepting the liquid from a liquid supply and a liquid control valve for controlling the passage of the liquid from the liquid inlet to the reservoir. The liquid may be released from the housing proportional to an amount of atmospheric gas delivered to the housing through the gas conduit, which may be controlled by any suitable electronic approaches and/or by any suitable mechanical approaches, such as moisture absorbers.

In some other embodiments, a water irrigation system may be configured to supply water, any other suitable liquid, or any other suitable irrigation solution to soil, any other suitable growing medium, or any other suitable target. The system may include a container for holding any suitable fluid. The container may include a liquid outlet for discharging the fluid to the ground or any other suitable target or growing medium. The system may also include a gas conduit that may be configured to transport any suitable gas to the container (e.g., air entering the gas conduit from an air inlet port). The system may include any suitable absorbent material that may be configured to act as a mechanical sensor and actuator, which may be at least partially positioned in the gas conduit and partially in contact with the target (e.g., soil, ground, growing medium, etc.). Additionally or alternatively, the gas conduit can be controlled via an electronic actuator. Any suitable type of electronic actuator may be used that can be configured to open or at least partially or fully close one or multiple small pipes, including, but not limited to, electric motors, linear actuators, piezo actuators, vibrator actuators, magnetic actuators, SMA actuators, and/or the like. Liquid concentration in an absorbent material may be configured to regulate the flow of gas transported to the container and/or the airflow can be controlled, and the fluid (e.g., water or other suitable liquid and/or the like) may be discharged from the container in proportion to the volume of gas transported to the container. The system may include a liquid inlet that may be configured to accept fluid from any suitable fluid supply into a reservoir that may be located within or otherwise provided by the container. The system may include any suitable fluid control mechanism that may be configured to manage the liquid inlet. Beside the electronic actuator, the absorbent material, which may be any suitable fabric wick, may be configured to control the flow of air or other suitable gas that may be delivered to the container (e.g., any suitable fluid vessel or reservoir), and fluid may be released from the container in an amount proportional to the amount of gas delivered to the container through the gas conduit. The absorbent material (e.g., a wick thereof) may be provided with any suitable additional component(s) and/or layer(s) (e.g., may be coupled to other types of materials, such as plastic, cork, cotton, and/or the like) that may be configured to reduce or increase the time that it may take the wick to return to its original state (e.g., a state when it is dry (e.g., versus a wet transitioned state), a state when it may be configured to let air (e.g., the most air) pass therethrough, etc.). Such an added layer (e.g., on top of and/or along the wick) may be adjustable in any suitable way(s) (e.g., adjusted (e.g., by a user) to enable a smaller or larger area of connection between the absorber mechanism and the ambient environment (e.g., target (e.g., soil)) to reduce or increase the surface of the wick that is in contact with the environment (e.g., soil, atmosphere, air, etc.), where such an adjustment may be configured to change the duration of time for transitioning the wick back to its original state. In some embodiments, the system may include a separate air channel that may be configured to expose the wick to air, where such a channel may be adjusted (e.g., in length, thickness, filtering, etc.) to reduce or increase the duration of time for returning the wick back to its original state (e.g., an area of connection between an air channel and ambient air may be adjustable (see, e.g., component 1509 of system 1500)). Additionally or alternatively, the size and/or location of a system's liquid outlet can be adjusted in order to reduce or increase the time that may be needed to take a wick from its original state into a transitioned (e.g., wet) state and/or vice versa. Additionally or alternatively, a system may include one or more electronic sensors (e.g., an air flow sensor and/or a pressure sensor) that may be configured to monitor electronically the humidity and/or any other suitable specification(s) of a target and/or of any other suitable element of the ambient environment of the system. In some embodiments, an electronic circuit of a system may provide a timer or otherwise that may be configured to release some air into an accumulation space of the system (e.g., through electronic control of a small air channel of the system), which may cause some liquid to be disbursed from the accumulation space (e.g., by controlling the flow of air through a small air channel of the system rather than controlling a liquid valve at a liquid outlet of the system, liquid disbursement may be controlled with lower power consumption). In some embodiments, any suitable electronic sensor(s) may be included in a system of the disclosure that may be configured to detect any suitable characteristic(s) of a target (e.g., soil humidity, sunlight, air humidity, water flow rate, pressure line magnitude, and/or the like, which may be used to control any suitable timer(s) for adjusting the functionality of the system in any suitable way(s).

In some embodiments, a system may include one or more mechanical actuators/sensors (e.g., a wick) but no electronic actuator(s)/sensor(s). In some other embodiments, a system may include one or more electronic actuators/sensors but no mechanical actuator(s)/sensor(s) (e.g., a wick). In yet some other embodiments, a system may include one or more mechanical actuators/sensors (e.g., a wick) and one or more electronic actuator(s)/sensor(s) that may be used together. Such actuators may be configured to control the air flow to a container and such (e.g., optional) electronic sensors may be configured to sense indirectly the air pressure inside the container (e.g., to monitor existence and amount of liquid inside the container, to sense flow of air through a system air channel to indirectly sense target moisture, and/or the like).

Any suitable irrigation system of the disclosure may be configured to optimize water consumption. By deploying a large number of systems with cost-and power-effective electro-mechanical valves across a vast (e.g., 1,000,000 square meter) farm, water can be distributed precisely where and when it may be needed. This precision, coupled with reduced need for accurate electronic sensor dependency, may significantly reduce water consumption.

In some other embodiments, a water irrigation system may be configured to supply water, any other suitable liquid, or any other suitable irrigation solution to soil, any other suitable growing medium, or any other suitable target. The system may include a container with an accumulation space for holding any suitable fluid. The container may include a liquid outlet for discharging the fluid to the ground or any other suitable target or growing medium. The system may also include a gas conduit that may be configured to transport any suitable gas to the container (e.g., air entering the gas conduit from an air inlet port). The system may include any suitable absorbent material. The material may include a first portion that may be positioned in a portion of the gas conduit between an ambient air opening and an accumulation space opening). The material may include a second portion that may be positioned in contact with the target (e.g., soil or other growing medium) or any other suitable space of the ambient environment. Liquid concentration in the absorbent material may be configured to regulate the flow of gas transported through the gas conduit (e.g., between the ambient air opening and the accumulation space opening) and into an accumulation space of the container. Additionally or alternatively, this air flow can be controlled (e.g., in parallel) using any suitable electronic actuator. For example, an electronic control unit may be configured to control the flow of air through an air channel (e.g., a unit that may release air from the ambient environment into an accumulation space of the system via a channel (e.g., channel 1421 of system 1400) and/or that may selectively couple two distinct channels of a gas conduit (e.g., channels 1423 and 1424 of system 1400). Fluid may be discharged from a liquid outlet port of the container in proportion to the volume of gas delivered to the container. For example, an electronic low consumption actuator may be used to control the amount of gas delivered to the liquid container. Additionally or alternatively, the liquid concentration in the absorbent material may be used to control the flow of air delivered to the container. The fluid may be released from the container proportional to the amount of air delivered to the container through the gas conduit. The system may include a liquid inlet for accepting the fluid into the container from any suitable fluid supply. The system may include an inlet reservoir within the container, where the inlet reservoir may be configured to receive the fluid from the liquid inlet. The system may include one or more fluid control valves for controlling the passage of fluid via the liquid inlet into the inlet reservoir of the container (e.g., mechanically and/or using one or more electronic filling valves). A fluid control valve may be a reservoir lip for limiting spill over between the inlet reservoir and the container.

In some other embodiments, a water irrigation system may be configured to supply water, any other suitable liquid, or any other suitable irrigation solution to soil, any other suitable growing medium, or any other suitable target. The system may include a container for holding any suitable fluid. The container may include a liquid outlet for discharging the fluid to the ground or any other suitable target or growing medium. The system may also include a gas conduit that may be configured to transport any suitable gas to the container (e.g., air entering the gas conduit from an air inlet port). The system may include any suitable absorbent material. The material may include a first portion that may be positioned in a portion of the gas conduit between an ambient fluid channel and an absorber fluid channel). The material may include a second portion that may be positioned in contact with the target (e.g., soil or other growing medium). Liquid concentration in the absorbent material may be configured to regulate the flow of gas transported through the gas conduit (e.g., through the inlet channel and passage channel) and into the container, so as to control the liquid exit flow and/or to sense existence of the liquid in the environment (e.g., air flow rate in an gas conduit based on an absorber mechanism may be an indicator of target humidity). Fluid may be discharged from an outlet port of the container in proportion to the volume of gas delivered to the container. The amount of delivered air can be controlled in parallel or indirectly by any suitable electronic actuator.

A system of the disclosure may be provided with an air channel with a minimal size that may enable air flow control therein with minimal electronic power consumption. For example, rather than directly controlling liquid flow through a large liquid outlet valve using an electronic liquid control valve, a system may control the liquid flow indirectly by directly controlling air flow through a small air channel pipe. This can save a lot of energy because the job may be done by controlling air flow via an air flow channel (e.g., a channel with a smaller diameter (e.g., a 1 millimeter diameter) rather than by controlling liquid flow via a liquid flow outlet port (e.g., a channel with a larger diameter (e.g., a 4 millimeter diameter)). A system may include a liquid inlet for accepting fluid from any suitable fluid supply line into a system container. The fluid supply line may be permanently coupled to the system as the system may include a water inlet control valve. The system may include an inlet reservoir with at least a portion thereof within the container. Such an inlet reservoir may be configured to receive the fluid from the liquid inlet. The system may include a fluid control valve for controlling the passage of fluid from the liquid inlet to the reservoir container. The fluid control valve may be configured to be activated by buoyancy of the reservoir for controlling the passage of fluid between the inlet reservoir and the container. An amount of gas delivered to the container may be defined using any suitable electronic actuator (e.g., a low power electronic actuator). Optionally, liquid concentration in an absorbent material may be configured to control the flow of air delivered to the container, wherein fluid may be released from an outlet port of the container in a manner proportional to the manner in which air may be delivered into the container (e.g., through a gas conduit). The absorbent material may be a fabric wick.

A system of this disclosure may be configured to control the exit rate of the flow from a liquid container indirectly by controlling the air pressure that may be exerted on top of the liquid. Therefore, if there is no air entering the container, the system may be configured not to release water from the container.

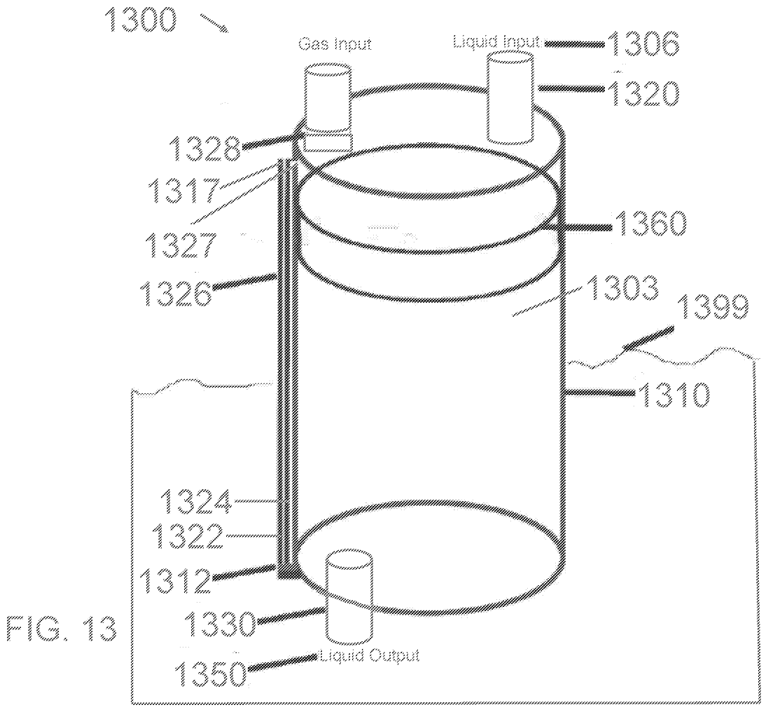

### FIG. 13

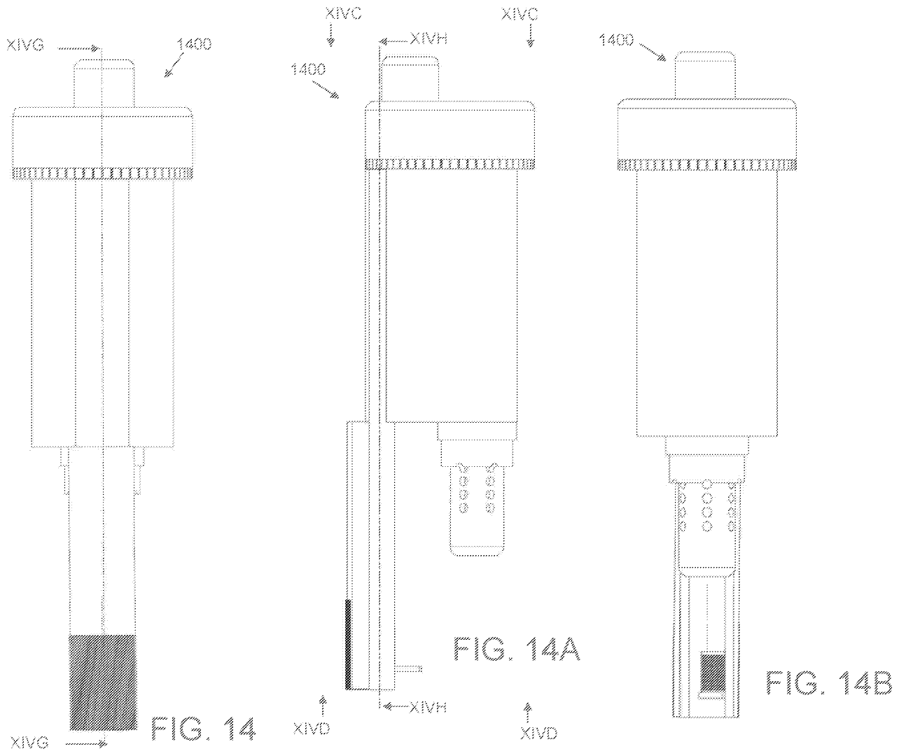

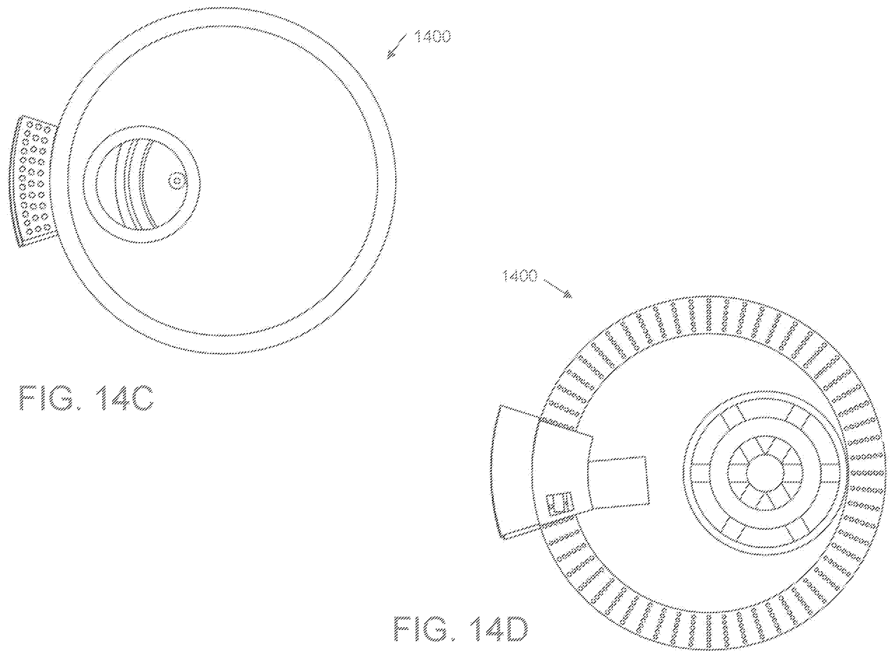

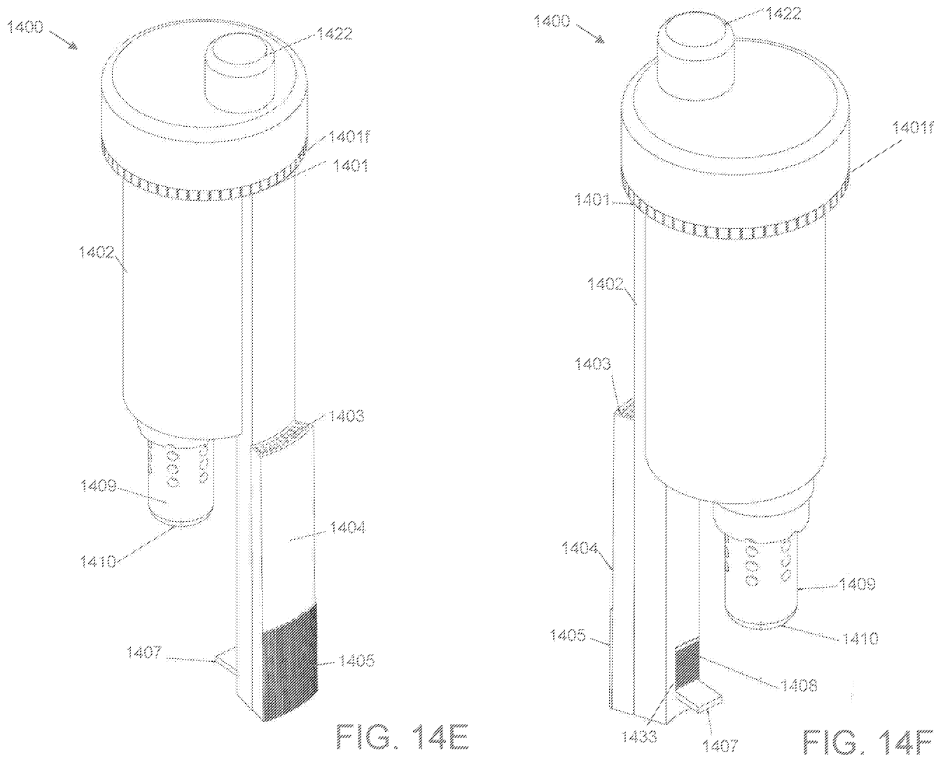

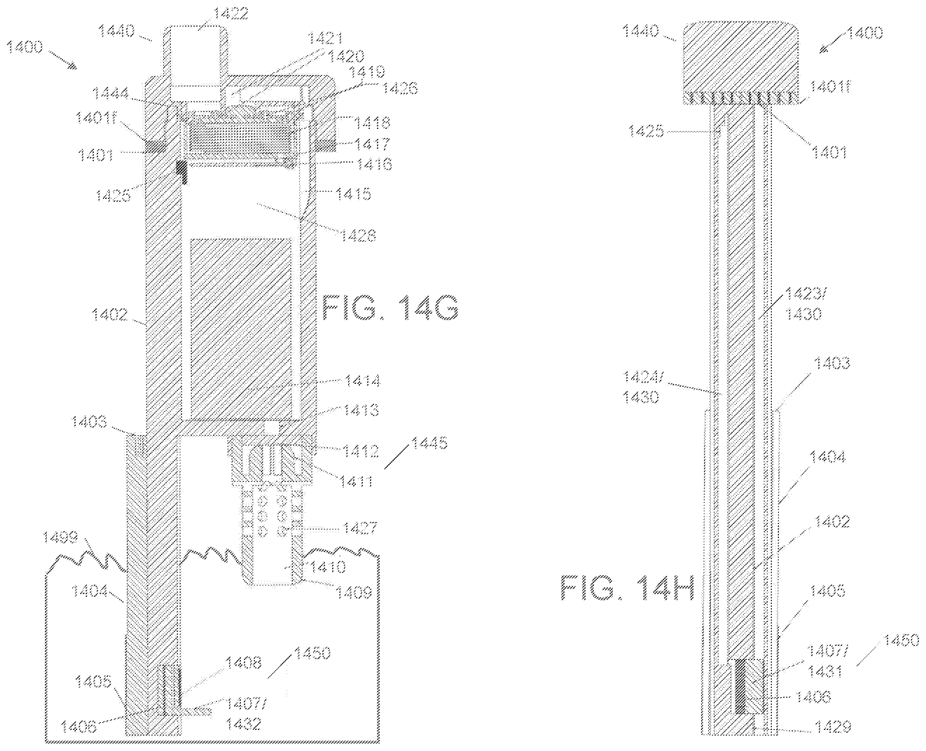

As shown in FIG. 13, in some embodiments of the disclosure, there may be provided a system 1300 (e.g., a water irrigation system) that may supply any suitable liquid, water, or other suitable irrigation solution to soil or ground or any other suitable growing medium or target 1399. System 1300 may include a container 1310 that may be used to hold any suitable fluid. Container 1310 may include a liquid outlet 1350 that may be configured to discharge the fluid to target 1399. A system may be positioned with respect to any suitable target in any suitable functional manner. For example, a system may be positioned with respect to a target such that one or more characteristics of the target may be able to reach or otherwise be detected by a system's absorber mechanism (e.g., absorber mechanism 1312 ought to be close to and above if not touching or within target 1399 (e.g., to detect the humidity of a soil target, etc.)) and such that ambient air may be able to reach and pass into an air inlet port of a system's gas conduit (e.g., an air inlet port 1317 of gas conduit 1326 ought to be positioned so as to be exposed to any suitable ambient air (e.g., even if port 1317 is positioned slightly below a top level of a soil target, air may be able to pass through that target and into port 1317)). A liquid outlet port of a system (e.g., liquid outlet port 1350) may be positioned above or on or within target 1399 (e.g., if liquid outlet port 1350 is inserted below a target soil surface, this may cause saving in water that is used for irrigation because it will not let any water be evaporated by sunlight exposure above the target soil surface, but outlet port 1350 may be above the target soil surface and still irrigate the target). System 1300 may include a gas conduit 1326 that may be configured to transport any suitable gas to container 1310. The gas may be air or any other suitable gas that may enter conduit 1326 via an air inlet port 1317 of conduit 1326. Gas conduit 1326 may include an ambient fluid channel 1322 extending between air inlet port 1317 and absorber mechanism 1312 and an absorber fluid channel 1324 extending between absorber mechanism 1312 and an accumulation opening 1327. Ambient air may enter channel 1322 of conduit 1326 via inlet port 1317 and may travel through conduit 1326 via absorber mechanism 1312 and into an accumulation space 1303 of container 1310 via opening 1327 of channel 1324 of conduit 1326. System 1300 may include any suitable absorber mechanism 1312 (e.g., any suitable absorbent material), which may include a first material portion that may be positioned in any suitable portion of gas conduit 1326 (e.g., between channels 1322 and 1324 (e.g., between air inlet port 1317 and accumulation opening 1327 of conduit 1326)) and a second material portion that may be positioned in contact with or functionally close to target 1399. A liquid concentration in absorbent material 1312 may be configured to regulate the flow of gas transported through conduit 1326 (e.g., through inlet port 1317 to accumulation opening 1327 via material 1312) and into accumulation space 1303 of container 1310. Fluid may be discharged from outlet port 1350 of accumulation space 1303 of container 1310. This fluid discharge from container 1310 may be in proportion to the volume of gas delivered to container 1310 via conduit 1326. Any suitable electronic actuator and/or sensing device 1328 may be provided along with (e.g., in parallel to) absorbent material 1312 and may be configured to regulate the air and/or measure the air pressure inside accumulation space 1303 of container 1310. System 1300 may include a liquid inlet 1306 (e.g., an airtight inlet) that may be configured to accept fluid from any suitable fluid supply (not shown). System 1300 may include an inlet reservoir 1320 within container 1310. Inlet reservoir 1320 may be configured to receive fluid from the fluid supply via liquid inlet 1306 and pass it to accumulation space 1303. System 1300 may include one or more fluid control valves 1360 that may be configured to control the passage of fluid from inlet 1306 to reservoir 1320. Valve 1360 may include a reservoir lip for limiting spillover between inlet reservoir 1320 and another portion of container 1310 (e.g., as a float (see, e.g., FIG. 14)). Liquid concentration in absorbent material 1312 may be configured to control the flow of air delivered to accumulation space 1303 of container 1310 via conduit 1326, wherein the fluid may be released from accumulation space 1303 of container 1310 proportional to the amount of air delivered to accumulation space 1303 of container 1310 through conduit 1326. System 1300 may include an exit reservoir 1330 that may be used to set the point where liquid level can open liquid outlet 1350 (see, e.g., component 321 of system 300). Material 1312 may include a fabric wick. One or more layers of different material(s) (e.g., plastic, etc.) may be added to the wick (e.g., as may be described with respect to system 1400). Such a wick may be wool or cotton but changing this is possible to several different material(s), and changing the material may change how much time it takes for it to transition between states (e.g., between any suitable dry state and any suitable wet state) and thus change the timing performance of the system. Different layer(s) may be added to a wick of an absorber mechanism using any suitable methodologies (e.g., pressure coupling, embedding the layers into design (e.g., make a protection layer in a plastic design then place a ceramic layer and a wool layer on top of each other, then connect the protection plastic by plastic weld to the structure and the ceramic and wool layers may remain in between). Such layer(s) may only be provided along certain area(s) of the wick in order to reduce or increase the duration of time needed to return the wick from a transitioned (e.g., wet) state to an original state. Such areas may be adjusted by any suitable adjustment member(s) and/or methodologies for allowing the user to adjust the time between irrigations.

In some embodiments, a portion of the gas may be redirected to material 1312 using an adjustable gas conduit 1326 (e.g., an adjustable air channel), which may reduce or increase the needed time for returning material 1312 to its original state. Such adjustment may be enabled via any suitable mechanical mechanism(s) (e.g., screw(s)) and/or via any suitable electro-mechanical mechanism(s) (e.g., motor(s) (e.g., direct current (“DC”) motor(s) and/or vibrator motor(s)). For example, to reduce or increase the amount of air that can reach the absorber material, a slider (e.g., slider 1509 of system 1500) may be positioned at an entrance and movement of the slider may change of the area of the entrance so by moving it we change the area of entrance.

Liquid concentration in material 1312 may regulate the flow of gas transported through gas conduit 1326 and into accumulation space 1303 of container 1310. Fluid discharged from accumulation space 1303 via outlet port 1350 may be in proportion to the volume of gas delivered to accumulation space 1303 of container 1310. System 1300 may include liquid inlet 1306 for accepting fluid from any suitable fluid supply line (not shown). Such a fluid supply line may be permanently attached to inlet 1306 (e.g., when system 1300 may include an inlet control valve (e.g., valve 1360)). System 1300 may include inlet reservoir 1320 that may be disposed within container 1310. Inlet reservoir 1320 may be configured to receive fluid from liquid inlet 1306.

Material 1312 (e.g., a liquid absorber unit) may be replaced with any suitable small tube(s) that may be configured to use capillary effect and take advantage of an increasing height of liquid in tubes to block the air channels in order to control the liquid exit flow and/or to sense the existence of liquid presence by measuring air flow or air pressure (see, e.g., system 1000).

In some embodiments, gas conduit 1326 may be disposed at least partially within container 1310. Conduit 1310 may be configured to transport atmospheric gas to a wick of material 1312. Conduit 1326 may be adjusted in any suitable way(s) (e.g., adjusting the area of its inlet(s) and/or exposure to material 1312.

At least one material may be provided adjacent (e.g., parallel) to absorbent material 1312 for reducing or increasing connection between the wick of material 1312 and the environment (see, e.g., system 1400).

In some embodiments, system 1300 may include a movable member adjacent to the wick of material 1312 for reducing or increasing area of the wick that may be in contact with the system's environment.

In some embodiments, system 1300 may include an adjustable liquid exit that may resize or move the water exit (e.g., outlet 1350) near or far from material 1312 (see, e.g., tube 1230 of system 1200).

Using absorbers for closing an air channel may be only one of the approaches that can be used to close the air channel. Other approaches may include, but are not limited to, a thin tube that may be coupled beside the air channel, where, due to capillary effect when the soil is wet, this tube may be configured to take the water up (e.g., like a plant's root) and the water may close the air passage. Additionally or alternatively, a floating object may be used inside this channel, or special materials that change their volume or materials that absorb water and get heavy and use their small weight to block the air passage may be used.

In some embodiments, a system may be configured to close or adjust the size of an air channel based on humidity and/or temperature and/or any other suitable changes in the chemical specification of the environment. As an example, a valve can be made by SMA material and, when the environment is cold or hot, the air channels may be closed. In chemistry, there are specific materials that may be configured to react with other specific materials and the result may be a produced high-pressure gas if this reaction occurs in a small container. The volume change may block the air channel for liquid flow control via chemical changes in the environment. The valve may close or open the output by changes in humidity, temperature, or chemical changes in the environment. The system preferably closes the liquid outlet valve when the environment is wet, but vice versa is also possible.

As overwatering can kill the plants, a system may be configured to deliver the water on the soil or under the soil. When water is delivered under the soil, air may also be taken down to the root by a small channel to make sure the air pressure at water output, this air will reduce the chance of killing the plant. Some systems may include a separate channel that may be configured to deliver air to a target (e.g., to roots in soil to accelerate its growth).

A system may include multiple water containers to force a floating object to go higher than a point that is close to the input flow with one secondary container above the main container reservoir. Water may first fill this container and then go into the main container, such that, when the input water flow is closed, still there may be remaining water in the container that may go into the main container and force the floating object to go higher (see, e.g., system 300, system 800, and/or the like). A system may be configured to prevent air in, so a separate container above or below may have remaining water that may stop air from entering the container. Before letting the water exit to the soil, there may be another small container to slow down the speed of the flow or to make a resistance for the roots that might try to go inside the device after a time. This may be a container or a piece of special material such as cork or cotton (e.g., limiter 840 may be such a material and buffer reservoir 830 may be a second container, where outlet 850 may be closed using any suitable absorber mechanism (e.g., a fabric)).

In a large agricultural field irrigated by drip irrigation, there can be notable differences between plants that are near the water source (e.g., closer to the drip emitters) and those that are far away. These differences may be due to variations in water distribution and availability.

The system may be used as a special gas container that may be configured to let internal gas exit only after humidity is removed from inside the fabric(s) in the air channel. Using this approach, a fabric may also be provided at the output channel. An absorber mechanism may be provided at outlet 1350 to control gas flow (e.g., to prevent gas from traveling in a particular direction (e.g., out of space 1303) via outlet 1350).

A system may include a length adjustable water output, such that the distance between water output and air input (e.g., between liquid output 1350 and material 1312 (see, e.g., tube 1230 of system 1200)) may be variable for changing this distance such that the system sensibility may be changed (e.g., if the distance is small, after a very short time of water output the air input conduit material may get wet and close the gas conduit quickly and this close the system's water output flow quickly, and if the distance is larger, it may take more time for the water output from the system to go through the soil and then make the air input conduit material wet and close the gas conduit to close the system's water output flow).

### FIGS. 14-14H

As shown in FIGS. 14-14H, in some embodiments of the disclosure, there may be provided a system 1400, which may be similar to or the same as system 100 and/or system 200 in various ways. As shown, system 1400 may include a liquid (e.g., water) container 1402. Any suitable seal or head assembly 1440 may be provided and coupled to (e.g., removably coupled to a top of) container 1402 for defining an accumulation space 1428 that may be configured to hold any suitable fluid(s) (e.g., water, air, etc.). Head assembly 1440 may be provided for closing or opening a liquid inlet or source opening 1444 (e.g., at a top of container 1402) with respect to a liquid inlet of the system for enabling liquid to be supplied into accumulation space 1428 from any suitable liquid source that may be provided via head assembly 1440 (e.g., via a liquid inlet 1422 of head assembly 1440). System 1400 (e.g., container 1402 and/or head assembly 1440) may define any suitable ambient opening 1401 that may be exposed to any suitable environment of system 1400 (e.g., of container 1402 and head assembly 1440) for enabling any suitable ambient fluid of the ambient environment (e.g., air) of system 1400 to enter into system 1400 via opening 1401. System 1400 (e.g., container 1402 and/or head assembly 1440) may define any suitable ambient fluid channel 1423 of a fluid (e.g., gas) conduit 1430, where ambient fluid channel 1423 may extend between ambient opening 1401 and any suitable absorber assembly 1450 for passing any suitable ambient fluid of the ambient environment between opening 1401 and absorber assembly 1450. Any suitable ambient opening filter 1401f may be provided at ambient opening 1401 and may be configured to filter any suitable substance(s) of the ambient environment for preventing such substance(s) from passing into ambient fluid channel 1423 via ambient opening 1401. For example, ambient opening filter 1401f may be any suitable filter configured to allow air to pass therethrough while blocking water, dust, and any suitable contaminants of the ambient environment from passing therethrough. Filter 1401f be made from any suitable materials, including, but not limited to, metal, ceramic, synthetic polymers, foam, non-woven fabrics, mesh, and/or the like, which can be selected for their permeability and/or durability. Additionally or alternatively, filter 1401 may be made more easily produced filter material(s), such as paper, cotton, sponge, and/or the like. System 1400 (e.g., container 1402 and/or head assembly 1440) may define any suitable absorber fluid channel 1424 of fluid (e.g., gas) conduit 1430, where absorber fluid channel 1424 may extend between absorber assembly 1450 and any suitable accumulation opening 1425 for passing any suitable fluid via absorber assembly 1450 into accumulation space 1428. Absorber assembly 1450 may include any suitable absorber mechanism 1407, which may be the same as or similar to absorber mechanism 102, 206, and/or the like. For example, absorber mechanism 1407 may be provided by any suitable absorber material (e.g., wool, cotton, microfibers, and/or the like) that may be configured to absorb liquid (e.g., water), such that, when liquid is absorbed by this material, any suitable number of small holes or cavities in the material may transition into a state whereby they do not allow air to pass therethrough (e.g., such that air passed from ambient opening 1401 through gas conduit 1430 may not reach accumulation space 1428 via accumulation opening 1425 due to such a transitioned absorber mechanism 1407). A first absorber mechanism portion 1431 (e.g., an internal end) of absorber mechanism 1407 may be positioned within ambient fluid channel 1423 and/or within any suitable portion of absorber fluid channel 1424 (e.g., via any suitable absorber opening 1433 through container 1402) in order to bring mechanism 1407 into communication with any fluid within ambient fluid channel 1423. Any suitable support (e.g., a support plug (e.g., any suitable plastic part)) may be provided to hold absorber mechanism 1407 in place with respect to container 1402 (e.g., such that first absorber mechanism portion 1431 (e.g., an internal end) of absorber mechanism 1407 may be positioned within ambient fluid channel 1423 and such that a second absorber mechanism portion 1432 (e.g., an external end) of absorber mechanism 1407 may be positioned external to container 1402 in order to be exposed to the target (e.g., a portion of mechanism 1407 between portions 1431 and 1432 may extend via opening 1433)). At least a portion of absorber mechanism 1407 may be any suitable fabric wick. Absorber assembly 1450 may include any suitable protection layer 1408 that may be provided along any suitable portion of absorber mechanism 1407 and may be configured to protect at least that portion of absorber mechanism 1407 from any possible source(s) of damage (e.g., roots in a target 1499) that may otherwise damage absorber mechanism 1407 if not protected by layer 1408 (e.g., a layer of rigid plastic)). Layer 1408 may be a protective layer (e.g., metal and/or plastic) with one or more holes configured to let liquid and air pass through while still protecting a portion of mechanism 1407 beyond layer 1408 (e.g., providing a filter from debris or damaging ambient element(s) (e.g., roots within a soil target)).

Absorber assembly 1450 may provide a multilayer material combination that may work together. Absorber assembly 1450 may include a material layer 1406 that may be configured to protect fluid conduit 1430 from receiving any liquid that has been absorbed by absorber mechanism 1407 (e.g., water absorbed into the absorber material of mechanism 1407). Layer 1406 may be a protective layer with one or more holes configured to let air but not liquid pass therethrough (e.g., such that any liquid from mechanism 1407 may not pass into channel 1424).

In some embodiments, absorber assembly 1450 may be a multilayer material assembly, which may include material 1407 (e.g., in the middle of the multilayer stack) that may be configured to absorb a liquid (e.g., an absorber layer or assembly component (e.g., wool, cotton, microfiber, fabric, wood, and/or any other suitable material(s))), an external layer 1408 that may be configured to protect material 1407 and/or adjust the release of liquid from absorber material 1407 (e.g., an absorber protection layer or assembly component (e.g., plastic, steel, aluminum, and/or any other suitable material(s)), which may include one or more holes therethrough for passing liquid and air but not passing larger debris and for protecting material 1407 from external forces (e.g., roots in a target soil)), and another layer 1406 (e.g., in internal layer) that may be configured to prevent liquid from entering fluid conduit 1430 (e.g., a water inlet protection layer or assembly component (e.g., ceramic, still, metal, and/or any other suitable material(s)), which may include one or more holes therethrough for passing air but not passing liquid for protecting fluid conduit 1430 from receiving unwanted liquid (e.g., from absorber mechanism 1407)). A small channel 1429 may be provided as extending away from a portion of absorber assembly 1450 within fluid conduit 1430 in order to provide a delivery path for such liquid being prevented by layer 1406 from entering conduit 1430. Instead, such liquid may be passed out from system 1400 (e.g., from channel 1423) via channel 1429 and into the ambient environment (e.g., to a portion of target 1499). Channel 1429 may be protected (e.g., from any external debris) by any suitable filter(s) and/or by its shape.

Container 1402 may include any suitable fluid outlet port(s) 1413 for enabling the discharge of any suitable fluid(s) from accumulation space 1428 and to the target. Container 1402 may define any suitable fluid or gas conduit 1430 (e.g., ambient fluid channel 1423 and absorber fluid channel 1424 that may fluidly communicate via absorber assembly 1450 (e.g., absorber mechanism 1407) for transporting any suitable fluid (e.g., any suitable gas (e.g., ambient fluid of the ambient environment (e.g., air))) from the ambient environment of system 1400 into accumulation space 1428. The fluid may be air or any other suitable gas that may enter ambient fluid channel 1423 via any suitable ambient opening(s) 1401. Ambient fluid channel 1423 of conduit 1430 may be configured to take air from the ambient environment (e.g., via opening(s) 1401) to absorber mechanism 1407, while absorber fluid channel 1424 of conduit 1430 may be configured to take such air from or via absorber mechanism 1407 to accumulation space 1428 (e.g., via opening(s) 1425, which may be positioned above the top surface of any liquid within accumulation space 1425). System 1400 may include any suitable absorber mechanism 1407 that may be provided by any suitable absorbent material(s). Mechanism 1407 (e.g., a long wool or cotton fabric) may be configured (e.g., as a wick) to absorb any suitable fluid from the target (e.g., second portion 1432 of mechanism 1407 may be configured to be in direct contact with the target external to container 1402 in order to absorb humidity or otherwise from the target) and variably block the flow of any suitable fluid (e.g., air) through conduit 1430 between opening(s) 1401 at the ambient environment and opening(s) 1425 at accumulation space 1428 (e.g., first portion 1431 of mechanism 1407 may be configured to block to a varying degree communication between channels 1423 and 1424 of conduit 1430 when first portion 1431 has expanded or otherwise transitioned from an original state (e.g., a dry state) to a transitioned state (e.g., a wet state)). In some embodiments, as shown in FIG. 14G, the target, such as target 1499, may be positioned at least a minimum distance from (e.g., below) ambient opening 1401 such that the target may not block a source of ambient fluid for conduit 1430, while the target may be positioned such that at least a portion of second portion 1432 of absorber mechanism 1407 may be in fluid communication with the target (e.g., at least a tip of second portion 1432 may be positioned within the target). Therefore, liquid concentration or other suitable transitioning in mechanism 1407 (e.g., in portion 1431 of mechanism 1407) may be configured to regulate the flow of fluid (e.g., gas (e.g., air)) transported through conduit 1430 between opening(s) 1401 and opening(s) 1425 (e.g., between the ambient environment and accumulation space 1428 of system 1400). Fluid may be discharged from accumulation space 1428 (e.g., via fluid outlet port(s) 1413) in proportion to the gas delivered to accumulation space 1428 via conduit 1430 (e.g., pressure created by the introduction of new fluid (e.g., air into accumulation space 1428 via conduit 1430 and opening(s) 1425) may be equalized by the removal of fluid (e.g., liquid from accumulation space 1428 via outlet port(s) 1413)). Any suitable head assembly 1440 may be provided for creating an air tight seal when it is not opened (e.g., at liquid inlet 1422) for enabling fluid from an external fluid source from adding fluid into accumulation space 1428 via any suitable source opening 1444 (e.g., seal assembly 1440 may be removed from opening 1444 when a hose or any other suitable fluid source may be used to inject liquid (e.g., water) into accumulation space 1428 via opening 1444, and seal assembly 1440 may be positioned at opening 1444 to seal opening 1444 shut to create an air tight seal at opening 1444 (e.g., such that when seal assembly 1440 may close opening 1444, ambient fluid (e.g., air) may only enter accumulation space 1428 via conduit 1430 and not also via opening 1444 and/or fluid outlet port(s) 1413 (e.g., port(s) 1413 may be configured with any suitable one-way valves for releasing fluid from space 1428 but not for introducing fluid into space 1428) and not also via opening(s) 1433). When a liquid is dispensed from accumulation space 1428 of system 1400 through port(s) 1413, ambient pressure above the liquid level in space 1428 may drop and create a partial vacuum. This vacuum may be filled by a volume of fluid (e.g., air) that may be generally equal to the volume of liquid that has been removed to equalize the pressure within the container. This pressure may be equalized by external air drawn into the container through conduit 1430 and not through the same valve aperture through which the liquid exited the container (e.g., not through port(s) 1413) and not through sealed opening(s) 1444 and not through opening(s) 1433. Because an air-back passageway (e.g., conduit 1430) may be at least in part formed separately from the liquid-out passageway (e.g., outlet port(s) 1413), air can flow into the container (e.g., accumulation space 1428) simultaneously with the dispensing of liquid therefrom. Thus, the pressure can continuously be equalized between the exterior of the container and the interior of the container above the liquid level within accumulation space 1428, so that the liquid may flow smoothly and/or at a controllable rate that may be dictated by liquid concentration or any other suitable transitioning in absorber assembly 1450 (e.g., in portion 1431 of mechanism 1407) within conduit 1430 (e.g., due to any suitable characteristic(s) of the target that may be exposed to portion 1432 of mechanism 1407 (e.g., target moisture level(s), target temperature level(s), level(s) of any suitable chemical(s) in the target, etc.)).

System 1400 may include any suitable flotation object 1414 that may be positioned within accumulation space 1428 and that may be configured to move up or down within space 1428 based on the accumulation of liquid (e.g., water) within space 1428. System 1400 (e.g., container 1402) may provide any suitable feed channel 1415 that may be configured to pass liquid from head assembly 1440 to accumulation space 1428. Head assembly 1440 may define any suitable inlet liquid channel 1421 that may receive any suitable liquid from liquid inlet 1422 and that may be configured to pass that liquid into accumulation space 1428 via feed channel 1415. Head assembly 1440 may include any suitable apparatus (e.g., within liquid channel 1421) for selectively passing liquid from channel 1421 to accumulation space 1428 (e.g., via channel 1415 and/or otherwise). Such apparatus may include a diaphragm 1419 (e.g., a rubber diaphragm), a component 1420 coupled to or otherwise supporting diaphragm 1419, any suitable small hole(s) 1426 through diaphragm 1419 (e.g., to send liquid from liquid inlet 1422 through diaphragm 1419), and a spring 1418 that may be configured to ensure a fluid path between liquid inlet 1422 and inlet liquid channel 1421 is closed if there is no input water pressure from liquid inlet 1422 (e.g., to avoid air entrance from liquid inlet 1422 when no liquid (e.g., source liquid) exists at liquid inlet 1422 for introduction into system 1400). Diaphragm 1419 may be coupled to component 1420 (e.g., a rigid plastic) on its back that may ensure closing of liquid channel 1421. Spring 1418 may be a separate part that is not connected directly to component 1420 but only via diaphragm 1419. Therefore, component 1420 may be configured to move up and down with diaphragm 1419. Component 1420 may be configured to hold spring 1418, while one or more holes 1417 may be provided through component 1420, and while diaphragm 1419 and component 1420 holding spring 1418 may form a spring accumulation zone that may be coupled to inlet liquid channel 1421 via holes 1426 through diaphragm 1419 for liquid input into the spring accumulation zone and to space 1428 through hole(s) 1417 for liquid output from the spring accumulation zone. Liquid may accumulate and diaphragm 1419 may be pushed to close a connection between liquid inlet 1422 and inlet liquid channel 1421, and/or a lever 1416 may be configured to be moved by flotation object 1414 (e.g., if flotation object 1414 moves upward within accumulation space 1428, it may push lever 1416 upward to close hole(s) 1417, and if flotation object 1414 moves downward within accumulation space 1428, lever 1416 may be pushed down (e.g., by its own weight and/or any pressure of liquid from hole(s) 1417) to open hole(s) 1417). Therefore, head assembly 1440 may include apparatus to restrict the liquid level inside accumulation space 1428 from getting too high. Such apparatus may include diaphragm 1419, which may be configured to regulate fluid flow by opening or closing based on pressure (e.g., diaphragm 1419 may be configured to use pressure of input liquid to work against itself (e.g., the area around diaphragm 1419 may be divided into two sections, a small area 1421 is coupled to inlet liquid from liquid inlet 1422, and liquid may be redirected through one or more small holes 1426 through diaphragm 1419 and may be released by one or more holes 1417 if to be closed, where the liquid may be accumulated in the back of diaphragm 1419 and a difference in area may create a difference in force that may cause liquid input stopped by a small force that may be applied by closing hole(s) 1417. Spring 1418 may be provided and configured to provide resistance to diaphragm 1419, which may ensure it returns to its closed position when needed, and a lever mechanism 1416 that may be actuated by float 1414. Float 1414 may be configured to move based on the fluid level, which may operate lever 1416, which in turn may open or close the small hole(s). This arrangement may enable precise control of fluid flow based on fluid levels and pressure differentials. For example, initially, fluid from the inlet may apply pressure to the center of diaphragm 1419. When float 1414 may cause lever 1416 to close small hole(s) 1417 in component 1420, pressure may build up behind diaphragm 1419 in the spring accumulation zone and/or channel 1421 plus spring force of any suitable rubber or additional possible spring(s) 1418 and/or diaphragm 1419. This pressure, combined with the force of the spring, may push diaphragm 1419 down, sealing the connection between the inlet and the outlet, thus preventing fluid flow. However, when float 1414 may go down and open small hole(s) 1417, the pressure in the chamber or channel 1421 may be relieved. As a result, the pressure from the inlet side may lift diaphragm 1419, allowing fluid to flow through the valve. Hole(s) 1426 in diaphragm 1419 may allow fluid pressure to balance across both sides, ensuring smooth operation. If hole(s) 1426 are blocked, the valve may remain open, as diaphragm 1419 may be continuously forced downward by the inlet pressure, bypassing the control exerted by channel 1421.

System 1400 may include any suitable liquid outlet assembly 1445 that may be configured to regulate the disbursement of liquid from accumulation space 1428 via fluid outlet port(s) 1413. Liquid outlet assembly 1445 may include any suitable base component 1409 (e.g., a plastic component) that may be coupled to a bottom surface of container 1402 (e.g., about fluid outlet port(s) 1413 that may be provided therethrough). A bottom free end of base component 1409 may be positioned within target 1499 (e.g., pushed into the soil), while one or more hole(s) 1427 may be provided through one or more side wall(s) of base component 1409 above the bottom free end and such hole(s) 1427 may be positioned above the target (e.g., above the soil level). Base component 1409, together with a rubber or other suitable bias component 1412, may be configured to form a one way valve for fluid outlet port(s) 1413 (e.g., bias component 1412 may be used to close fluid outlet port(s) 1413 whenever there is an appropriate air pressure drop inside accumulation space 1428). Additionally or alternatively, base component 1409 may be configured to deliver liquid from fluid outlet port(s) 1413 via a liquid exit area 1410 of component 1409 to a position below the surface level of the target (e.g., to save water from evaporation by direct sunlight). Hole(s) 1427 may be configured to let ambient air into assembly 1445 (e.g., so that there may be enough external air pressure at the output to enable proper functioning of liquid outlet assembly 1445 (e.g., as a one-way valve)). Any suitable structure 1411 of or inside base component 1409 may be configured to hold bias component 1412 in a functional position. Structure 1411 may be a spring in some embodiments. A mechanical spring (e.g., components 1411/1412) may be configured to require a minimum force to let liquid exit through assembly 1445 (e.g., spring behavior may be achieved by component(s) 1411 and/or 1412, which may be rubber material, and may be configured to need a minimum force to bend, but the same may be achieved via any suitable linear mechanical spring instead (e.g., if a mechanical metal spring may be provided to bias the liquid outlet shut, then external air pressure (e.g., via hole(s) 1427) may not be needed at the valve)). Such a minimum force may be achieved in different situations. For example, when the air channel is open, air pressure plus a minimum height of liquid inside accumulation space 1428 may make the exit area open. However, when the air channel is closed, a much higher liquid height may be needed to open the channel. This height difference may be used in head assembly 1440 to control water level. In some embodiments, bias component 1412 may be provided (e.g., instead of rubber or spring) as an absorber mechanism (e.g., absorber fabric) that may be configured to prevent air from traveling therethrough when wet.

System 1400 may include any suitable electric module 1404 that may be used (e.g., exclusively in electrical embodiments). Module 1404 may include a sensor portion 1405 that may be configured to detect any suitable characteristic(s) of the ambient environment (e.g., a humidity sensor). System 1400 (e.g., container 1402 and/or module 1404) may include a separate gas (e.g., air) entrance 1403 for electronic module 1404 (e.g., to receive air from the ambient environment). Electronic module 1404 may be configured to either let any air from entrance 1403 be transferred to absorber fluid channel 1424 and/or channel 1423 and/or or prevent the air from entering conduit 1430 of system 1400. Therefore, electric module 1404 may provide for a separate channel around absorber assembly 1450 (e.g., to let air in even if absorber material 1407 is not letting air to be transferred to absorber fluid channel 1424). System 1400 may be configured to allow for easy installation or removal of electric module 1404 based on the module's and system's configuration(s). Non-electrical versions of system 1400 may function without this electric module 1404. In some embodiments, if electric module 1404 is used, module 1404 may be coupled to container 1402 in such a way that a channel within module 1404 may fluidly couple channels 1423 and 1424 while bypassing absorber assembly 1450, wherein electric module 1404 may be programmed to automatically open or close its coupling channel for either fluidly coupling or fluidly decoupling channels 1423 and 1424 (e.g., similarly to the functionality of absorber assembly 1450 but through automatic electronic programming rather than via purely mechanical methodologies). Alternatively, in some embodiments, if electric module 1404 is used, module 1404 may be coupled to container 1402 in such a way that a channel within module 1404 may fluidly couple gas entrance 1403 of module 1404 to channel 1424 while bypassing absorber assembly 1450 and channel 1423, wherein electric module 1404 may be programmed to automatically open or close its coupling channel for either fluidly coupling or fluidly decoupling gas entrance 1403 and channel 1424 (e.g., similarly to the functionality of absorber assembly 1450 with channels 1423 and 1424 but through automatic electronic programming rather than via purely mechanical methodologies).

System 1400 can be adjusted mechanically by mechanical sliders in various ways. For example, the air channel connection to output air can be adjusted by a slider, such that the duration of time that may be required to dry the sensor may be adjusted (e.g., as may be described with respect to system 1500). As another example, a connection between absorber material 1407 and target 1499 may be adjusted (e.g., using any suitable barrier and/or protection layer(s)) (see, e.g., assembly 1530 of system 1500, which may include a protection layer in plastic that may include some long openings that may be fixed or that may be adjustable (e.g., via a screw) such that an area of connection between a target and absorber mechanism may change). As another example, an amount of water delivered to the target can be adjusted (e.g., by changing the size, number, and/or open/closed status of fluid outlet port(s) 1413).

In some embodiments, any suitable lever of a system of the disclosure (e.g., lever 1416 of system 1400) may be controlled using weight. For example, such a lever may be actuated by weight difference instead of a force applied by a float object. Therefore, adding a thick layer of fabric (e.g., an absorber mechanism) to a free lever end may be used (e.g., in place of a container or reservoir portion) and may provide an alternative embodiment of a system that may be configured to work by accumulating weight in the added fabric due to moisture absorption. However, some extra parts may be provided to protect the system and increase its lifetime (e.g., the illustrated container may change its shape and functionality and it may become smaller just to protect the lever and the material on it that may absorb liquid, and/or a piece of absorber may be configured to extend to the ambient environment (e.g., inside a target (e.g., to let it absorb humidity from a soil target)), and/or one or more small openings may be provided through the container to let a controlled amount of air circulate inside and let the absorber material dry and go to its initial state.

In some embodiments, other approaches may be used instead of or in addition to a diaphragm (e.g., diaphragm 1419 of system 1400) to control fluid height with a very small force, including, but not limited to, one or more hydraulic servo valves, one or more pilot-operated pressure relief valves, one or more butterfly valves with pilot control, one or more pressure-reducing valves with pilots, one or more weir-type diaphragm valves, one or more straight-through diaphragm valves, one or more pinch diaphragm valves, one or more pneumatic diaphragm valves, one or more hydraulic diaphragm valves, one or more solenoid-operated diaphragm valves, three-way diaphragm valves, and/or the like.

In some embodiments, a system of the disclosure may include a hydraulic servo valve, which may use both mechanical leverage and pressure amplification to control high-pressure hydraulic systems with minimal input force. In this design, a small force may be applied to a lever or spool that may open or close the valve controlling high-pressure fluid flow. The mechanical advantage provided by the lever may reduce the input effort required. Additionally, the input pressure signal, usually applied to a large surface area of the valve's spool or piston, may amplify into a larger force acting on the fluid. This combination of mechanical leverage and pressure amplification may allow for precise control of high-pressure systems using only small mechanical or fluid input (e.g., a float may inset a linear force that may increase using a lever and/or a diaphragm).

In some embodiments, a system of the disclosure may include a pilot-operated pressure relief valve, which may be used in high-pressure systems such as steam or hydraulic systems. In this setup, a small pilot valve may be provided and configured to control the opening and closing of a larger main valve. The pilot valve, which may operate via a mechanical lever or pivot system, may require only minimal force to regulate. When the pilot valve opens, it may release pressure from a chamber behind the main valve. As pressure drops, the larger valve may open, relieving pressure from the main system. This design may use both mechanical leverage (e.g., to control the pilot valve) and pressure differentials (e.g., to control the main valve), thereby allowing for efficient management of large fluid volumes without the need for a large input force.

In some embodiments, a system of the disclosure may include a butterfly valve with pilot control that may combine leverage and pressure amplification. A butterfly valve may include a disc mounted on a rod that may rotate around a pivot point. By applying a small force to a lever or actuator, the disc may rotate, thereby regulating fluid flow. A mechanical advantage provided by the lever may reduce the force needed to open or close the valve. When combined with a pilot valve system, the pilot may be configured to control fluid flow into an actuator (e.g., a diaphragm or piston), which may move the butterfly valve. A small pressure signal from the pilot valve may be sufficient to actuate the butterfly valve, thereby enabling control of large fluid volumes with minimal input effort. This method may be particularly effective for controlling flow in high-pressure pipelines.

In some embodiments, a system of the disclosure may include one or more pressure-reducing valves with pilots that may be designed to reduce downstream pressure from a high-pressure source. An internal valve may be controlled by a lever mechanism that may provide mechanical advantage, thereby allowing a small movement of the lever to result in a larger movement of the valve. The pilot valve may be configured to regulate the pressure behind the main valve, and this regulated pressure may be used to open or close the main valve. By using a pilot valve to amplify small control inputs, pressure-reducing valves can manage significant pressure differences while requiring minimal mechanical force to operate.

In some embodiments, a system of the disclosure may include a weir-type diaphragm valve that may be configured to use a slightly raised weir in the valve body, against which the diaphragm may press efficiently. A small mechanical lever can be used to control the diaphragm, providing mechanical advantage. Additionally, a pilot valve can be incorporated to regulate the pressure behind the diaphragm, further reducing the force needed to open or close the valve. This type of valve may be ideal for systems that may need precise control with minimal movement to block fluid flow. This design may be configured to use minimal diaphragm movement to open or close the valve.

In some embodiments, a system of the disclosure may include a straight-through diaphragm valve that may be configured to offer an unobstructed flow path when fully open, as the diaphragm may be configured to lift directly away from the flow. This design may be useful when unrestricted flow may be useful. A float-controlled lever or spring mechanism can be used to lift the diaphragm, while a pilot valve can control the pressure in the chamber behind the diaphragm. This configuration may enable smooth operation with minimal force, even in high-flow applications.

In some embodiments, a system of the disclosure may include a pinch diaphragm valve that may be configured to operate by “pinching” the diaphragm to stop the flow of fluid. This design may be effective for controlling viscous or abrasive fluids, as the valve may have no internal cavities where material can accumulate. A mechanical lever system can be used to pinch the diaphragm with minimal input force, while a pilot valve can be added to control pressure differentials, thereby enhancing the valve's efficiency in systems with high fluid pressures.

In some embodiments, a system of the disclosure may include any suitable pneumatic diaphragm valve(s), where air pressure may be used to move the diaphragm. A pilot valve may be configured to control the air pressure supplied to the diaphragm's actuator, thereby amplifying small pressure signals to move the diaphragm. A mechanical lever or float system can be used to activate the pilot valve, thereby allowing fluid flow to be controlled with minimal input effort. This type of valve may be well-suited for systems that may require automated or remote control.

In some embodiments, a system of the disclosure may include one or more hydraulic diaphragm valves that may be configured to use hydraulic pressure to move the diaphragm. The hydraulic pressure may be configured to provide greater force, making these valves suitable for high-pressure systems. A pilot valve can be used to control the hydraulic pressure applied to the diaphragm actuator, while a lever mechanism can further reduce the input force that may be needed to operate the valve. This combination of hydraulic amplification and mechanical leverage may allow for precise control in demanding environments.

In some embodiments, a system of the disclosure may include a solenoid-operated diaphragm valve that may be configured to use an electric solenoid to move a plunger, which may control the pressure acting on the diaphragm. This valve type may be used in automated systems. For purely mechanical applications, the solenoid can be replaced with any suitable mechanical spring or cam-driven mechanism to achieve the same diaphragm movement without electricity. This setup can be activated by a float or lever, thereby allowing for minimal mechanical input.

In some embodiments, a system of the disclosure may include a three-way diaphragm valve that may be configured to allow for switching between two different flow paths using a single diaphragm. A mechanical lever or float mechanism can be used to switch the flow direction by moving the diaphragm. A pilot valve can be incorporated or otherwise provided to control the pressure behind the diaphragm, thereby ensuring smooth transitions between flow paths with minimal force. This design may be useful especially for systems that may require frequent switching between different process streams.

Some electronic systems may be configured to work simply by a linear electric motor, which may open air passage in a very efficient way. However, this approach can be achieved by other methods, including, but not limited to, piezo materials, vibrator motors, solenoid valves, other electrical methods, and/or the like (e.g., a linear motor may be used to control a channel 1507 of system 1500).

Although, a goal of an electronic module added to a system of the disclosure may be to control an air channel, other possibilities for connecting the electronic board to other boards or giving electrical sensibility functions to a system or multiple interconnected systems are also considered herein.

In some embodiments, an absorbent material of one or more systems of the disclosure may be just one layer of fabric. However, in other embodiments, multilayer materials may be used, where some of these material layers may be for absorbing liquid (e.g., material of cotton, wool, etc.), while some of these material layers may be for protection (e.g., material of plastic, other fabrics, etc.), while some of these material layers may be for letting air pass and not liquid (e.g., material developed from ceramics, hydrophobic materials, etc.) (see, e.g., system 1500 and/or system 1600).

In some embodiments, a place of connection between an air channel and a container of any suitable system of the disclosure may be protected by ceramic material(s), hydrophobic material(s), and/or the like. This protection may be provided by any suitable shapes, such as through using small holes or inclined channels (see, e.g., system 1500 and/or system 1600).

In some embodiments, one or more rubber materials may be used at a place of exit but may be changed to just using fabrics in other embodiments (see, e.g., system 1400 and/or system 1600).

In some embodiments, one or more locations of input air that comes from an environment of any suitable system of the disclosure may be protected by any suitable filters to avoid dirt and dust accumulations in channels and increase system lifetime (e.g., filter(s) may not let any dust or other debris enter, for reducing chance of failure through the filter(s) and protection of the filter(s) through structural design of the system).

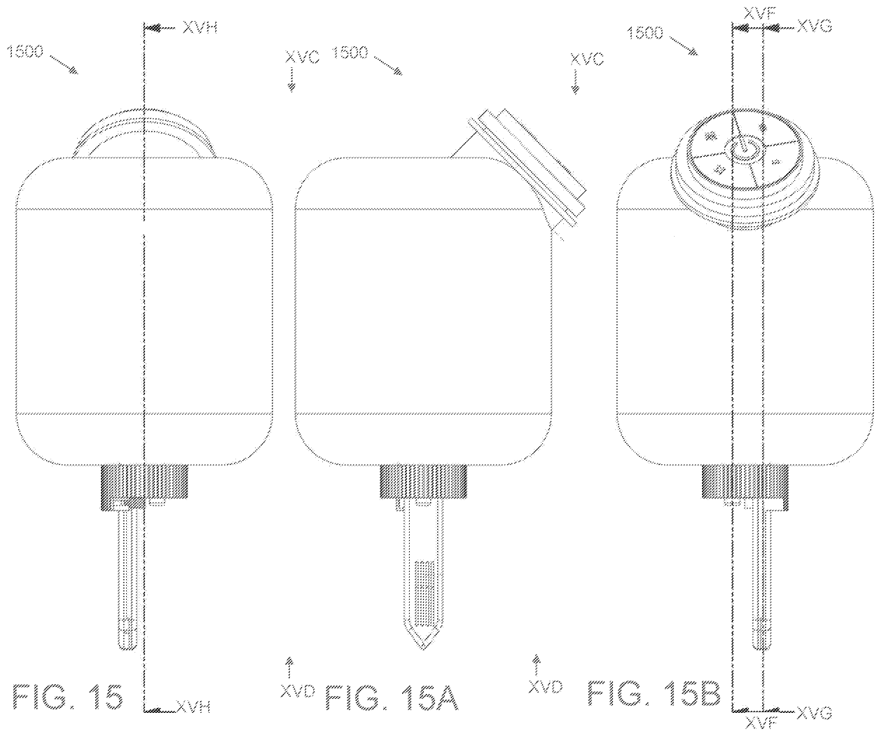

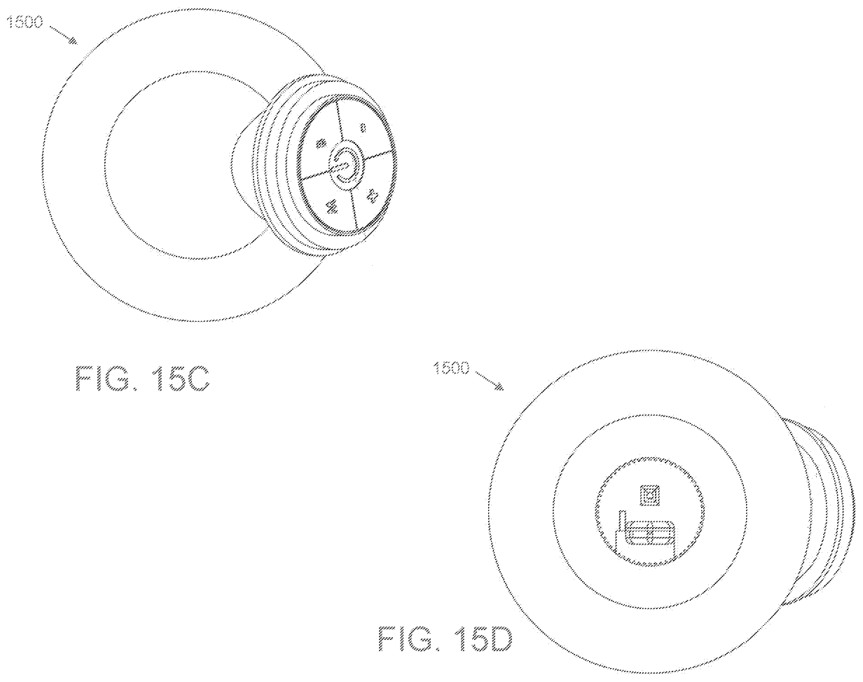

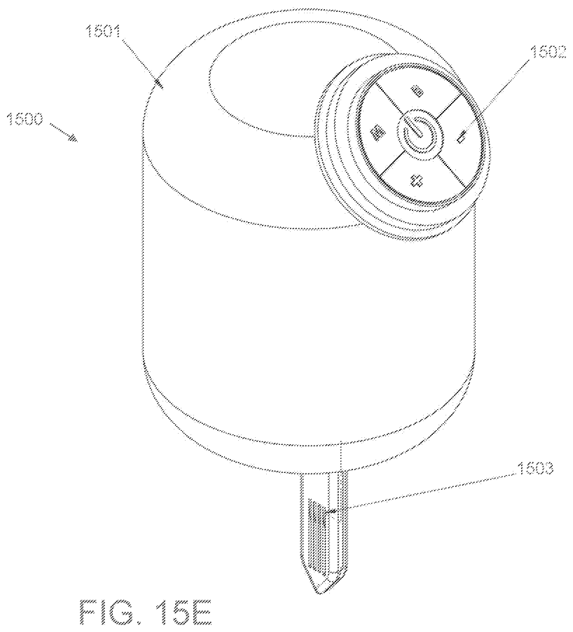

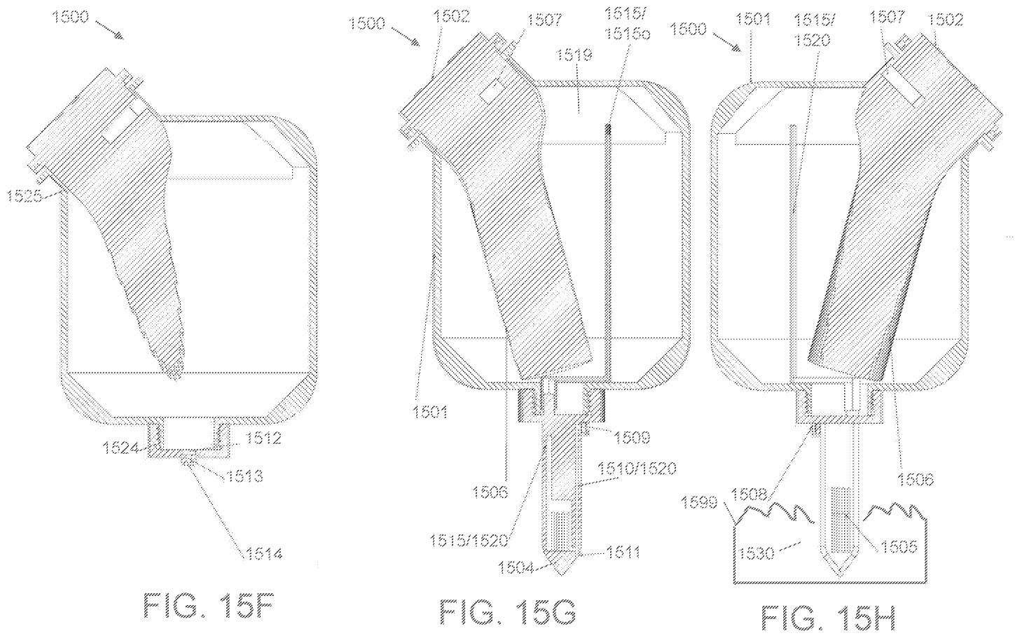

### FIGS. 15-15H

As shown in FIGS. 15-15H, in some embodiments of the disclosure, there may be provided a system 1500, which may be similar to or the same as system 100 and/or system 200 in various ways. As shown, system 1500 may include a liquid (e.g., water) container 1501. Any suitable mechanical sensor assembly structure 1503 may be provided and coupled to (e.g., removably coupled to a bottom of) container 1501 for defining an accumulation space 1519 that may be configured to hold any suitable fluid(s) (e.g., water, air, etc.). In some embodiments, rather than being permanently coupled, sensor assembly 1503 may be provided for being removably coupled about a bottom container opening 1524 (e.g., at a bottom of container 1501) using any suitable coupling mechanism(s) (e.g., threading, snap, adhesive, etc.) for enabling liquid to be supplied into accumulation space 1519 from any suitable liquid source (e.g., sensor assembly 1503 may be decoupled (e.g., unscrewed) from container 1501 and container 1501 may be turned upside down to be filled with any suitable liquid manually by a user via opening 1524).

System 1500 (e.g., container 1501 and/or sensor assembly 1503) may define any suitable ambient opening(s) 1508 that may be exposed to any suitable environment of system 1500 for enabling any suitable ambient fluid of the ambient environment (e.g., air) of system 1500 to enter into system 1500 via opening(s) 1508. System 1500 (e.g., container 1501 and/or sensor assembly 1503) may define any suitable ambient fluid channel 1510 of a fluid (e.g., gas) conduit 1520, where ambient fluid channel 1510 may extend between one or more ambient opening(s) 1508 and any suitable absorber assembly 1530 for passing any suitable ambient fluid of the ambient environment between opening(s) 1508 and absorber assembly 1530. Any suitable ambient opening filter may be provided at ambient opening(s) 1508 and may be configured to filter any suitable substance(s) of the ambient environment for preventing such substance(s) from passing into ambient fluid channel 1510 via ambient opening(s) 1508. Any suitable adjustable component 1509 (e.g., any suitable slider component or otherwise) may be provided by system 1500 (e.g., container 1501 and/or sensor assembly 1503) and may be configured to be used to control an amount of air that can enter ambient fluid channel 1510 by adjusting an area of an entrance of one or more ambient openings 1508 of ambient fluid channel 1510. Adjustable component 1509 may be configured to control the area of ambient air opening(s) 1508, which may provide a form of controllability on time between irrigations. System 1500 (e.g., container 1501 and/or sensor assembly 1503) may define any suitable absorber fluid channel 1515 of fluid (e.g., gas) conduit 1520, where absorber fluid channel 1515 may extend between absorber assembly 1530 and any suitable location within accumulation space 1519 (e.g., the location at which a free open end 15150 of channel 1515 may be positioned) for passing any suitable fluid via absorber assembly 1530 into accumulation space 1519 (e.g., opening 15150 may be configured to allow air to pass therethrough but to not allow liquid to pass therethrough). Channel 1515 may be protected at least partially by the structural body of sensor assembly 1503 and/or the structural body of container 1501. Absorber assembly 1530 may include any suitable absorber mechanism 1505, which may be the same as or similar to absorber mechanism 102, 206, and/or the like. For example, absorber mechanism 1505 may be provided by any suitable absorber material (e.g., wool, cotton, microfibers, and/or the like) that may be configured to absorb liquid (e.g., water), such that, when liquid is absorbed by this material, any suitable number of small holes or cavities in the material may transition into a state whereby they do not allow air to pass therethrough (e.g., such that air passed from ambient opening 1508 through gas conduit 1520 may not reach accumulation space 1519 via channel 1515 due to such a transitioned absorber mechanism 1505). A first absorber mechanism portion (e.g., an internal end) of absorber mechanism 1505 may be positioned within ambient fluid channel 1510 and/or within any suitable portion of absorber fluid channel 1515 (e.g., via any suitable absorber opening through container 1501 and/or sensor assembly 1503) in order to bring absorber mechanism 1505 into communication with any fluid within ambient fluid channel 1510. Any suitable support (e.g., a support plug (e.g., any suitable plastic part)) may be provided to hold absorber mechanism 1505 in place with respect to container 1501 and/or sensor assembly 1503 (e.g., such that a first absorber mechanism portion (e.g., an internal end) of absorber mechanism 1505 may be positioned within ambient fluid channel 1510 and such that a second absorber mechanism portion (e.g., an external end) of absorber mechanism 1505 may be positioned external to container 1501 and/or sensor assembly 1503 and/or exposed via any suitable opening through such structure in order for absorber mechanism 1505 to be exposed to the target (e.g., a portion of mechanism 1505 between such first and second portions may extend via an such opening in container 1501 and/or sensor assembly 1503 or mechanism 1505 may be exposed to the target via such an opening without mechanism 150 extending out through such an opening)).

At least a portion of absorber mechanism 1505 may be any suitable fabric wick. Absorber assembly 1530 may include any suitable protection layer(s) that may be provided along any suitable portion of absorber mechanism 1505 and may be configured to protect at least that portion of absorber mechanism 1505 from any possible source(s) of damage (e.g., roots in a soil target) that may otherwise damage absorber mechanism 1505 if not protected by such a protection layer (e.g., a layer of rigid plastic)). Absorber assembly 1530 may provide a multilayer material combination that may work together. Absorber assembly 1530 may include a material layer 1504 (e.g., any suitable filter and/or ceramic and/or metal that may be used for avoiding liquid entrance) that may be configured to protect fluid conduit 1520 from receiving any liquid that has been absorbed by absorber mechanism 1505 (e.g., water absorbed into the absorber material of mechanism 1505) and/or to deliver air inside container 1501. A bottom portion of container 1501 and/or sensor assembly 1503 may be shaped in such a way (e.g., a spike shape, as shown (see, e.g., component 1504)) that it may promote or enable easier insertion of that portion of the system into a target 1599 (e.g., into a soil target) for exposing absorber assembly 1530 to such a target.

In some embodiments, absorber assembly 1530 may be a multilayer material assembly, which may include material 1505 (e.g., in the middle of the multilayer stack) that may be configured to absorb a liquid (e.g., an absorber layer or assembly component (e.g., wool and/or any other suitable material(s)), an external layer that may be configured to protect material 1505 and/or adjust the release of liquid from absorber material 1505 (e.g., an absorber protection layer or assembly component (e.g., plastic, steel, aluminum, and/or any other suitable material(s)), and another layer 1504 that may be configured to prevent liquid from entering fluid conduit 1520 (e.g., a water inlet protection layer or assembly component (e.g., ceramic, still, and/or any other suitable material(s)). A small channel 1511 may be provided as extending away from a portion of absorber assembly 1530 within fluid conduit 1520 in order to provide a delivery path for such liquid being prevented by layer 1504 from entering conduit 1520. Instead, such liquid may be passed out from system 1500 (e.g., from channel 1510) via channel 1511 and into the ambient environment (e.g., to a portion of a target of system 1500). Channel 1511 may be protected (e.g., from any external debris) by any suitable filter(s) and/or by its shape. Channel 1511 may be configured to deliver trapped liquid in an air channel to a target or other suitable part of an ambient environment. Container 1501 may include any suitable fluid outlet port(s) (see, e.g., component(s) 1512/1513/1514) for enabling the discharge of any suitable fluid(s) from accumulation space 1519 and to the target (e.g., target 1599). System 1500 (e.g., container 1501 and/or sensor assembly 1503) may define any suitable fluid or gas conduit 1520 (e.g., ambient fluid channel 1510 and absorber fluid channel 1515 that may fluidly communicate via absorber assembly 1530 (e.g., absorber mechanism 1505) for transporting any suitable fluid (e.g., any suitable gas (e.g., ambient fluid of the ambient environment (e.g., air))) from the ambient environment of system 1500 into accumulation space 1519. The fluid may be air or any other suitable gas that may enter ambient fluid channel 1510 via any suitable ambient opening(s) 1508. Ambient fluid channel 1510 of conduit 1520 may be configured to take air from the ambient environment (e.g., via opening(s) 1508) to absorber mechanism 1505, while absorber fluid channel 1515 of conduit 1520 may be configured to take such air from or via absorber mechanism 1505 to accumulation space 1519 (e.g., via opening 1515o, which may be positioned above the top surface of any liquid within accumulation space 1519). System 1500 may include any suitable absorber mechanism 1505 that may be provided by any suitable absorbent material(s). Mechanism 1505 (e.g., a long wool or cotton fabric) may be configured (e.g., as a wick) to absorb any suitable fluid from the target (e.g., an external portion of mechanism 1505 may be configured to be in direct contact with the target external to system 1500 in order to absorb humidity or otherwise from the target) and variably block the flow of any suitable fluid (e.g., air) through conduit 1520 between opening(s) 1508 at the ambient environment and opening(s) 1515o at accumulation space 1519 (e.g., an internal portion of mechanism 1505 may be configured to block to a varying degree communication between channels 1510 and 1515 of conduit 1520 when the internal portion has expanded or otherwise transitioned from an original state (e.g., a dry state) to a transitioned state (e.g., a wet state)). In some embodiments, as shown in FIG. 15H, the target, such as a target 1599, may be positioned at least a minimum distance from (e.g., below) ambient opening(s) 1508 such that the target may not block a source of ambient fluid for conduit 1520, while the target may be positioned such that at least a portion of an external portion of absorber mechanism 1505 may be in fluid communication with the target (e.g., at least a tip of an external portion of the absorber mechanism may be positioned within the target). Therefore, liquid concentration or other suitable transitioning in mechanism 1505 may be configured to regulate the flow of fluid (e.g., gas (e.g., air)) transported through conduit 1520 between opening(s) 1508 and opening(s) 1515o (e.g., between the ambient environment and accumulation space 1519 of system 1500). Fluid may be discharged from accumulation space 1519 via any suitable fluid outlet port(s) in proportion to the gas delivered to accumulation space 1519 via conduit 1520 (e.g., pressure created by the introduction of new fluid (e.g., air into accumulation space 1519 via conduit 1520 and opening(s) 1515o) may be equalized by the removal of fluid (e.g., liquid from accumulation space 1519 via such fluid outlet port(s))). As shown, for example, system 1500 may include a reduced area 1512 that may be configured to enable optional use of any suitable one-way valve, a channel 1513 with a reduced area that may be configured to reduce linear applied force by fluid within accumulation space 1519, where special shapes such as a Tesla valve may help the functionality of channel 1513, and a special shape 1514 that may be configured to avoid liquid moves to form a large surface. Components 1512 and 1513 may be configured to provide any suitable one-way valve, while component 1514 may provide a curved edge or otherwise that may be configured to prevent liquid from forming a wide surface and potentially dripping from component 1514 into the ambient environment.

In some embodiments, system 1500 may include any suitable electronic module 1502 that may be removably coupled to container 1502 (e.g., to or within any suitable top container opening 1525 (e.g., at a top or side or corner of container 1501) using any suitable coupling mechanism(s) (e.g., threading, snap, adhesive, etc.) for enabling liquid to be supplied into accumulation space 1519 from any suitable liquid source (e.g., electronic module 1502 may be decoupled (e.g., unscrewed) from container 1501 and container 1501 may be filled with any suitable liquid manually by a user via opening 1525).

If an electronic module is not provided or desired to be utilized by an end user, the electronic module may be replaced by any suitable seal cap that may be used to seal opening 1525. As shown, electronic module 1502 may include any suitable sensor(s), such as a liquid level sensor 1506 that may be configured to detect a level of liquid within accumulation space 1519 and may be configured to send an alert (e.g., via an audible alarm at module 1502 or via a wireless electronic message to a user device, etc.) when it is determined that more liquid ought to be inserted into accumulation space 1519.

Electronic module 1502 may include any suitable air channel 1507 that may be configured to selectively communicate air from the ambient environment into accumulation space 1519 (e.g., air channel 1507 may be controlled by a linear motor of electronic module 1502 or any other suitable approaches to open or close air channel 1507 for fluidly coupling the ambient environment with space 1519 to let a controlled amount of air enter accumulation space 1519 via channel 1507 (e.g., based on any suitable irrigation schedule that may be programmed into module 1502, such that automatic irrigation may occur that may override irrigation initiated by the mechanics of absorber assembly 1530 and gas conduit 1520 (e.g., even if absorber assembly 1530 is in a transitioned state that may be blocking air from entering space 1519 via conduit 1520, module 1502 may still be configured to automatically open air channel 1507 for introducing air into space 1519 for forcing liquid out from space 1519 into the ambient environment via the liquid outlet(s))).

When a liquid is dispensed from accumulation space 1519 of system 1500 through any suitable liquid outlet port(s), ambient pressure above the liquid level in space 1519 may drop and create a partial vacuum. This vacuum may be filled by a volume of fluid (e.g., air) that may be generally equal to the volume of liquid that has been removed to equalize the pressure within the container. This pressure may be equalized by external air drawn into the container through conduit 1520 and/or air channel 1507 of electronic module 1502 and not through the same valve aperture through which the liquid exited the container (e.g., not through the liquid outlet port(s)) and not through sealed opening(s) 1524/1525 and/or any other openings through container 1501/sensor assembly 1503. Because an air-back passageway (e.g., conduit 1520) may be at least in part formed separately from the liquid-out passageway (e.g., liquid outlet port(s)), air can flow into the container (e.g., accumulation space 1519) simultaneously with the dispensing of liquid therefrom. Thus, the pressure can continuously be equalized between the exterior of the container and the interior of the container above the liquid level within accumulation space 1519, so that the liquid may flow smoothly and/or at a controllable rate that may be dictated by liquid concentration or any other suitable transitioning in absorber assembly 1530 within conduit 1520 (e.g., due to any suitable characteristic(s) of the target that may be exposed to absorber mechanism 1505 (e.g., target moisture level(s), target temperature level(s), level(s) of any suitable chemical(s) in the target, etc.)). Ambient fluid channel 1510 may take in any suitable gas (e.g., air) from the ambient environment via any suitable ambient opening(s) 1508 and such intake may be controlled via any suitable adjustable component(s) 1509, and remaining air may be transferred to absorber mechanism 1505 via channel 1510 and then via absorber mechanism 1505 to accumulation space 1519 via channel 1515, while any liquid may be transferred via conduit 1520 to the target via channel 1511 (e.g., because, if by any chance water came into gas conduit 1520, the liquid may be fed into the target (e.g., soil) rather than remaining in conduit 1520 to block air flow). At an end of channel 1510, material layer 1504 may be provided and configured to make it hard for water to come inside air channel 1510 (e.g., component or layer 1504 may be a small filter or ceramic material (e.g., with 60 to 100 ppi) that may have one or more small holes to a level such that air molecules can pass by but not water molecules because they tend to have higher bonds together).

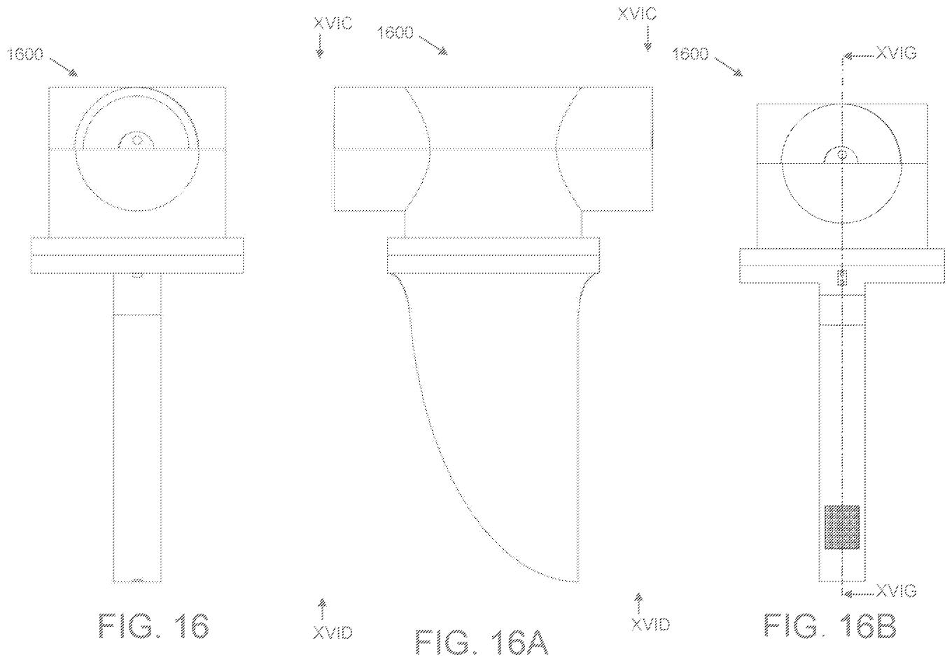

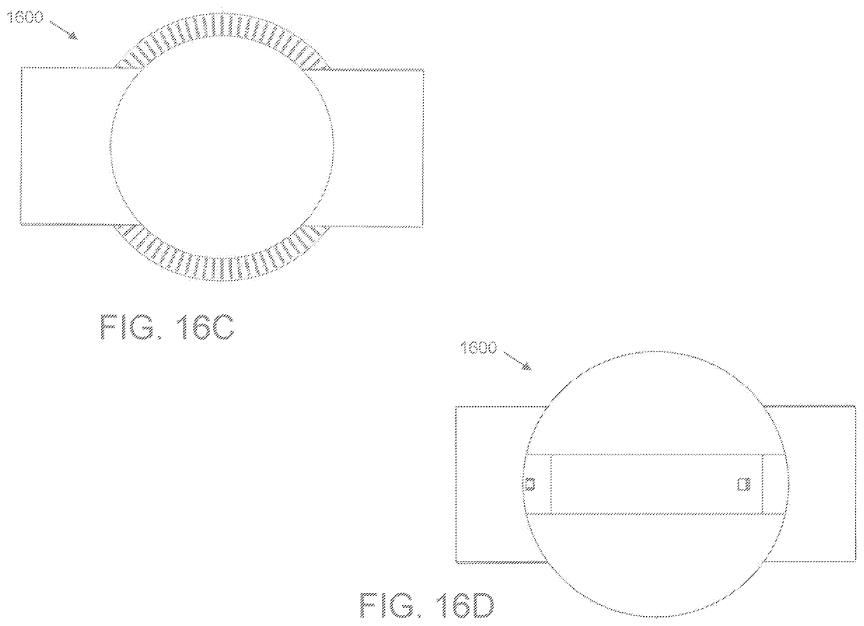

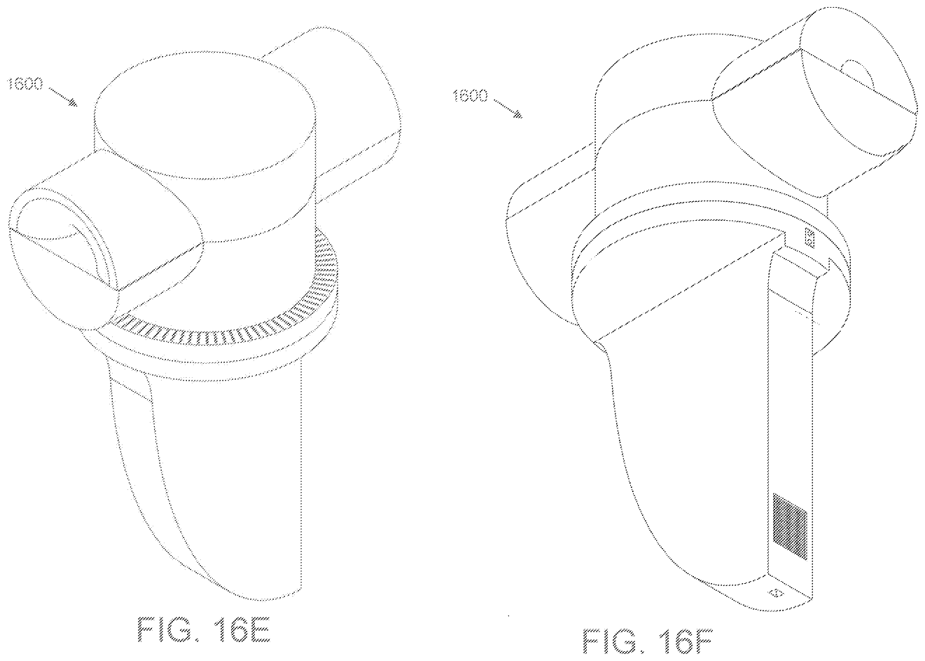

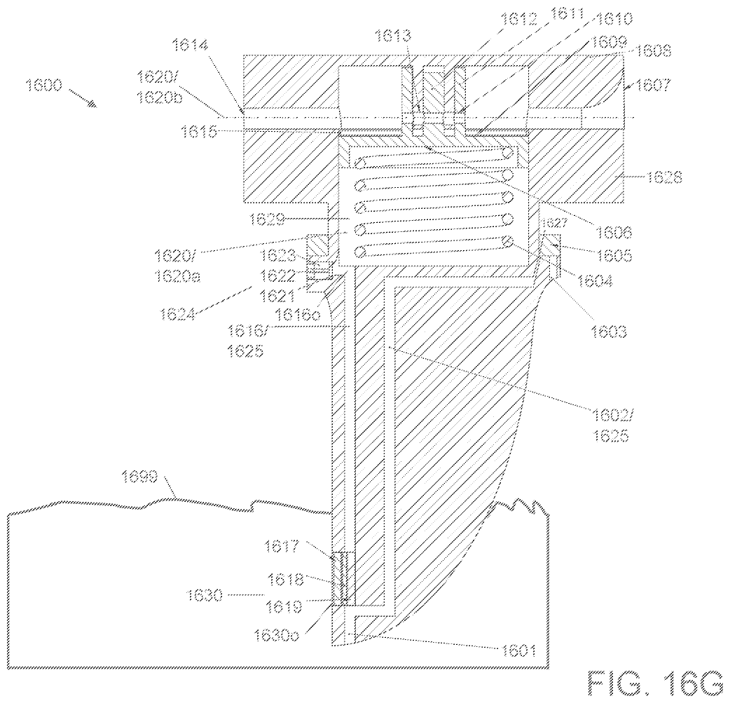

### FIGS. 16-16G

As shown in FIGS. 16-16H, in some embodiments of the disclosure, there may be provided a system 1600, which may be similar to or the same as system 100 and/or system 200 in various ways. As shown, system 1600 may include a liquid (e.g., water) container (e.g., body structure) that may be provided by a top structure or top container 1608, a bottom structure or bottom container 1628, and an internal shaft 1612 that may be coupled (e.g., removably coupled) to top container 1608 and coupled (e.g., removably coupled) to bottom container 1628 for defining one or more accumulation spaces 1620 (e.g., an air chamber 1620a below shaft 1612 (e.g., to hold any suitable fluid (e.g., gas (e.g., air))) and/or a liquid passageway 1620b that may be formed to extend through a liquid inlet 1607 and one or more holes 1610 in shaft 1612 and one or more holes 1613 in top container 1608 when such holes 1610 and 1613 are aligned and a fluid (e.g., liquid and/or gas) outlet 1614 (e.g., liquid passageway 1620b may be enabled to pass any suitable liquid (e.g., water) from any suitable source through liquid inlet 1607 and through liquid outlet 1614 to any suitable target via holes 1610 and 1613 when hole(s) 1610 align with hole(s) 1613 for forming a continuous passageway between inlet 1607 and outlet 1614)). In some embodiments, top container 1608 and bottom container 1628 may be distinct components that may be coupled (e.g., removably coupled) to one another or each of which may be coupled (e.g., removably coupled) to shaft 1612. In other embodiments, top container 1608 and bottom container 1628 may be a unitary structure and shaft 1612 may be positioned within a shaft space 1629 that may be provided at least partially within that unitary structure. System 1600 (e.g., container(s) 1608/1628) may define any suitable ambient opening(s) 1627 that may be exposed to any suitable environment of system 1600 (e.g., directly or via any suitable filter(s) 1605) for enabling any suitable ambient fluid of the ambient environment (e.g., air) of system 1600 to enter into system 1600 via opening(s) 1627.

A channel 1603 may be provided (e.g., by container(s) 1608/1628) for taking liquid that may pass a filter to the ambient environment (e.g., to a target). For example, any liquid that may be passed by filter 1605 may be fed into channel 1603 for releasing back into the ambient environment rather than into opening 1627 of channel 1602, which might hinder the functionality of gas conduit 1625.

System 1600 (e.g., container(s) 1608/1628) may define any suitable ambient fluid channel 1602 of a fluid (e.g., gas) conduit 1625, where ambient fluid channel 1602 may extend between one or more ambient opening(s) 1627 and any suitable absorber assembly 1630 for passing any suitable ambient fluid of the ambient environment between opening(s) 1627 and absorber assembly 1630. Any suitable ambient opening filter 1605 may be provided at ambient opening(s) 1627 and may be configured to filter any suitable substance(s) of the ambient environment for preventing such substance(s) from passing into ambient fluid channel 1602 via ambient opening(s) 1627. Any suitable adjustable component(s) may be provided by system 1600 (e.g., container(s) 1608/1628) and may be configured to be used to control an amount of air that can enter ambient fluid channel 1602 by adjusting an area of an entrance of one or more ambient openings 1627 of ambient fluid channel 1602. Such an adjustable component may be configured to control the area of ambient air opening(s) 1627, which may provide a form of controllability on time between irrigations. System 1600 (e.g., container(s) 1608/1628) may define any suitable absorber fluid channel 1616 of fluid (e.g., gas) conduit 1625, where absorber fluid channel 1616 may extend between absorber assembly 1630 and any suitable location within accumulation space 1620 (e.g., within air chamber 1620a (e.g., at a location below shaft 1612 at which an upper end of channel 1616 may fluidly couple with chamber 1620a)) for passing any suitable fluid via absorber assembly 1630 into air chamber 1620a. Absorber fluid channel 1616 may be protected at least partially by the structural body of container(s) 1608/1628. Absorber assembly 1630 may include any suitable absorber mechanism 1618, which may be the same as or similar to absorber mechanism 102, 206, and/or the like. For example, absorber mechanism 1618 may be provided by any suitable absorber material (e.g., wool, cotton, microfibers, and/or the like) that may be configured to absorb liquid (e.g., water), such that, when liquid is absorbed by this material, any suitable number of small holes or cavities in the material may transition into a state whereby they do not allow air to pass therethrough (e.g., such that air passed from ambient opening 1627 through gas conduit 1625 may not reach air chamber 1620a via channel 1616 due to such a transitioned absorber mechanism 1618). A first absorber mechanism portion (e.g., an internal end) of absorber mechanism 1618 may be positioned within ambient fluid channel 1602 and/or within any suitable portion of absorber fluid channel 1616 (e.g., via any suitable absorber opening through container(s) 1608/1628) in order to bring absorber mechanism 1618 into communication with any fluid within ambient fluid channel 1602. Any suitable support (e.g., a support plug (e.g., any suitable plastic part)) may be provided to hold absorber mechanism 1618 in place with respect to container(s) 1608/1628 (e.g., such that a first absorber mechanism portion (e.g., an internal end) of absorber mechanism 1618 may be positioned within ambient fluid channel 1602 and such that a second absorber mechanism portion (e.g., an external end) of absorber mechanism 1618 may be positioned external to container(s) 1608/1628 and/or exposed via any suitable opening 1630o in container(s) 1608/1628 in order to be exposed to the target (e.g., a portion of mechanism 1618 between such first and second portions may extend via opening 1630o in container(s) 1608/1628 or the second portion may be positioned within opening 1630o (e.g., behind any suitable protection layer 1617))). A bottom portion of container(s) 1608/1628 may be shaped in such a way that it may promote or enable easier insertion of that portion of the system into a target 1699 (e.g., into a soil target) for exposing absorber assembly 1630 to such a target (e.g., via opening 1630o).

At least a portion of absorber mechanism 1618 may be any suitable fabric wick. Absorber assembly 1630 may include any suitable protection layer(s) 1617 that may be provided along any suitable portion of absorber mechanism 1618 and may be configured to protect at least that portion of absorber mechanism 1618 from any possible source(s) of damage (e.g., roots in a soil target) that may otherwise damage absorber mechanism 1618 if not protected by such a protection layer (e.g., a layer of rigid plastic)). Absorber assembly 1630 may provide a multilayer material combination that may work together. Absorber assembly 1630 may include a material layer 1619 (e.g., any suitable filter and/or ceramic and/or metal that may be used for avoiding liquid entrance) that may be configured to protect fluid conduit 1625 from receiving any liquid that has been absorbed by absorber mechanism 1618 (e.g., water absorbed into the absorber material of mechanism 1618) and/or to deliver air inside container(s) 1608/1628. In some embodiments, layer 1619 may instead be provided by a one way valve or a tesla valve or the like. Layer 1619 may be any suitable filter or component that may be configured to pass air but not liquid therethrough. A seal may be provided at the bottom of layer 1619 to prevent any air from channel 1601 to pass up through layer 1619 and beyond absorber mechanism 1618 and into channel 1616. Instead, layer 1619 may only pass air from the ambient environment that passed through absorber mechanism 1618 (e.g., and also layer 1617 via any suitable container opening 1630o) into channel 1616 while preventing any liquid from absorber mechanism 1618 from passing into channel 1616 (e.g., such liquid may block channel 1616).

In some embodiments, absorber assembly 1630 may be a multilayer material assembly, which may include material 1618 (e.g., in the middle of the multilayer stack) that may be configured to absorb a liquid (e.g., an absorber layer or assembly component (e.g., wool and/or any other suitable material(s)), an external layer 1617 that may be configured to protect material 1618 and/or adjust the release of liquid from absorber material 1618 (e.g., an absorber protection layer or assembly component (e.g., plastic, steel, aluminum, and/or any other suitable material(s)), and another layer 1619 that may be configured to prevent liquid from entering fluid conduit 1625 (e.g., a water inlet protection layer or assembly component (e.g., ceramic, still, and/or any other suitable material(s)). A small channel 1601 may be provided as extending away from a portion of absorber assembly 1630 within fluid conduit 1625 in order to provide a delivery path for such liquid being prevented by layer 1619 from entering conduit 1625. Instead, such liquid may be passed out from system 1600 (e.g., from channel 1602) via channel 1601 and into the ambient environment (e.g., to a portion of a target of system 1600). Channel 1601 may be protected (e.g., from any external debris) by any suitable filter(s) and/or by its shape. Channel 1601 may be configured to deliver trapped liquid in an air channel to a target or other suitable part of an ambient environment. Container(s) 1608/1628 may include any suitable fluid outlet port(s) 1614 for enabling the discharge of any suitable fluid(s) from liquid passageway 1620b and to a target. System 1600 (e.g., container(s) 1608/1628) may define any suitable fluid or gas conduit 1625 (e.g., ambient fluid channel 1602 and absorber fluid channel 1616 that may fluidly communicate via absorber assembly 1630 (e.g., absorber mechanism 1618) for transporting any suitable fluid (e.g., any suitable gas (e.g., ambient fluid of the ambient environment (e.g., air))) from the ambient environment of system 1600 into air chamber 1620a. The fluid may be air or any other suitable gas that may enter ambient fluid channel 1602 via any suitable ambient opening(s) 1627. Ambient fluid channel 1602 of conduit 1625 may be configured to take air from the ambient environment (e.g., via opening(s) 1627) to absorber mechanism 1618, while absorber fluid channel 1616 of conduit 1625 may be configured to take such air from or via absorber mechanism 1618 to air chamber 1620a (e.g., via an opening 1616o at an end of channel 1616, which may be positioned within air chamber 1620a (e.g., below shaft 1612 or otherwise)).

System 1600 may include any suitable absorber mechanism 1618 that may be provided by any suitable absorbent material(s). Mechanism 1618 (e.g., a long wool or cotton fabric) may be configured (e.g., as a wick) to absorb any suitable fluid from the target (e.g., an external portion of mechanism 1618 may be configured to be in direct contact with the target external to system 1600 in order to absorb humidity or otherwise from the target) and variably block the flow of any suitable fluid (e.g., air) through conduit 1625 between opening(s) 1627 at the ambient environment and opening(s) 1616o at air chamber 1620a (e.g., an internal portion of mechanism 1618 may be configured to block to a varying degree communication between channels 1602 and 1616 of conduit 1625 when the internal portion has expanded or otherwise transitioned from an original state (e.g., a dry state) to a transitioned state (e.g., a wet state)). In some embodiments, as shown in FIG. 16G, the target, such as a target 1699, may be positioned at least a minimum distance from (e.g., below) ambient opening(s) 1627 such that the target may not block a source of ambient fluid for conduit 1625, while the target may be positioned such that at least a portion of an external portion of absorber mechanism 1618 may be in fluid communication with the target (e.g., at least a tip of an external portion of the absorber mechanism may be positioned within the target). Therefore, liquid concentration or other suitable transitioning in mechanism 1618 may be configured to regulate the flow of fluid (e.g., gas (e.g., air)) transported through conduit 1625 between opening(s) 1627 and opening(s) 1616o (e.g., between the ambient environment and air chamber 1620a of accumulation space 1620 of system 1600). Fluid may be discharged from liquid passageway 1620b of accumulation space 1620 of system 1600 via any suitable fluid outlet port(s) 1614 (e.g., in proportion to the gas delivered to air chamber 1620a of accumulation space 1620 of system 1600 (e.g., pressure created by the introduction of new fluid (e.g., air into air chamber 1620a of accumulation space 1620 of system 1600 via conduit 1625 and opening(s) 1616o) may be equalized by the removal of fluid (e.g., liquid from liquid passageway 1620b of accumulation space 1620 of system 1600 via such fluid outlet port(s) 1614))).

As shown, for example, system 1600 may include a small channel 1623 that may be protected by a thin rubber plate 1621 that may be supported by any suitable part 1622 and/or otherwise for providing any suitable one-way valve 1624. Channel 1616 may be fluidly coupled to channel 1623 (e.g., at or near opening 16160), whereby one-way valve 1624 may be configured to let any internal trapped air out (e.g., to the ambient environment) if absorber mechanism 1618 is wet and air cannot go out via absorber assembly 1630 (e.g., in such a situation, if shaft 1612 were to move downwardly within air chamber 1620a, any trapped air may travel out through channel 1623 of one-way valve 1624). Valve 1624 may be configured as a one-way valve to allow certain air to be released from system 1600 into the ambient atmosphere (e.g., if absorber assembly 1630 may be preventing air flow therethrough and action of shaft 1612 has pushed air into air chamber 1620a, such trapped air may be released via valve 1624 rather than being forced down into channel 1616, which may negatively affect absorber assembly 1630. As an example, when an input liquid from any suitable source may enter into liquid inlet 1607, in some situations (e.g., normal operation) the force that may be applied by the pressure of such input fluid (e.g., liquid and/or gas) on a top surface 1609 of shaft 1612 may be equal to and opposite the force that may be applied by air pressure within air chamber 1620a on a bottom surface 1606 of shaft 1612, such that hole(s) 1613 and hole(s) 1610 may be aligned due to this equilibrium (e.g., using any suitable biasing component 1604 (e.g., spring) below shaft 1612 and/or another biasing component above shaft 1612 (not shown), while a section 1611 of shaft 1612 may be used for sealing and guidance) for forming a continuous liquid passageway 1620b through which the input liquid may pass from liquid inlet 1607 to liquid outlet 1614 (e.g., for irrigating target 1699). Pressure of input liquid at inlet 1607 may bias shaft 1612 downward against an upward force of biasing component 1604 with enough force such that hole(s) 1613 and hole(s) 1610 may be misaligned for closing or terminating continuous liquid passageway 1620b. However, when at least a certain amount of air is within air chamber 1620a, such air may provide an upward pressure on shaft 1612 (e.g., in combination with upward pressure from biasing component 1604) to overcome any downward pressure by liquid at liquid inlet 1607 such that that hole(s) 1613 and hole(s) 1610 may be aligned for opening or forming continuous liquid passageway 1620b. One or more screws or other adjustment mechanisms may be provided for adding adjustments on forces (e.g., as applied to the biasing component(s)) to adjust the system for different pressures (e.g., for adjusting the position of biasing component 1604 with respect to container(s) 1608/1628 and/or the like to calibrate the system for desired use). However, if liquid may be communicating with absorber assembly 1630 (e.g., within target 1699) and such liquid may be absorbed by absorber mechanism 1618 (e.g., and filter 1619) such that air circulation may be at least partially blocked by absorber assembly 1630 within absorber fluid channel 1616, such that the equilibrium may be lost and such that hole(s) 1613 and hole(s) 1610 may not be aligned for terminating a continuous liquid passageway 1620b such that no liquid may be passed from liquid inlet 1607 to liquid outlet 1614 through the valve. In some embodiments, system 1600 may include any suitable diaphragm 1615 that may be configured for sealing purposes. Diaphragm 1615 may be any suitable component configured to prevent or block liquid within any portion(s) of liquid passageway 1620b from entering (e.g., seeping down into) air chamber 1620a while allowing appropriate action of shaft 1612 with respect to container(s) 1608/1628. The design of system 1600 presented herein is merely exemplary. Various modifications and adaptations can be implemented without departing from the core principles and scope of the disclosure. These variations may include, but are not limited to, the incorporation of feedback channels to monitor and adjust output pressure, the use of multiple springs to enhance pressure control, the integration of backpressure channels to manage differential pressures, the implementation of electronic and/or electromechanical valves for precise regulation of air pressure, and/or the like. Additionally or alternatively, mechanisms, such as adjustable screws, may be employed to modify spring compression, thereby altering the initial force exerted on the spring to fine-tune performance. Other potential embodiments may include the use of diaphragm-based control mechanisms, pilot-operated regulators for improved precision, balanced valve designs to minimize the impact of inlet pressure fluctuations, temperature compensation features to maintain consistent performance, ventilation ports or bleed holes for fine low-pressure regulation, integrated pressure relief mechanisms for safety in overpressure conditions, and/or the like. These and other potential variations may be considered to fall within the scope of this disclosure.

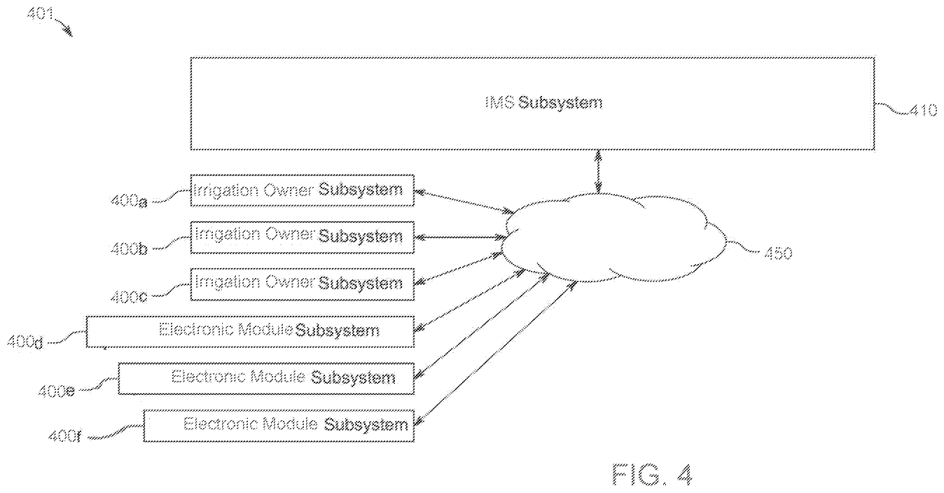

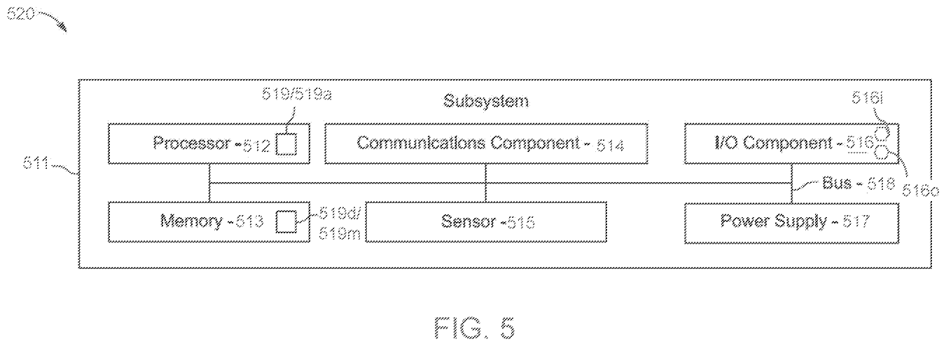

### FIGS. 4 and 5

FIG. 4 is a schematic view of an illustrative system 401 in which an irrigation management service may be facilitated amongst one or more various entities. For example, as shown in FIG. 4, system 401 may include an irrigation management service (“IMS”) subsystem 410, various subsystems 400 (e.g., one or more irrigation system owner (“IO”) subsystems 400a-400c (e.g., an owner's laptop computer, portable smart device, etc.), one or more irrigation electronic module subsystems 400d-400f (e.g., electronic module 1404, electronic module 1502, etc.) each of which may be functionally coupled to one or more irrigation systems (e.g., one or more of systems 100, 200, 300, 800, 900, 1000, 1100, 1200, 1300, 1400, 1500, 1600, etc.), and at least one communications network 450 through which any two or more of the subsystems 410 and 400 may communicate. IMS subsystem 410 may be operative to interact with any of the various subsystems 400 to provide an irrigation management service platform (“IMSP”) that may facilitate various irrigation management services.

As shown in FIG. 5, and as described in more detail below, a subsystem 520, which may be any of subsystems 400 and 410, may include a processor component 512, a memory component 513, a communications component 514, a sensor component 515, an input/output (“I/O”) component 516, a power supply component 517, and/or a bus 518 that may provide one or more wired or wireless communication links or paths for transferring data and/or power to, from, or between various other components of subsystem 520. In some embodiments, one or more components of subsystem 520 may be combined or omitted. Moreover, subsystem 520 may include other components not combined or included in FIG. 5 and/or several instances of the components shown in FIG. 5. For the sake of simplicity, only one of each of the components of subsystem 520 is shown in FIG. 5.

I/O component 516 may include at least one input component 516i (e.g., a button, mouse, keyboard, etc.) to receive information from a user or other device or power therefrom and/or at least one output component 5160 (e.g., an audio output component or speaker, video output component or display, haptic output component (e.g., rumbler, vibrator, etc.), lighting output component, olfactory output component, movement actuator, etc.) to provide information or power or any other suitable support to a user or other device, such as a touch screen I/O component that may receive input information through a user's touch of a display screen and that may also provide visual information to a user via that same display screen, and/or the like. In some embodiments, an I/O component 516 may be any suitable data and/or power connector (e.g., a Universal Serial Bus (“USB”) connector or any other suitable connector type, a wireless charger (e.g., an inductive charging pad or the like), etc.) that may be utilized in any suitable manner by any suitable portable media device or the like.

Memory 513 may include one or more storage mediums or media, including for example, a hard drive, flash memory, permanent memory such as read only memory (“ROM”), semi-permanent memory such as random access memory (“RAM”), any other suitable type of storage component, or any combination thereof (e.g., for storing any suitable data (e.g., data 519d (e.g., a service system management model 519m (e.g., that may be used by any suitable application 519a)))). Memory 513 may include suitable logic, circuitry, and/or code that may enable storage of various types of information, such as received data, generated data, code, and/or configuration information.

Communications component 514 may be provided to allow subsystem 520 to communicate with one or more other subsystems 520 (e.g., any communication to/from/between subsystem(s)/module(s) 410 and 400 of system 401) using any suitable communications protocol. Communications component 514 can be operative to create or connect to a communication network or link of a network. Communications component 514 can provide wireless communications using any suitable short range or long range communications protocol, such as Wi Fi (e.g., an 802.11 protocol), Bluetooth, ultra wideband, radio frequency systems (e.g., 1200 MHZ, 2.4 GHz, and 5.6 GHz communication systems), near field communication (“NFC”), infrared, protocols used by wireless and cellular telephones and personal e mail devices, or any other protocol supporting wireless communications. Communications component 514 can also be operative to connect to a wired communications link or directly to another data source wirelessly or via one or more wired connections or other suitable connection type(s). Communications component 514 may be a network interface that may include the mechanical, electrical, and/or signaling circuitry for communicating data over physical links that may be coupled to other devices of a network. Such network interface(s) may be configured to transmit and/or receive any suitable data using a variety of different communication protocols, including, but not limited to, TCP/IP, UDP, ATM, synchronous optical networks (“SONET”), any suitable wired protocols or wireless protocols now known or to be discovered, Frame Relay, Ethernet, Fiber Distributed Data Interface (“FDDI”), and/or the like. In some embodiments, one, some, or each of such network interfaces may be configured to implement one or more virtual network interfaces, such as for Virtual Private Network (“VPN”) access.

Sensor 515 may be any suitable sensor that may be configured to sense any suitable data for subsystem 120 (e.g., location based data via a GPS sensor system, motion data, environmental data, biometric data, etc.). Sensor 515 may be a sensor assembly that may include any suitable sensor or any suitable combination of sensors operative to detect movements of subsystem 520 and/or of any user thereof and/or any other characteristics of subsystem 520 and/or of its environment (e.g., physical activity or other characteristics of a user of subsystem 520, light content of the device environment, gas pollution content of the device environment, noise pollution content of the device environment, altitude of the device, etc.). Sensor 55 may include any suitable sensor(s), including, but not limited to, one or more of a GPS sensor, wireless communication sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. Sensor 515 may include any suitable sensor components or subassemblies for detecting any suitable movement of subsystem 520 and/or of a user thereof. For example, sensor 515 may include one or more three axis acceleration motion sensors (e.g., an accelerometer) that may be operative to detect linear acceleration in three directions (i.e., the x- or left/right direction, the y- or up/down direction, and the z- or forward/backward direction). As another example, sensor 515 may include one or more single axis or two axis acceleration motion sensors that may be operative to detect linear acceleration only along each of the x- or left/right direction and the y- or up/down direction, or along any other pair of directions. In some embodiments, sensor 515 may include an electrostatic capacitance (e.g., capacitance coupling) accelerometer that may be based on silicon micro machined micro electro-mechanical systems (“MEMS”) technology, including a heat based MEMS type accelerometer, a piezoelectric-type accelerometer, a piezo resistance type accelerometer, and/or any other suitable accelerometer (e.g., which may provide a pedometer or other suitable function). Sensor 515 may be operative to directly or indirectly detect rotation, rotational movement, angular displacement, tilt, position, orientation, motion along a non-linear (e.g., arcuate) path, or any other non-linear motions. Additionally or alternatively, sensor 515 may include one or more angular rate, inertial, and/or gyro motion sensors or gyroscopes for detecting rotational movement. For example, sensor 515 may include one or more rotating or vibrating elements, optical gyroscopes, vibrating gyroscopes, gas rate gyroscopes, ring gyroscopes, magnetometers (e.g., scalar or vector magnetometers), compasses, and/or the like. Any other suitable sensors may also or alternatively be provided by sensor 515 for detecting motion on subsystem 520, such as any suitable pressure sensors, altimeters, or the like. Using sensor(s) 515, subsystem 520 may be configured to determine a velocity, acceleration, orientation, and/or any other suitable motion attribute of subsystem 520. One or more biometric sensors may be multi-modal biometric sensors and/or operative to detect long lived biometrics, modern liveness (e.g., active, passive, etc.) biometric detection, and/or the like. Sensor 515 may include a microphone, camera, scanner (e.g., a barcode scanner or any other suitable scanner that may obtain product identifying information from a code, such as a linear barcode, a matrix barcode (e.g., a quick response (“QR”) code), or the like), proximity sensor, light detector, temperature sensor, motion sensor, biometric sensor (e.g., a fingerprint reader or other feature (e.g., facial) recognition sensor, which may operate in conjunction with a feature processing application that may be accessible to subsystem 520 for attempting to authenticate a user), line in connector for data and/or power, and/or combinations thereof. In some examples, each sensor can be a separate device, while, in other examples, any combination of two or more of the sensors can be included within a single subsystem or device. For example, a gyroscope, accelerometer, photoplethysmogram, galvanic skin response sensor, and temperature sensor can be included within a wearable electronic device, such as a smart watch, while a scale, blood pressure cuff, blood glucose monitor, SpO2 sensor, respiration sensor, posture sensor, stress sensor, and asthma inhaler can each be separate devices. While specific examples are provided, it should be appreciated that other sensors can be used and other combinations of sensors can be combined into a single subsystem or device. Subsystem 520 can further include a timer that can be used, for example, to add time dimensions to various attributes of any detected element(s). Sensor 515 may include any suitable sensor components or subassemblies for detecting any suitable characteristics of any suitable condition of the lighting of the environment of subsystem 520. For example, sensor 515 may include any suitable light sensor that may include, but is not limited to, one or more ambient visible light color sensors, illuminance ambient light level sensors, ultraviolet (“UV”) index and/or UV radiation ambient light sensors, and/or the like. Any suitable light sensor or combination of light sensors may be provided for determining the illuminance or light level of ambient light in the environment of subsystem 520 (e.g., in lux or lumens per square meter, etc.) and/or for determining the ambient color or white point chromaticity of ambient light in the environment of subsystem 520 (e.g., in hue and colorfulness or in x/y parameters with respect to an x-y chromaticity space, etc.) and/or for determining the UV index or UV radiation in the environment of subsystem 520 (e.g., in UV index units, etc.). Sensor 515 may include any suitable sensor components or subassemblies for detecting any suitable characteristics of any suitable condition of the air quality of the environment of subsystem 520. For example, sensor 515 may include any suitable air quality sensor that may include, but is not limited to, one or more ambient air flow or air velocity meters, ambient oxygen level sensors, volatile organic compound (“VOC”) sensors, ambient humidity sensors, ambient temperature sensors, and/or the like. Any suitable ambient air sensor or combination of ambient air sensors may be provided for determining the oxygen level of the ambient air in the environment of subsystem 520 (e.g., in O2 % per liter, etc.) and/or for determining the air velocity of the ambient air in the environment of subsystem 120 (e.g., in kilograms per second, etc.) and/or for determining the level of any suitable harmful gas or potentially harmful substance (e.g., VOC (e.g., any suitable harmful gasses, scents, odors, etc.) or particulate or dust or pollen or mold or the like) of the ambient air in the environment of subsystem 520 (e.g., in HG % per liter, etc.) and/or for determining the humidity of the ambient air in the environment of subsystem 520 (e.g., in grams of water per cubic meter, etc. (e.g., using a hygrometer)) and/or for determining the temperature of the ambient air in the environment of subsystem 520 (e.g., in degrees Celsius, etc. (e.g., using a thermometer)). Sensor 515 may include any suitable sensor components or subassemblies for detecting any suitable characteristics of any suitable condition of the sound quality of the environment of subsystem 520. For example, sensor 515 may include any suitable sound quality sensor that may include, but is not limited to, one or more microphones or the like that may determine the level of sound pollution or noise in the environment of subsystem 520 (e.g., in decibels, etc.). Sensor 515 may also include any other suitable sensor for determining any other suitable characteristics about a user of subsystem 520 and/or the environment of subsystem 520 and/or any situation within which subsystem 520 may be existing. For example, any suitable clock and/or position sensor(s) may be provided to determine the current time and/or time zone within which subsystem 520 may be located. Sensor 515 may be embedded in a body (e.g., housing 511) of subsystem 520, such as along a bottom surface that may be operative to contact a user, or can be positioned at any other desirable location. In some examples, different sensors can be placed in different locations inside or on the surfaces of subsystem 520 (e.g., some located inside housing 511 and some attached to an attachment mechanism (e.g., a wrist band coupled to a housing of a wearable device), or the like). In other examples, one or more sensors can be worn by a user separately as different parts of a single subsystem 520 or as different subsystems or devices. In such cases, the sensors can be configured to communicate with subsystem 520 using a wired and/or wireless technology (e.g., via communications component 514). In some examples, sensors can be configured to communicate with each other and/or share data collected from one or more sensors.

Power supply 517 can include any suitable circuitry for receiving and/or generating power, and for providing such power to one or more of the other components of subsystem 520. For example, power supply assembly 517 can be coupled to a power grid (e.g., when subsystem 520 is not acting as a portable device or when a battery of the device is being charged at an electrical outlet with power generated by an electrical power plant). As another example, power supply assembly 517 may be configured to generate power from a natural source (e.g., solar power using solar cells). As another example, power supply assembly 517 can include one or more batteries for providing power (e.g., when subsystem 520 is acting as a portable device). Subsystem 520 may also be provided with a housing 511 that may at least partially enclose one or more of the components of subsystem 520 for protection from debris and other degrading forces external to subsystem 520. Each component of subsystem 520 may be included in the same housing 511 (e.g., as a single unitary device, such as a portable media device or server) and/or different components may be provided in different housings (e.g., a keyboard input component may be provided in a first housing that may be communicatively coupled to a processor component and a display output component that may be provided in a second housing, such as in a desktop computer set up). In some embodiments, subsystem 120 may include other components not combined or included in those shown or several instances of the components shown.

Processor 512 may be used to run one or more applications, such as an application 519 that may be accessible from memory 513 (e.g., as a portion of data 519d) and/or any other suitable source (e.g., from any other device in its system). Application 519 may include, but is not limited to, one or more operating system applications, firmware applications, communication applications (e.g., for enabling communication of data between devices), third party service applications, internet browsing applications (e.g., for interacting with a website provided by a third party or remote subsystem), application programming interfaces (“APIs”), software development kits (“SDKs”), proprietary applications (e.g., a web application or a native application) for enabling subsystem 520 to interact with an online service and/or one or more other subsystems and/or the like, which may include applications for routing protocols, SDN modules based on OpenFlow, P4, or other network data plane programming standards, machine learning algorithms, network management functions, and/or the like, and/or any other suitable applications. For example, processor 512 may load an application 519 as an interface program to determine how instructions or data received via an input component 516i of I/O component 516 or other component of subsystem 520 (e.g., sensor 515 and/or communications component 514) may manipulate the way in which information may be stored (e.g., in memory 13) and/or provided via an output component 516o of I/O component 516 (e.g., presented to a user on a display or actuator manipulation to adjust the functionality and/or position of any suitable component) and/or communicated to another system device via communications component 514. As one example, application 519 may be firmware. As another example, application 519 may be a third party application that may be running on subsystem 520 (e.g., an application associated with the network of system 401) that may be loaded on subsystem 520 in any suitable manner, such as via an application market (e.g., using communications component 514), such as the Apple App Store or Google Play, or that may be accessed via an internet application or web browser (e.g., by Apple Safari or Google Chrome) that may be running on subsystem 520 and that may be pointed to a uniform resource locator (“URL”) whose target or web resource may be managed by or otherwise affiliated with any suitable entity. Any subsystem may include any suitable special purpose hardware (e.g., hardware support of high-speed packet processing, hardware support of machine learning algorithms, etc.). Processor 512 may include suitable logic, circuitry, and/or code that may enable processing data and/or controlling operations of subsystem 520. In this regard, processor 512 may be enabled to provide control signals to various other components of subsystem 520. Processor 512 may also control transfers of data between various portions of subsystem 520. Processor 512 may further implement an operating system or may otherwise execute code to manage operations of subsystem 520.

Subsystem 520 may be any portable, mobile, wearable, implantable, or hand held electronic device configured to operate with system 401. Alternatively, subsystem 520 may not be portable during use, but may instead be generally stationary. Subsystem 520 can include, but is not limited to, a media player, video player, still image player, game player, other media player, music recorder, movie or video camera or recorder, still camera, other media recorder, radio, medical equipment, domestic appliance, smart appliance (e.g., smart door handle, smart door lock, etc.), transportation vehicle instrument, musical instrument, calculator, cellular telephone, other wireless communication device, personal digital assistant, remote control, pager, computer (e.g., a desktop, laptop, tablet, server, etc.), monitor, television, stereo equipment, set up box, set top box, wearable device, boom box, modem, router, printer, kiosk, beacon, server, and any combinations thereof.

In some embodiments, processor 512 may be used to run one or more applications that may be accessible from memory 513 and/or from any other suitable source (e.g., an application from IMS subsystem 410 via an active internet connection or otherwise at and for use by a subsystem 400). Such an application may include, but is not limited to, one or more operating system applications, firmware applications, communication applications, internet browsing applications (e.g., for interacting with a website provided by IMS subsystem 410 for enabling a subsystem 400 to interact with an online service of IMS subsystem 410 (e.g., a IMSP)), IMS applications (e.g., a web application or a native application or a hybrid application that may be at least partially produced by IMS subsystem 410 for enabling a subsystem 400 to interact with an online service of IMS subsystem 410 (e.g., a IMSP)), or any other suitable applications. As one example, an application of a subsystem 400 may provide a user with the ability to interact with a service or the IMSP of IMS subsystem 410, where such an application may be a third party application that may be running on a subsystem 400 (e.g., an application (e.g., software and/or firmware) associated with IMS subsystem 410 that may be loaded on subsystem 400 from IMS subsystem 410 or via an application market) and/or that may be accessed via an internet application or web browser running on subsystem 400 (e.g., processor 512) that may be pointed to a uniform resource locator (“URL”) whose target or web resource may be managed by IMS subsystem 410 or any other remote subsystem. Each subsystem 400 may be a portable media device (e.g., a smartphone), a laptop computer, a tablet computer, a desktop computer, an appliance, a wearable electronic device, a virtual reality device, a dongle device, at least one web or network server (e.g., for providing an online resource, such as a website or native online application, for presentation on one or more other subsystems) with an interface for an administrator of such a server, and/or the like.

Some or all portions of IMS subsystem 410 may be operated, managed, or otherwise at least partially controlled by an entity (e.g., administrator) responsible for providing an irrigation management service to one or more clients or other suitable entities. IMS subsystem 410 may communicate with one or more subsystems 400 via communications network 450. Network 450 may be the internet or any other suitable network, such that when intercoupled via network 450, any two subsystems of system 401 may be operative to communicate with one another (e.g., a subsystem 400 may access information (e.g., from an application 519 or data 519d of IMS subsystem 410, as may be provided as an irrigation management service via processor 512 and communications component 514 of IMS subsystem 410) as if such information were stored locally at that subsystem 400 (e.g., in its memory component 513)).

Various clients and/or partners may be enabled to interact with IMS subsystem 410 for enabling the irrigation management services and the IMSP. For example, at least one owner subsystem of system 401 (e.g., each one of the one or more owner subsystems 400a-400c) may be any suitable subsystem (e.g., portable computer) operated by any suitable owner that may own, rent, or otherwise have access to an electronic module of an irrigation system.

Each subsystem 400 of system 401 (e.g., each one of subsystems 400a-400f) may be operated by any suitable entity for interacting in any suitable way with IMS subsystem 410 (e.g., via network 50) for deriving value from and/or adding value to a service of the IMSP of IMS subsystem 410. For example, a particular subsystem 400 may be a server operated by a client/partner entity that may receive any suitable data from IMS subsystem 410 related to any suitable irrigation management enhancement of the IMSP provided by IMS subsystem 410 (e.g., via network 450). Additionally or alternatively, a particular subsystem 400 may be a server operated by a client/partner entity that may upload or otherwise provide any suitable data to IMS subsystem 410 related to any suitable irrigation management service of the IMSP provided by IMS subsystem 410 (e.g., via network 450).

Any, each, or at least one module or component or subsystem of system 401 may be provided as a software construct, firmware construct, one or more hardware components, or a combination thereof. For example, any, each, or at least one module or component or subsystem of any suitable system may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. The number, configuration, functionality, and interconnection of the modules and components and subsystems of system 401 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

Implementations within the scope of the present disclosure can be partially or entirely realized using a tangible computer-readable storage medium, or multiple tangible computer-readable storage media of one or more types, encoding one or more instructions. The tangible computer-readable storage medium also can be non-transitory in nature.

At least a portion of one or more of the modules of any suitable system of the disclosure (e.g., system 401) may be stored in or otherwise accessible to a subsystem (e.g., subsystem 520) in any suitable manner (e.g., in memory 513 (e.g., as at least a portion of application 519a and/or model 519m)). Any or each module of any suitable system of the disclosure (e.g., system 401) may be implemented using any suitable technologies (e.g., as one or more integrated circuit devices), and different modules may or may not be identical in structure, capabilities, and operation. Any or all of the modules or other components of any suitable system of the disclosure (e.g., system 401) may be mounted on an expansion card, mounted directly on a system motherboard, or integrated into a system chipset component (e.g., into a “north bridge” chip). At least a portion of one or more of the modules of any suitable system of the disclosure (e.g., system 401) may be stored in or otherwise accessible to any suitable components in any suitable manner. Any or each module of any suitable system of the disclosure (e.g., system 401) may be implemented using any suitable technologies (e.g., as one or more integrated circuit devices), and different modules may or may not be identical in structure, capabilities, and operation. Any or all of the modules or other components of any suitable system of the disclosure (e.g., system 401) may be mounted on an expansion card, mounted directly on a system motherboard, or integrated into a system chipset component (e.g., into a “north bridge” chip).

Any or each module of any suitable system of the disclosure may be a dedicated system implemented using one or more expansion cards adapted for various bus standards. For example, all of the modules may be mounted on different interconnected expansion cards or all of the modules may be mounted on one expansion card. With respect to a system, by way of example only, modules of the system may interface with a motherboard or processor assembly through an expansion slot (e.g., a peripheral component interconnect (“PCI”) slot or a PCI express slot). Alternatively, modules of the system need not be removable but may include one or more dedicated modules that may include memory (e.g., RAM) dedicated to the utilization of the module. In other embodiments, modules of the system may be at least partially integrated into a subsystem. For example, a module of the system may utilize a portion of memory of a subsystem. Any or each module of the system may include its own processing circuitry and/or memory. Alternatively, any or each module of the system may share processing circuitry and/or memory with any other module of the system and/or processor assembly and/or memory assembly of a subsystem.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device (e.g., via one or more wired connections, one or more wireless connections, or any combination thereof).

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including, but not limited to, routines, subroutines, programs, data structures, objects, modules, applications, applets, functions, and/or the like. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations may be performed by one or more integrated circuits, such as ASICs or FPGAs. In one or more implementations, such integrated circuits may execute instructions that may be stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software may depend upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The predicate words “configured to,” “operable to,” “operative to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation or the processor being operative to monitor and control the operation. Likewise, a processor configured to execute code can be construed as a processor programmed to execute code or operable to execute code or operative to execute code.

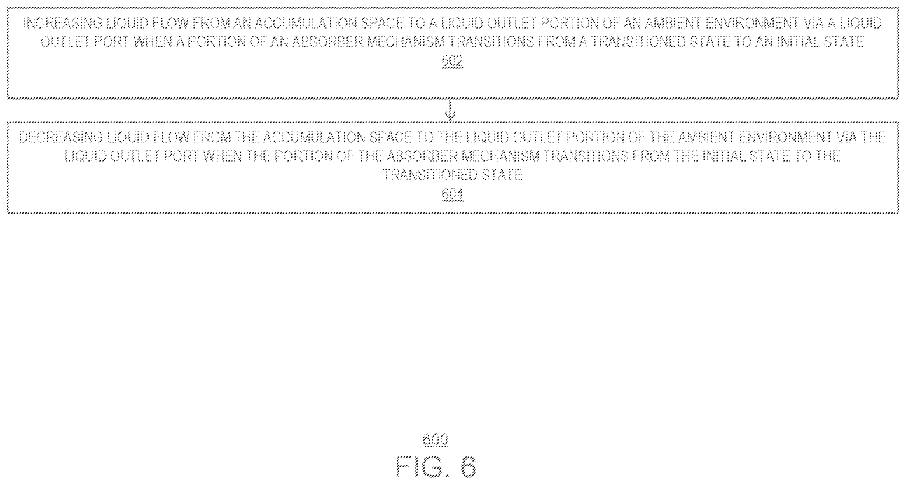

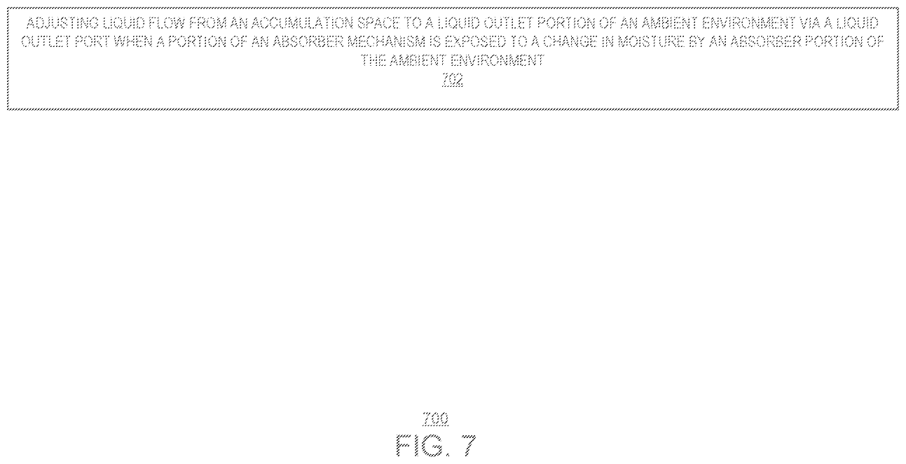

### FIGS. 6 and 7

FIG. 6 depicts a flowchart of a process 600 for mechanically controlling an irrigation system, wherein the irrigation system includes a container defining an accumulation space, a liquid inlet port configured to fluidly couple the accumulation space to a liquid inlet portion of an ambient environment of the system, a liquid outlet port configured to fluidly couple the accumulation space to a liquid outlet portion of the ambient environment, and a gas conduit extending between a gas inlet port configured to fluidly couple the gas conduit to a gas inlet portion of the ambient environment and a gas outlet port configured to fluidly couple the gas conduit to the accumulation space, and an absorber mechanism, wherein a first portion of the absorber mechanism is positioned within the gas conduit between the gas inlet port and the gas outlet port, wherein a second portion of the absorber mechanism is exposed via an absorber opening of the gas conduit to an absorber portion of the ambient environment, and wherein the first portion of the absorber mechanism is configured to transition between an initial state that passes air through the first portion of the absorber mechanism between the gas inlet port and the gas outlet port and a transitioned state that does not pass air through the first portion of the absorber mechanism between the gas inlet port and the gas outlet port. At operation 602, process 600 may include increasing liquid flow from the accumulation space to the liquid outlet portion of the ambient environment via the liquid outlet port when the first portion of the absorber mechanism transitions from the transitioned state to the initial state. At operation 604, process 600 may include decreasing liquid flow from the accumulation space to the liquid outlet portion of the ambient environment via the liquid outlet port when the first portion of the absorber mechanism transitions from the initial state to the transitioned state.

The operations shown in process 600 of FIG. 6 are only illustrative and that existing operations may be modified or omitted, additional operations may be added, and the order of certain operations may be altered.

FIG. 7 depicts a flowchart of a process 700 for mechanically controlling an irrigation system, wherein the irrigation system includes a container defining an accumulation space, a liquid inlet port configured to add liquid into the accumulation space, a liquid outlet port configured to selectively disburse liquid from the accumulation space to a liquid outlet portion of the ambient environment, and a gas conduit extending between a gas inlet port configured to fluidly couple the gas conduit to a gas inlet portion of the ambient environment and a gas outlet port configured to fluidly couple the gas conduit to the accumulation space, and an absorber mechanism, wherein a first portion of the absorber mechanism is positioned within the gas conduit between the gas inlet port and the gas outlet port, and wherein a second portion of the absorber mechanism is exposed via an absorber opening of the gas conduit to an absorber portion of the ambient environment. At operation 702, process 700 may include adjusting liquid flow from the accumulation space to the liquid outlet portion of the ambient environment via the liquid outlet port when the second portion of the absorber mechanism is exposed to a change in moisture by the absorber portion of the ambient environment.

The operations shown in process 700 of FIG. 7 are only illustrative and that existing operations may be modified or omitted, additional operations may be added, and the order of certain operations may be altered.

### Additional Concepts

Therefore, an irrigation system may include a container defining an accumulation space, a liquid inlet port configured to fluidly couple the accumulation space to a first portion of an ambient environment of the system, a liquid outlet port configured to fluidly couple the accumulation space to a second portion of the ambient environment, and a gas conduit extending between a gas inlet port configured to fluidly couple the gas conduit to a third portion of the ambient environment and a gas outlet port configured to fluidly couple the gas conduit to the accumulation space. The system may also include an absorber assembly including an absorber mechanism. A first portion of the absorber mechanism may be positioned within the gas conduit between the gas inlet port and the gas outlet port. A second portion of the absorber mechanism may be exposed via an absorber opening of the gas conduit to a fourth portion of the ambient environment. The first portion of the absorber mechanism may be configured to transition between an initial state that passes air through the first portion of the absorber mechanism between the gas inlet port and the gas outlet port, and a transitioned state that does not pass air through the first portion of the absorber mechanism between the gas inlet port and the gas outlet port. In some embodiments, the absorber mechanism is configured to transition between the initial state and the transitioned state when the second portion of the absorber mechanism is exposed to a change in moisture by the fourth portion of the ambient environment. In some embodiments, the absorber mechanism is configured to transition between the initial state and the transitioned state when the second portion of the absorber mechanism is exposed to a change in temperature by the fourth portion of the ambient environment. In some embodiments, the absorber mechanism is configured to transition between the initial state and the transitioned state when the second portion of the absorber mechanism is exposed to a change in chemical level by the fourth portion of the ambient environment. In some embodiments, the liquid outlet port is configured to disburse liquid from the accumulation space to the second portion of the ambient environment when the first portion of the absorber mechanism is in the initial state. In some embodiments, the liquid outlet port is configured to prevent liquid from passing from the accumulation space to the second portion of the ambient environment when the first portion of the absorber mechanism is in the transitioned state. In some embodiments, the liquid outlet port is configured to disburse liquid from the accumulation space to the second portion of the ambient environment when the first portion of the absorber mechanism is in the initial state, and prevent liquid from passing from the accumulation space to the second portion of the ambient environment when the first portion of the absorber mechanism is in the transitioned state. In some embodiments, the absorber mechanism includes an absorber fabric. In some embodiments, the absorber mechanism includes at least one of wood, wool, cotton, or microfiber. In some embodiments, the absorber mechanism includes a capillary tube. In some embodiments, the absorber assembly further includes a rigid protector at the absorber opening; and the rigid protector includes holes through the rigid protector configured to pass liquid and air therethrough. In some embodiments, the absorber assembly further includes a protector between the first portion of the absorber mechanism and the second portion of the absorber mechanism, and the protector includes holes through the protector configured to pass air therethrough but not liquid therethrough. In some embodiments, the fourth portion of the ambient environment is below a top surface of a target, the second portion of the ambient environment is above the top surface of the target or the second portion of the ambient environment is below the top surface of the target. In some embodiments, the target is soil. In some embodiments, the system may further include a tube extending between a first open end fluidly coupled to the liquid outlet port, and a second open end, wherein the tube is flexible for enabling movement of the second open end with respect to the fourth portion of the ambient environment. In some embodiments, the system may further include an electronic module configured to electrically adjust the size of a gas passageway between a fifth portion of the ambient environment and the accumulation space.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. The term “and/or” as used herein refers to and encompasses any and all possible combinations of one or more of the associated listed items. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” may each refer to only A, only B, or only C; any combination of A, B, and C; and/or at least one of each of A, B, and C. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. When used in the claims, the term “or” is used as an inclusive or and not as an exclusive or. For example, the phrase “at least one of x, y, or z” means any one of x, y, and z, as well as any combination thereof.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the term “based on” may be used to describe one or more factors that may affect a determination. However, this term does not exclude the possibility that additional factors may affect the determination. For example, a determination may be solely based on specified factors or based on the specified factors as well as other, unspecified factors. The phrase “determine A based on B” specifies that B is a factor that is used to determine A or that affects the determination of A. However, this phrase does not exclude that the determination of A may also be based on some other factor, such as C. This phrase is also intended to cover an embodiment in which A may be determined based solely on B. As used herein, the phrase “based on” may be synonymous with the phrase “based at least in part on.”

As used herein, the phrase “in response to” may be used to describe one or more factors that trigger an effect. This phrase does not exclude the possibility that additional factors may affect or otherwise trigger the effect. For example, an effect may be solely in response to those factors, or may be in response to the specified factors as well as other, unspecified factors. The phrase “perform A in response to B” specifies that B is a factor that triggers the performance of A. However, this phrase does not foreclose that performing A may also be in response to some other factor, such as C. This phrase is also intended to cover an embodiment in which A is performed solely in response to B.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter/neutral gender (e.g., her and its and they) and vice versa. Headings and subheadings, if any, are used for convenience only and do not limit the subject disclosure.

While there have been described systems and methods for irrigating a target (e.g., soil), many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements. It is also to be understood that various directional and orientational terms, such as “left” and “right,” “up” and “down,” “front” and “back” and “rear,” “top” and “bottom” and “side,” “above” and “below,” “length” and “width” and “thickness” and “diameter” and “cross-section” and “longitudinal,” “X-” and “Y-” and “Z-,” “roll” and “pitch” and “yaw,” “clockwise” and “counter-clockwise,” and/or the like, may be used herein only for convenience, and that no fixed or absolute directional or orientational limitations are intended by the use of these terms. For example, the components of the apparatus can have any desired orientation. If reoriented, different directional or orientational terms may need to be used in their description, but that will not alter their fundamental nature as within the scope and spirit of the disclosure.

Therefore, those skilled in the art will appreciate that the concepts of the disclosure can be practiced by other than the described embodiments, which are presented for purposes of illustration rather than of limitation.

What is claimed is:

1. An irrigation system comprising:
a container defining:
an accumulation space;
a liquid inlet port configured to fluidly couple the accumulation space to a first portion of an ambient environment of the system;
a liquid outlet port configured to fluidly couple the accumulation space to a second portion of the ambient environment; and
a gas conduit extending between:
a gas inlet port configured to fluidly couple the gas conduit to a third portion of the ambient environment; and
a gas outlet port configured to fluidly couple the gas conduit to the accumulation space; and
an absorber assembly comprising an absorber mechanism, wherein:
a first portion of the absorber mechanism is positioned within the gas conduit between the gas inlet port and the gas outlet port;
a second portion of the absorber mechanism is exposed via an absorber opening of the gas conduit to a fourth portion of the ambient environment; and
the first portion of the absorber mechanism is configured to transition between:
an initial state that passes air through the first portion of the absorber mechanism between the gas inlet port and the gas outlet port; and
a transitioned state that does not pass air through the first portion of the absorber mechanism between the gas inlet port and the gas outlet port.

2. The irrigation system of claim 1, wherein the absorber mechanism is configured to transition between the initial state and the transitioned state when the second portion of the absorber mechanism is exposed to a change in moisture by the fourth portion of the ambient environment.

3. The irrigation system of claim 1, wherein the absorber mechanism is configured to transition between the initial state and the transitioned state when the second portion of the absorber mechanism is exposed to a change in temperature by the fourth portion of the ambient environment.

4. The irrigation system of claim 1, wherein the absorber mechanism is configured to transition between the initial state and the transitioned state when the second portion of the absorber mechanism is exposed to a change in chemical level by the fourth portion of the ambient environment.

5. The irrigation system of claim 1, wherein the liquid outlet port is configured to disburse liquid from the accumulation space to the second portion of the ambient environment when the first portion of the absorber mechanism is in the initial state.

6. The irrigation system of claim 1, wherein the liquid outlet port is configured to prevent liquid from passing from the accumulation space to the second portion of the ambient environment when the first portion of the absorber mechanism is in the transitioned state.

7. The irrigation system of claim 1, wherein the liquid outlet port is configured to:
disburse liquid from the accumulation space to the second portion of the ambient environment when the first portion of the absorber mechanism is in the initial state; and
prevent liquid from passing from the accumulation space to the second portion of the ambient environment when the first portion of the absorber mechanism is in the transitioned state.

8. The irrigation system of claim 1, wherein the absorber mechanism comprises an absorber fabric.

9. The irrigation system of claim 1, wherein the absorber mechanism comprises at least one of wood, wool, cotton, or microfiber.

10. The irrigation system of claim 1, wherein the absorber mechanism comprises a capillary tube.

11. The irrigation system of claim 1, wherein:
the absorber assembly further comprises a rigid protector at the absorber opening; and
the rigid protector comprises holes through the rigid protector configured to pass liquid and air therethrough.

12. The irrigation system of claim 1, wherein:
the absorber assembly further comprises a protector between the first portion of the absorber mechanism and the second portion of the absorber mechanism; and
the protector comprises holes through the protector configured to pass air therethrough but not liquid therethrough.

13. The irrigation system of claim 1, wherein the fourth portion of the ambient environment is below a top surface of a target.

14. The irrigation system of claim 13, wherein the second portion of the ambient environment is above the top surface of the target.

15. The irrigation system of claim 13, wherein the second portion of the ambient environment is below the top surface of the target.

16. The irrigation system of claim 13, wherein the target is soil.

17. The irrigation system of claim 1, further comprising a tube extending between:
a first open end fluidly coupled to the liquid outlet port; and
a second open end, wherein the tube is flexible for enabling movement of the second open end with respect to the fourth portion of the ambient environment.

18. The irrigation system of claim 1, further comprising an electronic module configured to electrically adjust the size of a gas passageway between a fifth portion of the ambient environment and the accumulation space.

19. A method for mechanically controlling an irrigation system, wherein the irrigation system comprises a container defining an accumulation space, a liquid inlet port configured to fluidly couple the accumulation space to a liquid inlet portion of an ambient environment of the system, a liquid outlet port configured to fluidly couple the accumulation space to a liquid outlet portion of the ambient environment, and a gas conduit extending between a gas inlet port configured to fluidly couple the gas conduit to a gas inlet portion of the ambient environment and a gas outlet port configured to fluidly couple the gas conduit to the accumulation space, and an absorber mechanism, wherein a first portion of the absorber mechanism is positioned within the gas conduit between the gas inlet port and the gas outlet port, wherein a second portion of the absorber mechanism is exposed via an absorber opening of the gas conduit to an absorber portion of the ambient environment, and wherein the first portion of the absorber mechanism is configured to transition between an initial state that passes air through the first portion of the absorber mechanism between the gas inlet port and the gas outlet port and a transitioned state that does not pass air through the first portion of the absorber mechanism between the gas inlet port and the gas outlet port, the method comprising:
increasing liquid flow from the accumulation space to the liquid outlet portion of the ambient environment via the liquid outlet port when the first portion of the absorber mechanism transitions from the transitioned state to the initial state; and
decreasing liquid flow from the accumulation space to the liquid outlet portion of the ambient environment via the liquid outlet port when the first portion of the absorber mechanism transitions from the initial state to the transitioned state.

20. A method for mechanically controlling an irrigation system, wherein the irrigation system comprises a container defining an accumulation space, a liquid inlet port configured to add liquid into the accumulation space, a liquid outlet port configured to selectively disburse liquid from the accumulation space to a liquid outlet portion of the ambient environment, and a gas conduit extending between a gas inlet port configured to fluidly couple the gas conduit to a gas inlet portion of the ambient environment and a gas outlet port configured to fluidly couple the gas conduit to the accumulation space, and an absorber mechanism, wherein a first portion of the absorber mechanism is positioned within the gas conduit between the gas inlet port and the gas outlet port, and wherein a second portion of the absorber mechanism is exposed via an absorber opening of the gas conduit to an absorber portion of the ambient environment, the method comprising:
adjusting liquid flow from the accumulation space to the liquid outlet portion of the ambient environment via the liquid outlet port when the second portion of the absorber mechanism is exposed to a change in moisture by the absorber portion of the ambient environment.
